SEQUENCE LISTING (13 sequences)

SEQ ID NO: 1 - DNA, 1260 bp, SARS-CoV-2
  misc_feature: ORF of SARS-CoV-2 nucleoprotein
atgtctgataatggaccccaaaatcagcgaaatgcaccccgcattacgtttggtggaccctcagattcaactggcagtaaccagaatggagaacgcagtggggcgcgatcaaaacaacgtcggccccaaggtttacccaataatactgcgtcttggttcaccgctctcactcaacatggcaaggaagaccttaaattccctcgaggacaaggcgttccaattaacaccaatagcagtccagatgaccaaattggctactaccgaagagctaccagacgaattcgtggtggtgacggtaaaatgaaagatctcagtccaagatggtatttctactacctaggaactgggccagaagctggacttccctatggtgctaacaaagacggcatcatatgggttgcaactgagggagccttgaatacaccaaaagatcacattggcacccgcaatcctgctaacaatgctgcaatcgtgctacaacttcctcaaggaacaacattgccaaaaggcttctacgcagaagggagcagaggcggcagtcaagcctcttctcgttcctcatcacgtagtcgcaacagttcaagaaattcaactccaggcagcagtaggggaacttctcctgctagaatggctggcaatggcggtgatgctgctcttgctttgctgctgcttgacagattgaaccagcttgagagcaaaatgtctggtaaaggccaacaacaacaaggccaaactgtcactaagaaatctgctgctgaggcttctaagaagcctcggcaaaaacgtactgccactaaagcatacaatgtaacacaagctttcggcagacgtggtccagaacaaacccaaggaaattttggggaccaggaactaatcagacaaggaactgattacaaacattggccgcaaattgcacaatttgcccccagcgcttcagcgttcttcggaatgtcgcgcattggcatggaagtcacaccttcgggaacgtggttgacctacacaggtgccatcaaattggatgacaaagatccaaatttcaaagatcaagtcattttgctgaataagcatattgacgcatacaaaacattcccaccaacagagcctaaaaaggacaaaaagaagaaggctgatgaaactcaagccttaccgcagagacagaagaaacagcaaactgtgactcttcttcctgctgcagatttggatgatttctccaaacaattgcaacaatccatgagcagtgctgactcaactcaggcctaa

SEQ ID NO: 2 - protein, 419 aa, SARS-CoV-2
  misc_feature: nucleoprotein amino acid sequence
MSDNGPQNQRNAPRITFGGPSDSTGSNQNGERSGARSKQRRPQGLPNNTASWFTALTQHGKEDLKFPRGQGVPINTNSSPDDQIGYYRRATRRIRGGDGKMKDLSPRWYFYYLGTGPEAGLPYGANKDGIIWVATEGALNTPKDHIGTRNPANNAAIVLQLPQGTTLPKGFYAEGSRGGSQASSRSSSRSRNSSRNSTPGSSRGTSPARMAGNGGDAALALLLLDRLNQLESKMSGKGQQQQGQTVTKKSAAEASKKPRQKRTATKAYNVTQAFGRRGPEQTQGNFGDQELIRQGTDYKHWPQIAQFAPSASAFFGMSRIGMEVTPSGTWLTYTGAIKLDDKDPNFKDQVILLNKHIDAYKTFPPTEPKKDKKKKADETQALPQRQKKQQTVTLLPAADLDDFSKQLQQSMSSADSTQA

SEQ ID NO: 3 - protein, 18 aa, SARS-Cov-2
  misc_feature: SARS-CoV-2 nucleoprotein peptide
ITFGGPSDSTGSNQNGER

SEQ ID NO: 4 - protein, 20 aa, SARS-Cov-2
  misc_feature: SARS-CoV-2 nucleoprotein peptide
WYFYYLGTGPEAGLPYGANK

SEQ ID NO: 5 - protein, 16 aa, SARS-Cov-2
  misc_feature: SARS-CoV-2 nucleoprotein peptide
DGIIWVATEGALNTPK

SEQ ID NO: 6 - protein, 20 aa, SARS-Cov-2
  misc_feature: SARS-CoV-2 nucleoprotein peptide
NPANNAAIVLQLPQGTTLPK

SEQ ID NO: 7 - protein, 17 aa, SARS-Cov-2
  misc_feature: SARS-CoV-2 nucleoprotein peptide
MAGNGGDAALALLLLDR

SEQ ID NO: 8 - protein, 10 aa, SARS-Cov-2
  misc_feature: SARS-CoV-2 nucleoprotein peptide
AYNVTQAFGR

SEQ ID NO: 9 - protein, 16 aa, SARS-Cov-2
  misc_feature: SARS-CoV-2 nucleoprotein peptide
GPEQTQGNFGDQELIR

SEQ ID NO: 10 - protein, 19 aa, SARS-Cov-2
  misc_feature: SARS-CoV-2 nucleoprotein peptide
IGMEVTPSGTWLTYTGAIK

SEQ ID NO: 11 - protein, 10 aa, SARS-Cov-2
  misc_feature: SARS-CoV-2 nucleoprotein peptide
ADETQALPQR

SEQ ID NO: 12 - protein, 17 aa, SARS-Cov-2
  misc_feature: SARS-CoV-2 nucleoprotein peptide
QQTVTLLPAADLDDFSK

SEQ ID NO: 13 - protein, 14 aa, SARS-Cov-2
  misc_feature: SARS-CoV-2 nucleoprotein peptide
QLQQSMSSADSTQA

(19) United States
(12) Patent Application Publication
(10) Pub. No.: US 2022/0326126 A1
(43) Pub. Date: Oct. 13, 2022

(54) DETERGENT-FREE SIMULTANEOUS MULTIOMICS SAMPLE PREPARATION METHOD USING NOVEL NEW VESICLE DESIGN

(71) Applicant: ProtiFi, LLC, Farmingdale, NY (US)

(72) Inventors: Alexandre ZOUGMAN, Guiseley, Leeds (GB); Sandra WILSON, Huntington, NY (US); John Paul WILSON, Huntington, NY (US)

(21) Appl. No.: 17/753,329

(22) PCT Filed: Aug. 31, 2020
(86) PCT No.: PCT/US2020/048840

§ 371 Date: Feb. 28, 2022

Related U.S. Application Data
(60) Provisional application No. 62/894,201, filed on Aug. 30, 2019.

(51) Int. Cl. G01N 1/34; B01L 3/00

(52) U.S. Cl. CPC G01N 1/34; B01L 3/502753; B01L 2200/026; B01L 2300/042; B01L 2200/0684; B01L 2300/0681

(57) ABSTRACT

A two-piece assembly for sequential through-matrix processing of solutions and/or solids is provided, the assembly having an inner vial which maintains and holds the matrix and an outer vial which is configured to receive the inner vial at the upper or lower parked positions, to respectively allow or impede passage of the solution through the matrix of the upper vial. Captured molecules can be treated with enzymes and/or chemistries in situ in the matrix, and without the need for the use of strong chaotropic agents such as urea or detergents like SDS.

### RELATED APPLICATIONS

This application claims priority from U.S. Provisional Application Ser. No. 62/894,201, filed Aug. 30, 2019. The entirety of the aforementioned applications is incorporated herein by reference.

### FIELD

The present application relates to methods and devices for the preparation of samples containing proteins and/or small molecules and/or DNA/RNA.

### BACKGROUND

The combination of omic technology and techniques is gaining in popularity and advancing our understanding of biological systems and human pathologies. However, integrating analyses across omics platforms has introduced new technical challenges. Parallel sample handling in which a sample is split and portions are processed for different molecular classes, e.g. proteins and metabolites, is one potential solution. However, when the sample amounts are limited, as is often the case with clinical material, or heterogeneity exists, for example across different tissue sections, using a simultaneous extraction methodology for several molecular classes is essential however such methods have been lacking. The only methods available have been based on phase separation, e.g. chloroform-methanol extraction, and are limited by their complexity and laboriousness. They are not practical for either implementation with small sample amounts or high-throughput analyses.

In chemistry, biochemistry and clinical and research settings, there is often need for samples to be treated, for example including, and not limited to, steps of chemical or enzymatic reactions, or precipitations or coagulations, before said sample is subject to subsequent steps which might include filtration, capture, clarification, chromatography or myriad other processes, all of which require the sample to flow through some kind of a matrix adapted to the process of interest such as and not limited to filtration, capture, clarification, enrichment or chromatography. Simultaneous Trapping (SiTrap) facilitates direct measurement of, at a minimum, the proteome and metabolome in the same sample extract. SiTrap represents a method and system of sample preparation and separation on a depth filter to fractionate biology into two or many classes of biological moieties. SiTrap can be detergent-free and is extensible to nucleic acid polymers (DNA and RNA) as well as lipids, glycans and other molecular classes. A new novel vesicle allows for maximum SiTrap function and increased processing speed and convenience.

Each treatment step often requires time, i.e. incubation, and such steps are often serial, such as a precipitation or depletion or enzymatic or chemical reaction, followed by some kind of chromatography or enrichment or affinity or enzymatic treatment. Such treatments are most typically achieved by running a reaction in one tube or vesicle or container, transferring the contents of that reaction, perhaps including any precipitant or solid material (or excluding it, depending), to some matrix such as, and not limited to, a filter or porous material or a chromatography column of many formats (cartridges, tips, sheets, membranes, spin columns or filters, gravity flow columns, solid-phase extraction [SPE] columns, etc.), which then flows into a second tube or vesicle or container. It is noted that depending on the needs of the system at hand, such matrices might be in serial, for example a filter might be placed before a chromatography cartridge to prevent clogging.

After processing on or through the matrix, some combination of (1) the flow through that passes through the matrix, (2) the retentate which did not enter into the matrix, or (3) the material bound on or to or within the matrix are taken for further work or analysis; the fraction(s) which are desirable and not desirable are completely a function of the processing at hand.

After whatever portion of the sample has passed through the matrix, the matrix and/or retentate is often further processed such as by washing, chemical or enzymatic treatment, affinities, elution, etc. Depending on the workflow, a treatment that requires time to work, i.e. incubation(s), might be applied to the matrix, or the retentate, or both. Such incubation might be at lower or higher temperature than is ambient. Depending on the task at hand, such incubations might also involve the introduction of electromagnetic radiation in the form of light or microwaves or radiowaves, or of ultrasonic energy.

Because treatment steps including and not limited to chemical or enzymatic reactions or precipitations or other reactions which cause a phase change require incubation times, the output side of the matrix must be somehow plugged or stopped to prevent liquid from flowing through the matrix so that the process happening on or in or on top of the matrix can be afforded the requisite amount of time. In the above examples, if the protease K solution were to drip through, it would not act on the tissue; if the HRP solution were to flow through, no ELISA reaction would occur; and if the biotin elution solution were to flow through, no elution would occur. Similarly, if the solution containing salts or other dissolved moieties flowed through, no desired concentration reduction would occur, and for biopolymers, should incubation be needed to effect a phase change, the biopolymers would then pass through the matrix into the sample which was supposed to be cleared of biopolymers to later cause clogging. In the potential second (or more than second) incubation, if the listed enzymes were to flow through, they would not process any biomolecules atop or in or within or on the matrix, causing failure. Thus, plugging of the output side of the matrix is essential in such treatments to afford the treatment sufficient time.

This requirement to plug or stop flow through the matrix causes multiple negative issues. First, not only is plugging a hassle, but it adds significant additional experimental time especially when handling large numbers of samples. The use of a matrix with plugging often happens in the following sequence: 1) apply sample to a matrix, perhaps in a spin column (but other formats are of course possible); 2) make the flow through pass through the matrix with positive pressure on the input side of the matrix or negative pressure on the output side or alternatively centrifugation; 3) lift the spin column containing the matrix; 4) plug the column or other vesicle holding the matrix; 5) close the former container which holds the flow through; 6) place the now plugged column in a new tube or container; 7) open the spin column such that other solutions of the treatment can be added, perhaps (and not limited to) an enzyme solution which works on material on and in and atop the matrix; 8) cap the column again; 9) incubate the column with the matrix at the necessary temperature for the necessary amount of time; 10) remove the spin column from the new tube; 11) remove the plug, probably very carefully, directly above the new tube; 12) return the spin column to the new tube or container; 13) apply positive or negative pressure or centrifugal force to remove the contents of the matrix and any contents held by the spin column; 14) potentially elute from the matrix or wash the matrix, as determined by the needs of the system and properties of the matrix; and 15) repeat this process, each time using a fresh tube, if additional incubations are to be performed, such as recovery first of nucleic acids, then enzymatic treatment with a glycosidase, then chemical treatment with reduction and alkylation reagents, among many other possibilities (such as citraconic anhydride or hydroxylamine or NHS or isothiocyanate or many other chemistries and chemical treatments), then washing such reagents away, then processing with a protease the proteins bound in and on and within and atop the matrix. Needless to say, for large numbers of sample, this becomes simply intractable.

Beyond the tedious nature of plugs, they can leak, losing sample and causing failure. Indeed because matrices and their vesicles are inside tubes and thus not directly visible, the presence of a leak is often not detected until a treatment or experiment has run its course. Plugs can also break off during removal, also losing sample from an inability to recover sample from the matrix.

Plugging introduces additional experimental error because the timing of the plugging may be variable and can affect results: some samples might drip through more, or samples might have longer or shorter incubation times depending on when they were plugged and unplugged. Indeed, by the very nature of the process, the first sample to be plugged in a series will be plugged for longer than the last sample to receive a plug, subjecting the samples to additional and undesirable experimental variability.

Plugging also causes problems when it is desired to capture all of the material which flows from or out of or off or through the matrix. Indeed especially for small volumes, the plug itself may retain a significant amount of material one wishes to work to obtain. This is particularly the case if the plug is of a female variety and caps the end of a nozzle or flow director or connector or lure lock: the act of removing the plug creates a vacuum, filling the plug with material which, depending on the process, may be desirable and precious. In such a case one must pipette out the sample back into the vesicle atop the matrix, if possible. Such sample loss can also occur if plugs are a male variety: when the plug inserted in to the inside of the connection on the post-flow side of the matrix, the act of unplugging creates the same suction which can lead to the sample flowing out and potentially being lost. To address such situations, one may place a capture tube under the connector which comes off the matrix, carefully remove the plug and attempt to capture any sample which drips out. In summary, plugging is an error-prone process necessitating significant amounts of time. Finally, the use of plugs necessitates significant manual manipulation of the vesicles holding the matrix. This manipulation is poorly translatable to automation.

Thus, there exists a need for a device and method and process which: affords support to a matrix or matrices, which might be serially employed or stacked; affords a space before the matrix into which samples can be added, and a space after the matrix which can hold the portion of the sample which has passed through the matrix; affords easy start and stop of flow through a matrix with minimal handling and importantly no loose plug; allows for the easy use of multiple sequential treatments including on- or in-matrix treatments; allows for the easy introduction of heat or electromagnetic radiation like light or sonic energies such as ultrasonication; limits the potential for treatment failure due to dripping or lack of sealing.

### SUMMARY

In one aspect, the present application provides a method of preparing a sample comprising one or more fractions of molecule of interest, the method comprising: Exposing the sample to an extraction solvent, wherein the extraction solvent can be around neutral, or basic or acidic, and wherein the extraction solvent can be detergent-free or alternatively contain detergents or surfactants; Exposing said sample combined with said extraction solvent to physical disruption such as bead beating, sonication or ultrasonication. Preferably, but not obligatorily, sonication and ultrasonication is used; In the case that a sample was extracted with a basic extraction solvent, neutralizing the basic extraction solvent with an acid so that the pH is around neutral.

In certain embodiments, in the case that a sample was extracted with an acidic extraction solvent, neutralizing the acidic extraction solvent with a base so that the pH is around neutral; Exposing said sample combined with said extraction solvent to a molecule coagulant which facilitates binding of especially larger molecules upon a matrix, preferably a porous matrix, or a collection of small particles which can be manipulated and/or retained, wherein said coagulant may consist of a single- or multi-phase solution; During the (large) molecule coagulation step, bringing said sample combined with said large molecule coagulant into contact with a matrix adapted to capture said large molecules in the presence of the coagulant and most preferably a matrix which prevents excessive aggregation of coagulated large molecules such that flow through the matrix is not impeded; Collection into a removable vesicle of the smaller non-coagulated and unbound molecules, where the classes of smaller non-coagulated molecules collected are dependent on the choice and use of large molecule coagulant; Typically, though not obligatorily, washing the matrix and the captured large molecules to clean them; such a step is not optional if the extraction solvent contained surfactants or detergents, and such a step is typically always performed after a chemical manipulation like reduction and alkylation; Most preferably, elution of classes of separate classes of coagulated captured molecules from the capture matrix into a removable vesicle with extraction solvents chosen to match the solubilities of the captured molecules.

In certain embodiments, nucleic acids and polynucleic acids such as DNA and RNA, or alternatively free glycans as well as other kinds of molecules, are water-soluble and can be eluted by flowing an aqueous buffer through said capture matrix into a new removable vesicle. Similarly some lipids and some hydrophobic peptides are soluble in organic solvents like alcohols, which serves only as an illustrative example. Optionally during this step physical and/or thermal energy may be added such as via shaking or sonication or ultrasonication or heating or microwaving or other techniques apparent to one skilled in the art. It is explicitly noted that elutions may be serial using different elution solvents. By example, captured DNA and RNA might be eluted with an aqueous buffer and then captured lipids might be eluted with an organic extraction solvent, the choice of which is determined by the solubility properties of the classes of molecules of interest; Most preferably, either before or after the above mentioned elution of classes of captured coagulated large molecules upon the capture matrix, processing of the captured molecules with enzymes or chemistries, such as nucleases, proteases, glycosidases, lipases, or cyanogen bromide cleavage of proteins, and other enzymes and chemistries which alter the state of the coagulated large molecules to facilitate further down-stream processing.

In certain embodiments, specific classes of molecules may be liberated and/or processed from larger molecules into smaller molecules which often have different solubility properties. Such a step may be performed prior to or after steps of elution, and it is apparent to one skilled in the art that there is great flexibility in sample processing which can yield similar results.

In embodiments of the application, example classes of molecule which might be fractionated and/or prepared include amino acids, nucleosides, nucleotides, oligonucleotides, nucleic acids, sugars, carbohydrates, oligosaccharides, polysaccharides, fatty acids, lipids, hormones, metabolites, heterocyclic aromatic compounds, carcinogens, mutagens, compounds of the exposome such as plasticizers, pesticides, mold release agents, and/or fire retardants among many others, peptides, metabolites, cofactors, inhibitors, drugs, agents, nutrients, vitamins, polypeptides, proteins, glycoproteins, lipoproteins, antibodies, growth factors, cytokines, chemokines, receptors, neurotransmitters, antigens, prions, allergens, antibodies, substrates, biological hazardous materials, infectious substances including viruses, protozoan, bacteria and fungi, and wastes.

In certain embodiments, a sample can be first captured on the matrix, then optionally treated with a nuclease to form smaller molecules of DNA and RNA, which can be eluted and fractionated with the addition of an aqueous buffer, then captured lipids can be extracted with an organic solvent such as ethanol, hexane, methanol, ether, or chloroform, either separately or in combination, then captured proteins can be processed in or on the matrix, by example by glycosidases and the liberated glycosidases can be eluted with another aqueous elution, then the proteins can be reduced and alkylated in-situ within the trapping matrix, then subsequently they can be processed with a protease such as trypsin, or alternatively via chemical means such as cyanogen bromide or acidic degradation or alternatively sheering from strong sonic forces, and the peptides resulting from the captured proteins can be captured in a separate fraction.

In certain embodiments, one would obtain small molecules such as metabolites in the first flow through fraction, a lipid fraction, a nucleic acid fraction, a glycan fraction, and a peptide fraction, all of which are ready for analysis by mass spectrometry or other detection technique. Such enzymatic or chemical reactions or elutions may be accelerated with the addition of physical and/or thermal energy may be added such as via shaking or sonication or ultrasonication or heating or microwaving or other techniques apparent to one skilled in the art.

In certain embodiments, the trap may allow molecules or molecule fragments suitably pass to one or more secondary matrix or matrices, where the matrix or matrices might provide chromatographic separation or enrichment of various classes or subclasses of molecules.

In certain aspects, the application is a method, system and device for preparing a samples containing many classes of biomolecules such as (and not limited to) DNA, RNA, protein, glycans, small molecules, lipids and other metabolites and small molecules solubilized without a surfactant for analysis by mass spectrometry, e.g. LC-MS/MS.

In certain aspects, the application is a method, system and device for preparing a sample containing multiple molecule classes for multi-omics analyses. Such attempts to date have typically involved lysis of cells and extraction of proteins, and have failed to generate multiple molecule classes from one sample. A suitable lysis medium comprises 30 mM ammonium acetate. Another suitable lysis medium is 1.8% ammonium hydroxide. Another is 1 M HCl.

In certain embodiments, the method comprises the step of reducing and simultaneously alkylating the disulphide bonds of proteins in situ on the trapping matrix. This is achieved by heating the sample at 80° C. in 60 mM triethylammonium bicarbonate (TEAB), 10 mM tris(2-carboxyethyl)phosphine (TCEP), 25 mM chloroacetamide (CAA). Other suitable reagents may be used. The use of such reagents prevents formation of disulphide bonds between cysteine residues, especially of different peptides.

In certain embodiments, centrifugation is performed to drive the various media, reagents, buffers and the like through the matrix (matrices) as required.

In certain embodiments, pumps or the like can be used to move the various media, reagents, buffers and the like through the matrix (matrices) of the present application.

In certain aspects, the present application provides a sample preparation device for molecules extracted in a liquid medium, the device comprising a vessel having an inlet and an outlet, a matrix disposed between the inlet and the outlet, the matrix being adapted to capture and retain particles of molecules of interest from a medium as is flows from the inlet to the outlet.

In certain embodiments, the matrix is formed from a depth filter material.

In certain embodiments, the matrix extends across the entire lumen of the vessel such that anything flowing from the inlet to the outlet must pass through at least a portion of the matrix.

In one aspect, this application provides a new multi-part vesicle which speeds digestion or solubilization of intact proteins, which minimizes the number of transfer steps and which affords quick use. This new vesicle provides first for the ability to do the flow through described herein. It also provides for the ability to seal an inner vial within an outer vial, and that sonic energy and heat can be transferred from the outside to the inside. It further provides that flow through the matrix is most preferably uniform and uni-directional. The inner vial can be sealed against the outer vial so that solutions can be added to the inner vial which can act on the matrix and such solutions can be permeated into the matrix by capillary action as well as centrifugation. The inner vial can then be raised such that there is space between the inner and outer vials, so that the solution which was initially added can be centrifuged into the outer vial. The outer vial then becomes the container holding the omics sample which will be analyzed.

In an aspect of the application, a two-piece assembly for sequential through-matrix processing of solutions and/or solids is provided, the assembly having an inner vial which maintains and holds the matrix and an outer vial which is configured to receive the inner vial at the upper or lower parked positions, to respectively allow or impede passage of the solution through the matrix of the upper vial. The capability of the outer vial to reversibly seal the inner vial obviates the need for plugs and eliminates loss of sample to the plug. The inner vial has an inner chamber to receive a sample which may contain solids and liquids and via treatments solids may form from liquids. The outer vial has an inner chamber which can alternately seal the inner vial in the lower parked position or receive sample which flows from the inner vial through the matrix into the receiving space of the outer vial in the upper parked position. The inner vial and outer vial have opening on the top and are both afforded caps or lids to protect the sample and seal the space for samples. The inner vial lid additionally has a vent to allow for gases to escape in the case of heating, and the inner vial has an opening on the bottom to allow flow through the matrix it supports. In one preferred embodiment, the inner and outer vials are substantially cylindrical. The inner and outer vials have a locking or parking or support system such that the inner vial can be supported in the lower or upper parked positions. In one preferred embodiment, the support system consists of ridges and U-shaped stops; one skilled in the art will recognize that many other embodiments are possible, so long as the upper and lower positions are able to be maintained. The inner vial supports the matrix at its lower portion.

In certain embodiments, in the upper parked position, the outer vial is configured to receive sample placed into the sample holding space of the upper vial which flows from the upper vial through the matrix supported by the inner vial through the opening in the bottom of the lower vial when the upper vial is in the upper parked position.

In certain embodiments, in the lower parked position the outer vial is configured to seal the inner vial and impeded flow through the matrix, allowing incubation of the contents of the inner vial, while also reducing the dead volume of solution in the inner vial. In the lower parked position, the inner and outer vials can be centrifuged to drive out any air in the matrix and put a solution in full contact with the matrix, such as and not limited to solutions containing enzymes or chemicals to allow them to work on the material and molecules held within or atop the matrix.

In an aspect of the application, a kit is provided that includes the inner and outer vials, the inner vial being charged with a matrix to meet the needs of the required sample treatment, and optionally any reagents or solutions or materials to implement the steps of the kit.

In an aspect of the application, a method of sample processing is provided including passing a solution having solvent, soluble contaminants, and insoluble solid components, all of which may be of interest, through the matrix of the present application, such that soluble materials without affinity for the matrix pass through into the outer vial, materials which bind to the matrix are retained and any insoluble materials are retained in or on the matrix.

In an aspect of the application, a method of sample processing is provided including solubilizing some desired component of a sample, such as biological molecules including metabolites, lipids, proteins, nucleic acids, glycans and proteins, capturing or trapping or separating some fraction of molecules of interest, such as biopolymers, often and not only by the addition of coagulation agents including mild precipitants such as and not limited to a wide variety of organic solvents, potentially by inducing a phase change or coagulation or binding of said molecules and in all cases resulting in retention of the molecules of interest, which can then be trapped in or on or atop or within the matrix, or by affinities afforded to the matrix for the molecules of interest. With the sample fraction which is not trapped or retained by the matrix separated, the retained molecules can be subject to a wide range of treatments including chemical and/or enzymatic and/or chromatographic treatments which cause the release of desired components of the retained material, which can then be eluted. Sample can be driven through the matrix by positive pressure on the input side of the matrix or negative pressure on the output side or centrifugation.

### BRIEF DESCRIPTION OF THE DRAWINGS

FIG. 1 shows protein capture and digest from non-ionic detergent lysates. FIG. 1A Protein capture in cellulose depth filter tips. 3% Octyl Glucoside (OG) and 3% Poloxamer 407 (P407) lysates were prepared in 30 mM Ammonium Acetate from MDA-MB-231 cells by sonication on ice. The lysates were loaded into the tips immediately or diluted with equal volumes of methanol in 30 mM Ammonium Acetate (final methanol concentration—50%). The captured proteins were eluted with 2× Laemmli buffer. FIG. 1B SiTrap-type in-tip digestion of MDA-MB-231 cellular lysate prepared with 3% Octyl Glucoside. The capture tips were constructed either with quartz or cellulose materials. Digestion was performed according to SiTrap protocols. The digest products were eluted with 2× Laemmli buffer. Samples were analyzed on NuPAGE 4-12% Bis-Tris Protein Gels. A block flow diagram of a general approach for denaturing a biochemical agent using an activated cleaning fluid mist.

FIG. 2 shows MDA MB 231 cells were lysed by probe sonication on ice using 30 mM ammonium acetate (AA), 1.8% ammonium hydroxide (AH) or 3% SDS in 30 mM ammonium acetate (SDS). The lysates were centrifuged at 11,000×g for 2 min to remove debris. For AA and SDS lysates 4 volumes of methanol in 30 mM acetate were added to the samples; for AH lysates equal volume of 1 M acetic acid was added to the sample followed by addition of 2 volumes of methanol. The proteins were then captured in cellulose depth filters and consequently eluted with 2× Laemmli buffer and run on NuPAGE 4-12% Bis-Tris Protein Gels.

FIG. 3 shows SiTrap processing of cellular material. FIG. 3A Basic scheme. A cell pellet is sonicated or otherwise physically disrupted and/or heated in excess of either 30 mM ammonium acetate (AA) or 1.8% ammonium hydroxide (AH). For AA extraction four volumes of methanol in 30 mM AA are added to the lysate. For AH extraction an equal volume of 1M acetic acid is added to the lysate followed by two volumes of methanol. The resultant mix is loaded into the SiTrap unit (1), the proteins are captured in the depth filter trap and the flow-through is collected (2, 3). Following a wash with 50% methanol, the proteins are denatured, reduced and alkylated in situ by heating at 80° C. in 60 mM triethylammonium bicarbonate (TEAB), 10 mM tris(2-carboxyethyl)phosphine (TCEP), 25 mM chloroacetamide (CAA) solution (4). After the wash (5) an enzyme is introduced to the trapped proteins (6). After the digestion, the peptides are eluted from the SiTrap tips (7). The peptides are concentrated by Stage tips for downstream analysis by mass spectrometry. FIG. 3B-FIG. 3D Proteomics comparison of SiTrap ammonium hydroxide (AH), SiTrap ammonium acetate (AA) and standard SDS-based digests of MDA-MB-231 cells. FIG. 3B Box-plot diagram of identified protein numbers (at least two peptides were required for protein identification). FIG. 3C Protein distributions in the main GO cellular component categories. FIG. 3D Venn diagram showing distributions of the number of proteins identified with at least two peptides for each of the three sample preparation methods.

FIG. 4 shows digestion of a cellular lysate by SiTrap using cellulose tips. MDA-MB-231 cells were lysed by probe sonication on ice either with 30 mM ammonium acetate (AA) FIG. 4A or 1.8% ammonium hydroxide (AH) FIG. 4B. The 30 μg of lysate was loaded into SiTrap tip according to the described protocol and the flow-through (FT1) was collected. Trapped proteins were reduced and alkylated in-situ for 30 min with 10 mM TCEP and 25 mM chloroacetamide in 60 mM TEAB at 80° C. (FT2), digested with trypsin at 47° C. for 45 min and eluted with 2× Laemmli buffer. Samples were run on NuPAGE 4-12% Bis-Tris Protein Gels.

FIG. 5 shows volcano plot significance analysis of the metabolomics and proteomics profiling data for normal vs tumor renal sections. The significance cut-offs were set to 0.05 for false discovery rates (FDR). FIG. 5A The results of the metabolomics analysis indicate a decrease in both short chain acylcarnitines (C5, C5:1 and C3) and in polyunsaturated free fatty acids (C20:5, C20:4, C22:6) in the tumor samples. FIG. 5B The results of the proteomics analysis indicate downregulation of enzymes in the carnitine pathway, Carnitine O-acetyltransferase (CRAT), Carnitine O-palmitoyltransferase 2 (CPT2) and Carnitine 0-palmitoyltransferase 1 (CPT1A) in the tumor samples. Downregulation of enzymes in the polyunsaturated fatty acid pathway, Acyl-CoA Thioesterase 1 (ACOT1) and long chain Fatty acid-CoA ligase (ACSL1), is also observed in the tumor samples.

FIG. 6 shows SiTrap proteomic and metabolomic analysis of renal tumors identifies dysfunctional acylcarnitine (AC) metabolism. FIG. 6A Metabolomics analysis identifies decreased short chain acyl carnitines (C5, C5:1 and C3) in the tumor samples. The Y axes represent mean-centered relative concentrations. FIG. 6B Proteomics analysis indicates downregulation of Carnitine O-acetyltransferase (CRAT), Carnitine O-palmitoyltransferase 2 (CPT2) and Carnitine O-palmitoyltransferase 1 (CPT1A) in the tumor samples. The Y axes represent label-free quantitation (LFQ) intensity values.

FIG. 7 shows 0.5 μl of human serum from a healthy volunteer was either digested directly by SiTrap technology (6 replicate samples in total) or diluted with 20 mM TEAB buffer and processed by fractionation using SiTrap quartz tips. SiTrap processing produced two fractions, captured and flow-through (3 replicates each for each fraction, 6 samples in total). The MS results from tryptic digests of the 6 samples in each approach were merged.

FIG. 8 shows human renal FFPE tissue was deparaffinized by standard xylene/ethanol treatment and then lysed in 30 mM ammonium acetate by probe sonication. —50 ng of the resultant protein lysate was processed either by SiTrap or SDS methods. The sample was cleared of SDS by the standard protocol and the flow-through was collected (FT). Similarly to SiTrap, the proteins were digested at 48 C by two consecutive 1-hour digestions with 1.25 μg of trypsin (Promega) in 100 mM ammonium bicarbonate (trypsin concentration 0.07 μg/μl). Digest products were eluted consecutively by 500 mM ammonium bicarbonate and 50% acetonitrile in 0.2% formic acid. The leftover material was eluted by 2× Laemmli buffer.

FIG. 9 shows a schematic of the use of the assembly. In FIG. 9A, the matrix 117 is in contact with the solution 120 first applied to the inner sample holding space of the inner vial, potentially for treatments that require incubations, with the inner and outer vials are in their lower parked positions. In FIG. 9B, the inner vial has been moved to the upper parked position and the solution 124 has passed through the matrix 117. Depending on the matrix, it may have molecules bound in it or potentially material 123 that cannot pass through the matrix. In FIG. 9C, treatment solution 127 has been applied to work on materials bound or retained in or on or by matrix 117 and any materials potentially not passing into the matrix 123. It is in FIG. 9C that the nested assembly is exposed in its lower portion 273 is exposed to heat or sonic energy such as ultrasonication or light or electromagnetic radiation such as microwaves, to speed or facilitate reactions, the details of which depend entirely on the experimental system. After this processing has been complete, as shown in FIG. 9D the vial is moved to its upper parked position; in this view the inner vial stops 153 and outer vial support mechanism 174 are not visible. The solution which has worked on the matrix and its retentate 125 is propelled through the matrix 117 by positive or negative pressure or by centrifugation to transfer the now processed sample 126 to the bottom of the outer vial in its sample collection area. After this process is complete, the sample is ready to store or analyze further as shown in FIG. 9E.

FIG. 10 shows the complete assembly of the inner vial rotated to engage the locking mechanisms of the inner and outer vials, in this embodiment three of them, to hold the inner vial in the upper parked position within the outer vial, and how sample from the inner space of the inner vial can flow through the matrix supported by the inner vial to the receiving space of the outer vial.

FIG. 11 is another view of the inner and outer vial assembly showing the other side of the assembly where two locking mechanisms are engaged to hold the upper parked position.

FIG. 12 shows the inner and outer vial assembled in the lower parked position in which the inner vial is sealed against the outer vial to transmit externally applied treatments and seal the inner vial while removing dead space of the output of the inner vial with a pin.

FIG. 13 shows both sides of the inner vial.

FIG. 14 is a cutaway of the lower parked position of the nested inner and outer vials illustrating the position of the matrix, pin which serves to remove dead volume, and sample collection region, as well as the tight interface between the inner and outer vials through the whole lower region of the inner and outer vials.

FIG. 15 shows an embodiment of the application arrayed in a 96-well plate format in which the inner plate bearing a matrix of inner vials is in the lower parked position with the outer plate and which is held in place by moveable hinged tab stops; the array is unmodified in the sealing and treatment transmission capabilities between the inner and outer vials/plates.

FIG. 16 shows an embodiment of the application arrayed in a 96-well plate format in which the inner plate bearing a matrix of inner vials is supported in the upper parked position by moveable hinged tab stops to allow the contents of the inner plate to flow through the matrix of the wells of the inner plate to the sample collection region of the outer plate.

FIG. 17 shows an embodiment of a locking mechanism to establish a lower and upper park position consisting of posts with corresponding notches which afford the two positions.

FIG. 18 shows an embodiment of a locking mechanism to establish two positions will allow or prohibit flow thorough the matrix via a side release design in which the outer vial either seals or does not seal against the inner vial depending on the position of rotation. A snap fit locking mechanism can afford sealing.

FIG. 19 shows an embodiment of a locking mechanism to establish a lower and upper park position consisting of snaps which hold the inner vial at various vertical heights within the outer vial.

FIG. 20 shows an embodiment of a locking mechanism to establish a lower and upper park position consisting of multiple ridges, fine or coarse, which hold the inner vial at various vertical heights within the outer vial.

FIG. 21 is like FIG. 20 in demonstrating a potential embodiment of a locking mechanism to establish a lower and upper park position consisting of multiple ridges to hold the inner vial at various vertical heights within the outer vial, but has the added advantage of having a release where the ridges are disengaged by rotation to gaps that lack interlocking ridges.

FIG. 22 shows a potential embodiment of a locking mechanism to establish a lower and upper park position consisting of a coarse thread where the inner vial is screwed down to seal or unscrewed to allow flow from the inner to outer vial.

FIG. 23 shows the various transitions of SARS-CoV-2 nucleoprotein peptide WYFYYLGTGPEAGLPYGANK.

FIG. 24 shows the various transitions of SARS-CoV-2 nucleoprotein peptide DGIIWVATEGALNTPK.

FIG. 25 illustrates reversible SiTrap capture and release of RNA from detergent-containing and detergent-free conditions.

### PARTS LEGEND

101 Inner vial
109 Outer vial
111 Inner and outer vial assembled in the lower parked position to hold and treat solutions within the space of the inner vial 122 and/or materials on or atop or in or within matrix 117
113 Inner and outer vial assembled in the upper parked position to pass solutions from the space of the inner vial 122 through matrix 117 to the sample holding space of the outer vial 222
115 Inner and outer plate assembly including means to support the upper and lower parked positions.
117 Matrix held in place by the inner vial
120 Sample first added to the inner vial in the parked position prior to processing.
122 Space within the inner vial to hold sample including solid and/or liquid sample and/or treatment reagents in the upper or lower parked positions
123 Material potentially retained by the matrix
124 Initial flow through fraction which might be devoid of coagulated material, have been depleted of something via affinity in the matrix 117, might be free of insoluble matter, etc.
125 Solution post processing as it is passing through the matrix of the inner vial having worked on material retained or bound in or on or by the matrix
126 Solution post processing that has passed through the matrix of the inner vial
127 Treatment solution applied to work on material retained by or in the matrix 117 and/or anything on it like 123
129 Opening of the inner vial with surface to interface with the rib sealing mechanism 248
137 Vent of the lid of the inner vial
145 D-pin which is configured to plug the inner vial and remove the dead space of the output of the inner vial up to the bottom of the matrix
153 Locking/stop/support mechanisms of the inner vial which engage with the support mechanism of the outer vial 174 to form a supported upper parked position to allow the contents held on the inside of the inner vial to flow through the matrix into the receiving space 222 of the outer vial
168 Living hinge of the outer vial connecting outer vial lid 217 with the main body of the outer vial
174 Support mechanism of the outer vial which interfaces with the locking mechanisms or stops of the inner vial 153
185 Hinge of the inner vial
195 Sample collection region of the outer vial at the lowest depth
203 Output of the outer vial; as depicted the outside dimensions fit lure lock receptacles
217 Lid of outer the vial with tab 299 for opening and closing
222 Space within the outer vial which can receive and hold flow through of sample that passes through the matrix
226 Space within the outer plate which can receive and hold flow through of sample that passes through the matrix supported by the inner plate
237 Lid of the inner vial with tab 281 for opening and closing
248 Rib sealing mechanism of the inner vial lid which seals the inner vial at its top
256 Rib sealing mechanism of the outer vial lid which seals the inner vial at its top
269 Inner vial bottom opening for receiving flow from the matrix and transmitting it out of the inner vial
273 Region of the outer vial which can receive the inner vial with a tight fit and transmit from the exterior of the outer vial heat and sonic energy to the inner vial, the matrix of the inner vial and any sample held in the inner vial, when the inner vial is in the lower parked position
276 Tight interface between the inner and outer vials which facilitates flow from the exterior of the outer vial to the interior of the inner vial, its contents and matrix of treatments such as heat or light or electromagnetic radiation or sonic energy like ultrasonication
281 Tab of inner vial lid for opening and closing by hand or automation
299 Tab of outer vial lid for opening and closing by hand or automation
303 Plates bearing embodiment bearing the equivalent to 96 inner vials
308 Plates bearing embodiment bearing the equivalent to 96 outer vials
311 Hinge region of the outer plate which allows the inner plate to be held down and sealed in the lower parked position or held up in the upper parked position to facilitate flow through the matrices to the outer plate.
326 Support of the outer plate which holds the inner plate down to seal it against the outer plate in the lower parked position
331 Support of the outer plate which holds the inner plate up in the upper parked position to allow solution to flow

Throughout the drawings, the same reference numerals and characters, unless otherwise stated are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and appended claims.

### DETAILED DESCRIPTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the appended numbered paragraphs, the singular forms “a,” “an” and “the” include plural referents unless the content clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to “the value,” greater than or equal to the value” and possible ranges between values are also disclosed, as appropriately understood by the skilled artisan. For example, if the value “10” is disclosed the “less than or equal to 10” as well as “greater than or equal to 10” is also disclosed.

The present application concerns, at least in part, a two-piece “processing and containment” assembly which includes an inner vial that maintains and supports a matrix, which may be multiple matrices in series such as a porous capture surface followed by a chromatographic media as is common in SPE such as C4, C8, C18, or ion exchange resins such as SCX, SAX, or metal binding surfaces such as IMAC, and which facilitates processing a sample into multiple fractions, and an outer vial which seals the inner vial during incubation and/or reaction steps in the lower parked position, which then in the upper parked position serves as a containment vesicle. The upper and lower parked positions are afforded by locking mechanisms between the inner and outer vial which in the lower parked position, allow the inner vial to seal against the very bottom of the outer vial, and which in the upper parked position, effected by minimal rotation, allow the inner vial to be supported at the upper parked position so that its contents can be passed through the matrix into the sample holding space of the outer vial. The combination of a containment vesicle and a sealing ability in the outer vial, complete with a pin to remove dead space of the output of the inner vial, minimizes sample losses, minimizes elution volumes and maximizes throughput. The inner vial serves as a reaction vessel in capturing and processing steps. Reactions can occur within the inner vial including atop or within or on the matrix held by the inner vial. It the lower parked position, the inner and outer vial assembly can be centrifuged to ensure the surfaces and pores of the matrix held by the inner vial have all been cleared of air and are exposed to treatment reagents. The assembly can be disposable.

The assembly can be manufactured in multiplexed formats such as 96-well plates; many other multiplexed samples can be contemplated. Some workflows may utilize multiple outer vials to capture first the initial flow through, then the results of other treatment steps received by the material retained insider the inner vial and on, atop, within or in its matrix. In preferred embodiments, molecules are forced by the addition of reagents to bind to or within the matrix, or to coagulate to themselves or onto the matrix or the molecules themselves, allowing all non-coagulated molecules to be passed through the matrix. After the inner vial, now containing the coagulated material retained via the matrix, has been placed into a new outer vial in the lower parked position, reagents are added to the sealed interior of the lower vial to process the material held atop or in or within or on the matrix.

Treatments might include various elutions from chromatographic media such as salt cuts from ion exchange or organic solvent cuts from reverse phase, as well as the above-referenced chemical, enzymatic, heat, sonic or other kinds of treatments. This application simplifies sample treatments and eliminates the need to manually process plugs. By integrating steps of coagulation or precipitation or chemical treatment steps with matrix processing that can include filtration as well as binding including binding to chromatographic surfaces (which can be serial simply by stacking matrices), into a two-part assembly, this application facilitates high throughput including in via automation, robustness and reproducibility, as well as cost-effectiveness which will be essential as treatments are applied to large scales such as in personalized or precision medicine.

Protein and DNA and glycan and other molecules and biopolymers are captured through a combination of at least two capture mechanisms. Any precipitant particles such as protein or biopolymer precipitant are physically trapped in the filter pores and in-solution protein material in the presence of the coagulant is adsorbed on the matrix via non-covalent interactions with the matrix surface by intentional modulation of the chaotropicity of the solvent containing the analyte molecules. Importantly, the flow-through after this capture contains the extracted physiological small molecules and does not include contaminants, save the volatile or non-interfering buffer components. Thus, this application provides that the flow-through is a suitable medium for profiling of metabolites and other unbound molecules. Significantly and surprisingly, the captured biomolecules like proteins can still be reduced and alkylated while in the trap, consequently facilitating downstream in situ protein digestion and proteomics analysis. Other treatments, chemical and enzymatic, to proteins and other trapped molecules can surprisingly be performed in situ. It is a significant unexpected advantage of the present application that captured molecules can be treated with enzymes and/or chemistries in situ in the matrix, and without the need for the use of strong chaotropic agents such as urea or detergents like SDS.

The present methods and systems can involve the use of extraction solvents which, despite having no detergent, are strongly solubilizing. For example, a preferred buffer for the present application is 1.8% ammonium hydroxide, which by proteomics results surprisingly showed similar ability to retrieve proteins as SDS. Unexpectedly, the capture of molecules from a neutral (or neutralized) extraction solution, without the presence of a detergent or chaotrope, supplemented with a mildly chaotropic coagulant, for example the aqueous methanolic compositions described herein, provides very favorable conditions for the method of the present application, namely capture of molecules in native or near-native state, and capture with a high surface area-to-volume ratio which makes the molecules particularly sensitive to enzymatic or chemical treatments and/or manipulations within the trapping matrix, while also allowing for the selective recovery of various classes of molecules. For example, proteins so captured are highly protease-sensitive. Additionally, capture in the native state allows the use of enzymes which require native tertiary structure of biomolecules. By non-limiting example, the enzyme FabRICATOR digests IgG at a specific site below the hinge region, generating a homogenous pool of F(ab′)2 and Fc/2 fragments. FabRICATOR can be used to enzymatically process antibodies in the workflow of this application, by contrast, FabRICATOR cannot be used after other techniques of sample preparation such as protein precipitation.

Another specific and preferred embodiment of the present application is the addition of two volumes of methanol to sample first extracted with 1.8% ammonium hydroxide sonication (by probe or otherwise), which was then neutralized by addition of an equal volume of 1 M acetic acid. To this neutralized solution can be additionally added coagulant, specifically such as two volumes of methanol, although other ratios may be advantageous. This particular approach is unique and totally surprising in that upon neutralization, biomolecules instantly form enzyme-sensitive aggregates which can be captured, separated from smaller non-aggregated molecules, washed, and further extracted and/or processed by chemical or enzymatic means.

### Definitions

As used herein, the term “virus” can include, but is not limited to, influenza viruses, herpesviruses, polioviruses, noroviruses, and retroviruses. Examples of viruses include, but are not limited to, human immunodeficiency virus type 1 and type 2 (HIV-1 and HIV-2), human T-cell lymphotropic virus type I and type II (HTLV-I and HTLV-II), hepatitis A virus, hepatitis B virus (HBV), hepatitis C virus (HCV), hepatitis delta virus (HDV), hepatitis E virus (HEV), hepatitis G virus (HGV), parvovirus B19 virus, hepatitis A virus, hepatitis G virus, hepatitis E virus, transfusion transmitted virus (TTV), Epstein-Barr virus, human cytomegalovirus type 1 (HCMV-1), human herpesvirus type 6 (HHV-6), human herpesvirus type 7 (HHV-7), human herpesvirus type 8 (HHV-8), influenza type A viruses, including subtypes H1N1 and H5N1, human metapneumovirus, severe acute respiratory syndrome (SARS) coronavirus, SARS-CoV-2, Middle East respiratory syndrome (MERS), hantavirus, and RNA viruses from Arenaviridae (e.g., Lassa fever virus (LFV)), Pneumoviridae (e.g., human metapneumovirus), Filoviridae (e.g., Ebola virus (EBOV), Marburg virus (MBGV) and Zika virus); Bunyaviridae (e.g., Rift Valley fever virus (RVFV), Crimean-Congo hemorrhagic fever virus (CCHFV), and hantavirus); Flaviviridae (West Nile virus (WNV), Dengue fever virus (DENV), yellow fever virus (YFV), GB virus C (GBV-C; formerly known as hepatitis G virus (HGV)); Rotaviridae (e.g., rotavirus), and combinations thereof. In one embodiment, the subject is infected with HIV-1 or HIV-2.

The genetically diverse Orthocoronavirinae family is divided into four genera (alpha, beta, gamma, and delta coronaviruses). Human CoVs are limited to the alpha and beta subgroups. Exemplary human CoVs include severe acute respiratory syndrome coronavirus-2 (SARS-CoV-2), severe acute respiratory syndrome coronavirus (SARS-CoV), Middle East respiratory syndrome coronavirus (MERS-CoV), HCoV-229E, HCoV-OC43, HCoV-NL63, and HCoV-HKU1.

Nonlimiting examples of subgroup 1a alphacoronaviruses and their GenBank Accession Nos. include FCov.FIPV.79.1146.VR.2202 (NV 007025), transmissible gastroenteritis virus (TGEV) (NC_002306; Q811789.2; DQ811786.2; DQ811788.1; DQ811785.1; X52157.1; AJ011482.1; KC962433.1; AJ271965.2; JQ693060.1; KC609371.1; JQ693060.1; JQ693059.1; JQ693058.1; JQ693057.1; JQ693052.1; JQ693051.1; JQ693050.1); porcine reproductive and respiratory syndrome virus (PRRSV) (NC 001961.1; DQ811787), as well as any subtype, clade or sub-clade thereof, including any other subgroup 1a coronavirus now known (e.g., as can be found in the GenBank® Database) or later identified in the GenBank® Database.

Nonlimiting examples of a subgroup 1b alphacoronaviruses and their GenBank Accession Nos. include HCoV.NL63.Amsterdam.I (NC_005831), BtCoV.HKU2.HK.298.2006 (EF203066), BtCoV.HKU2.HK.33.2006 (EF203067), BtCoV.HKU2.HK.46.2006 (EF203065), BtCoV.HKU2.GD.430.2006 (EF203064), BtCoV.1A.AFCD62 (NC 010437), BtCoV.1B.AFCD307 (NC 010436), BtCov.HKU8.AFCD77 (NC 010438), BtCoV.512.2005 (DQ648858); porcine epidemic diarrhea viruses (NC 003436, DQ355224.1, DQ355223.1, DQ355221.1, JN601062.1, JN601061.1, JN601060.1, JN601059.1, JN601058.1, JN601057.1, JN601056.1, JN601055.1, JN601054.1, JN601053.1, JN601052.1, JN400902.1, JN547395.1, FJ687473.1, FJ687472.1, FJ687471.1, FJ687470.1, FJ687469.1, FJ687468.1, FJ687467.1, FJ687466.1, FJ687465.1, FJ687464.1, FJ687463.1, FJ687462.1, FJ687461.1, FJ687460.1, FJ687459.1, FJ687458.1, FJ687457.1, FJ687456.1, FJ687455.1, FJ687454.1, FJ687453 FJ687452.1, FJ687451.1, FJ687450.1, FJ687449.1, AF500215.1, KF476061.1, KF476060.1, KF476059.1, KF476058.1, KF476057.1, KF476056.1, KF476055.1, KF476054.1, KF476053.1, KF476052.1, KF476051.1, KF476050.1, KF476049.1, KF476048.1, KF177258.1, KF177257.1, KF177256.1, KF177255.1), HCoV.229E (NC 002645), as well as any subtype, clade or sub-clade thereof, including any other subgroup 1b coronavirus now known (e.g., as can be found in the GenBank® Database) or later identified in the GenBank® Database.

Nonlimiting examples of subgroup 2a betacoronaviruses and their GenBank Accession Nos. include HCoV.HKU1.C.N5 (DQ339101), MHV.A59 (NC_001846), PHEV.VW572 (NC_007732), HCoV.OC43.ATCC.VR.759 (NC_005147), bovine enteric coronavirus (BCoV.ENT) (NC_003045), as well as any subtype, clade or sub-clade thereof, including any other subgroup 2a coronavirus now known (e.g., as can be found in the GenBank® Database) or later identified in the GenBank® Database.

Nonlimiting examples of subgroup 2b betacoronaviruses and their GenBank Accession Nos. include human SARS CoV-2 isolates, such as Wuhan-Hu-1 (NC 045512.2) and any CoV-2 isolates comprising a genomic sequence set forth in GenBank Accession Nos., such as MT079851.1, MT470137.1, MT121215.1, MT438728.1, MT470115.1, MT358641.1, MT449678.1, MT438742.1, LC529905.1, MT438756.1, MT438751.1, MT460090.1, MT449643.1, MT385425.1, MT019529.1, MT449638.1, MT374105.1, MT449644.1, MT385421.1, MT365031.1, MT385424.1, MT334529.1, MT466071.1, MT461669.1, MT449639.1, MT415321.1, MT385430.1, MT135041.1, MT470179.1, MT470167.1, MT470143.1, MT365029.1, MT114413.1, MT192772.1, MT135043.1, MT049951.1; human SARS CoV-1 isolates, such as SARS CoV.A022 (AY686863), SARSCoV.CUHK-W1 (AY278554), SARSCoV.GDO1 (AY278489), SARSCoV.HC.SZ.61.03 (AY515512), SARSCoV.SZ16 (AY304488), SARSCoV.Urbani (AY278741), SARSCoV.civet010 (AY572035), SARSCoV.MA.15 (DQ497008); bat SARS CoV isolates, such as BtSARS.HKU3.1 (DQ022305), BtSARS.HKU3.2 (DQ084199), BtSARS.HKU3.3 (DQ084200), BtSARS.Rml (DQ412043), BtCoV.279.2005 (DQ648857), BtSARS.Rfl (DQ412042), BtCoV.273.2005 (DQ648856), BtSARS.Rp3 (DQ071615),), as well as any subtype, clade or sub-clade thereof, including any other subgroup 2b coronavirus now known (e.g., as can be found in the GenBank® Database) or later identified in the GenBank® Database.

Nonlimiting examples of subgroup 2c betacoronaviruses and their GenBank Accession Nos. include Middle East respiratory syndrome coronavirus (MERS) isolates, such as Riyadh 22012 (KF600652.1), Al-Hasa_18_2013 (KF600651.1), Al-Hasa_17_2013 (KF600647.1), Al-Hasa_152013 (KF600645.1), Al-Hasa_16_2013 (KF600644.1), Al-Hasa_21_2013 (KF600634), Al-Hasa_19_2013 (KF600632), Buraidah_1_2013 (KF600630.1), Hafr-Al-Batin_1_2013 (KF600628.1), Al-Hasa_122013 (KF600627.1), Bisha.1toreq.1_2012 (KF600620.1), Riyadh_3_2013 (KF600613.1), Riyadh_1_2012 (KF600612.1), Al-Hasa_3_2013 (KF186565.1), Al-Hasa_1_2013 (KF186567.1), Al-Hasa_2_2013 (KF186566.1), Al-Hasa_4_2013 (KF186564.1); Betacoronavirus England 1-N1 (NC_019843), SA-N1 (KC667074); human betacoronavirus 2c Jordan-N3/2012 (KC776174.1); human betacoronavirus 2c EMC/2012, (JX869059.2); any bat coronavirus subgroup 2c isolate, such as bat coronavirus Taper/CII_KSA_287/Bisha/Saudi Arabia (KF493885.1), bat coronavirus Rhhar/CII_KSA 003/Bisha/Saudi Arabia/2013 (KF493888.1), bat coronavirus Pikuh/CII_KSA 001/Riyadh/Saudi Arabia/2013 (KF493887.1), bat coronavirus Rhhar/CII_KSA 002/Bisha/Saudi Arabia/2013 (KF493886.1), bat coronavirus Rhhar/CII_KSA 004/Bisha/Saudi Arabia/2013 (KF493884.1), bat coronavirus BtCoV.HKU4.2 (EF065506), bat coronavirus BtCoV.HKU4.1 (NC 009019), bat coronavirus BtCoV.HKU4.3 (EF065507), bat coronavirus BtCoV.HKU4.4 (EF065508), bat coronavirus BtCoV133.2005 (NC 008315), bat coronavirus BtCoV.HKU5.5 (EF065512), bat coronavirus BtCoV.HKU5.1 (NC 009020), bat coronavirus BtCoV.HKU5.2 (EF065510), bat coronavirus BtCoV.HKU5.3 (EF065511), and bat coronavirus HKU5 isolate (KC522089.1); any additional subgroup 2c, such as KF192507.1, KF600656.1, KF600655.1, KF600654.1, KF600649.1, KF600648.1, KF600646.1, KF600643.1, KF600642.1, KF600640.1, KF600639.1, KF600638.1, KF600637.1, KF600636.1, KF600635.1, KF600631.1, KF600626.1, KF600625.1, KF600624.1, KF600623.1, KF600622.1, KF600621.1, KF600619.1, KF600618.1, KF600616.1, KF600615.1, KF600614.1, KF600641.1, KF600633.1, KF600629.1, KF600617.1, KC869678.2; KC522088.1, KC522087.1, KC522086.1, KC522085.1, KC522084.1, KC522083.1, KC522082.1, KC522081.1, KC522080.1, KC522079.1, KC522078.1, KC522077.1, KC522076.1, KC522075.1, KC522104.1, KC522104.1, KC522103.1, KC522102.1, KC522101.1, KC522100.1, KC522099.1, KC522098.1, KC522097.1, KC522096.1, KC522095.1, KC522094.1, KC522093.1, KC522092.1, KC522091.1, KC522090.1, KC522119.1, KC522118.1, KC522117.1, KC522116.1, KC522115.1, KC522114.1, KC522113.1, KC522112.1, KC522111.1, KC522110.1, KC522109.1, KC522108.1, KC522107.1, KC522106.1, KC522105.1); Pipistrellus bat coronavirus HKU4 isolates (KC522048.1, KC522047.1, KC522046, 1, KC522045.1, KC522044.1, KC522043.1, KC522042.1, KC522041.1, KC522040.1, KC522039.1, KC522038.1, KC522037.1, KC522036.1, KC522048.1, KC522047.1, KC522046.1, KC522045.1, KC522044.1, KC522043.1, KC522042.1, KC522041.1, KC522040, 1, KC522039.1, KC522038.1, KC522037.1, KC522036.1, KC522061.1, KC522060.1, KC522059.1, KC522058.1, KC522057.1, KC522056.1, KC522055.1, KC522054.1, KC522053.1, KC522052.1, KC522051.1, KC522050.1, KC522049.1, KC522074.1, KC522073.1, KC522072.1, KC522071.1, KC522070.1, KC522069.1, KC522068.1, KC522067.1, KC522066.1, KC522065.1, KC522064.1, KC522063.1, KC522062.1), as well as any subtype, clade or sub-clade thereof, including any other subgroup 2c coronavirus now known (e.g., as can be found in the GenBank® Database) or later identified in the GenBank® Database.

Nonlimiting examples of subgroup 2d betacoronaviruses and their GenBank Accession Nos. include BtCoV.HKU9.2 (EF065514), BtCoV.HKU9.1 (NC 009021), BtCoV.HkU9.3 (EF065515), BtCoV.HKU9.4 (EF065516), as well as any subtype, clade or sub-clade thereof, including any other subgroup 2d coronavirus now known (e.g., as can be found in the GenBank® Database) or later identified in the GenBank® Database.

Nonlimiting examples of subgroup 3 gammacoronaviruses include IBV.Beaudette.IBV.p65 (DQ001339) or any other subgroup 3 coronavirus now known (e.g., as can be found in the GenBank® Database) or later identified in the GenBank® Database.

A coronavirus defined by any of the isolates or genomic sequences in the aforementioned subgroups 1a, 1b, 2a, 2b, 2c, 2d and 3 can be targeted.

As used herein, the term “bacteria” shall mean members of a large group of unicellular microorganisms that have cell walls but lack organelles and an organized nucleus. Synonyms for bacteria may include the terms “microorganisms”, “microbes”, “germs”, “bacilli”, and “prokaryotes.” Exemplary bacteria include, but are not limited to Mycobacterium species, including M. tuberculosis; Staphylococcus species, including S. epidermidis, S. aureus, and methicillin-resistant S. aureus; Streptococcus species, including S. pneumoniae, S. pyogenes, S. mutans, S. agalactiae, S. equi, S. canis, S. bovis, S. equinus, S. anginosus, S. sanguis, S. salivarius, S. mitis; other pathogenic Streptococcal species, including Enterococcus species, such as E. faecalis and E. faecium; Haemophilus influenzae, Pseudomonas species, including P. aeruginosa, P. pseudomallei, and P. mallei; Salmonella species, including S. enterocolitis, S. typhimurium, S. enteritidis, S. bongori, and S. choleraesuis; Shigella species, including S. flexneri, S. sonnei, S. dysenteriae, and S. boydii; Brucella species, including B. melitensis, B. suis, B. abortus, and B. pertussis; Neisseria species, including N. meningitidis and N. gonorrhoeae; Escherichia coli, including enterotoxigenic E. coli (ETEC); Vibrio cholerae, Helicobacter pylori, Geobacillus stearothermophilus, Chlamydia trachomatis, Clostridium difficile, Cryptococcus neoformans, Moraxella species, including M. catarrhalis, Campylobacter species, including C. jejuni; Corynebacterium species, including C. diphtheriae, C. ulcerans, C. pseudotuberculosis, C. pseudodiphtheriticum, C. urealyticum, C. hemolyticum, C. equi; Listeria monocytogenes, Nocardia asteroides, Bacteroides species, Actinomycetes species, Treponema pallidum, Leptospirosa species, Klebsiella pneumoniae; Proteus sp., including Proteus vulgaris; Serratia species, Acinetobacter, Yersinia species, including Y. pestis and Y. pseudotuberculosis; Francisella tularensis, Enterobacter species, Bacteroides species, Legionella species, Borrelia burgdorferi, and the like. As used herein, the term “targeted bioterror agents” includes, but is not limited to, anthrax (Bacillus antracis), plague (Yersinia pestis), and tularemia (Franciscella tularensis).

As used herein, the term “fungi” shall mean any member of the group of saprophytic and parasitic spore-producing eukaryotic typically filamentous organisms formerly classified as plants that lack chlorophyll and include molds, rusts, mildews, smuts, mushrooms, and yeasts. Exemplary fungi include, but are not limited to, Aspergillus species, Dermatophytes, Blastomyces derinatitidis, Candida species, including C. albicans and C.krusei; Malassezia furfur, Exophiala werneckii, Piedraia hortai, Trichosporon beigelii, Pseudallescheria boydii, Madurella grisea, Histoplasma capsulatum, Sporothrix schenckii, Histoplasma capsulatum, Tinea species, including T. versicolor, T. pedis T. unguium, T. cruris, T. capitus, T. corporis, T. barbae; Trichophyton species, including T. rubrum, T. interdigitale, T. tonsurans, T. violaceum, T. yaoundei, T. schoenleinii, T. megninii, T. soudanense, T. equinum, T. erinacei, and T. verrucosum; Mycoplasma genitalia; Microsporum species, including M. audouini, M. ferrugineum, M. canis, M. nanum, M. distortum, M. gypseum, M. fulvum, and the like.

As used herein, the term “protozoan” shall mean any member of a diverse group of eukaryotes that are primarily unicellular, existing singly or aggregating into colonies, are usually nonphotosynthetic, and are often classified further into phyla according to their capacity for and means of motility, as by pseudopods, flagella, or cilia. Exemplary protozoans include, but are not limited to Plasmodium species, including P. falciparum, P. vivax, P. ovale, and P. malariae; Leishmania species, including L. major, L. tropica, L. donovani, L. infantum, L. chagasi, L. mexicana, L. panamensis, L. braziliensis and L. guyanensi; Cryptosporidium, Isospora belli, Toxoplasma gondii, Trichomonas vaginalis, and Cyclospora species.

By ‘capture’, ‘retain’ and related terms in the context of the matrix and biological molecules including large molecules and fragments of large molecules, it is meant that the matrix and molecules interact such that the molecules especially large molecules are retained on and/or in the matrix after the molecules are exposed to the coagulant. The interaction is typically non-covalent, and may be an intermolecular interaction or simple retention on the basis of size. The specific nature of the interaction is not critical. However, the matrix can retain molecules especially large molecules such as (and not limited to) DNA, RNA, protein and glycans following addition of the coagulation medium, allows for washes as needed, prevents excessive aggregation, allow for smaller molecules to be captured in the flow through thus separating the small molecules from the large molecules, that the matrix allows for chemical and/or enzymatic treatment such as with (and not limited to) protease, nucleases and glycosidases, and the matrix allows the molecules or fractions of molecules to be eluted afterwards, most preferably in separate elution steps. If needed, bound molecules can be washed with a solvent which does not dissolve the captured molecules; correspondingly, different classes of molecule are eluatable and thus fractionateable with different solvents.

In the following, “matrix” shall mean “one or a combination of matrices.”

The term herein “analyte” means the molecule or molecules desired to analyze which could include proteins, DNA, RNA, glycans, lipids, small molecules such as metabolites, drugs and vitamins, etc. Analytical techniques which can be used to analyze analytes are well known to one skilled in the art and include mass spectrometry, NMR, antibody assays, nanopores, nucleic acid tagging technologies, and many others.

The term herein “contaminant,” mean moieties which interfere with downstream processing and/or analysis. Contaminants may include salts, buffers, chaotropes, detergents, or components which are naturally found in the sample such as phospholipids or components which are added to the sample by the user during other sample treatment steps such as reduction and alkylation reagents.

The term herein “robustness,” means that use of the system, its assembly or components in the methods of the present application produce results which are highly reproducible.

The term herein “throughput” means the speed at which a single sample can be processed, or the speed and ability to process multiple samples in parallel, often by automation.

The term herein “simple-to-use,” means the ability to maintain all desired aspects of sample treatment and manipulation including recovery and separation of analytes, robustness and throughput with minimal former training with minimal chance for the perturbations in the sample processing to result in failed treatment.

As referred to herein, “a strong chaotropic agent” is a reagent that causes total denaturation of biological molecules and typically prevents capture and binding to the capture matrix. Chaotropes are compounds of many kinds that induce disorder in biological macromolecules and supramolecular assemblies, disrupting especially hydrogen bonds. They tend to disrupt phospholipid membranes and weaken or unfold the three-dimensional structures of proteins and nucleic acids. The exact mechanism in which chaotropes work is complex and depends on the specific substance; some are more disordering than others at the same concentration and we thus recognize stronger and weaker chaotropes. Urea and guanidinium salts are commonly recognized as strong chaotropes that, in high enough concentrations, cause total denaturation and typically dissolution of biological samples and their molecules at large concentrations such as 8 M or 6 M. Strong chaotropes are to be avoided in the choice of extraction solvents of the present invention as they inhibit coagulation and thus prevent binding.

As referred to herein, “a mild chaotropic agent” is a chaotropic agent that does not fully denature biomolecules and that facilitates binding to the trapping matrix. Mild chaotropes give molecules structural freedom and encouraging protein extension and denaturation while not completely linearizing biopolymers and denaturing biomolecules. Such mild chaotropes reduce the amount of order in the structure of a protein formed by water molecules, both in the bulk and the hydration shells around hydrophobic amino acids, which allows molecules to present typically hydrophobic interior regions to each other as well as the binding surfaces of the matrix, resulting in binding. Many kinds of molecules are chaotropes that can effect various levels of disorder in biological molecules including, and are not limited to, alcohols and other organic solvents such as benzene, sugars, glycerol, zwitterions, even vanillin among many, many other compounds (see Timson, D. J. (2020). The roles and applications of chaotropes and kosmotropes in industrial fermentation processes. World Journal of Microbiology and Biotechnology, 36(6). doi:10.1007/s11274-020-02865-8). Like the science of chaotrops in general, with regard to the present invention, the determination of the strength chaotropicity of a given agent is an empirical one which hinges on the chaotrope's ability to facilitate coagulation of the analyte molecules of interest to the binding matrix at hand. Mild chaotropes function only in the context of the combination of the extraction solvent and molecule coagulant.

As referred to herein, a “molecule coagulant” shall mean a reagent or combination of reagents which when mixed with the extraction solvent, which may have been pH adjusted, promotes the retention and binding of analytes of interest in the protein trap via especially non-covalent mechanisms such as hydrophobic or hydrophilic interactions or ionic interactions. Molecule coagulants are so chosen that they do not cause excessive aggregation of coagulated analyte molecules, which would impede flow through the binding or capture matrix, though they may promote intermolecular interactions to make analyte molecules more apt to bind to the capture matrix. In many embodiments, while coagulants promote binding, they do so in a mostly native state of biomolecules. A potential coagulant can be easily tested by first determining if it hinders sample processing, which would indicate that it causes excessive aggregation, second if it promotes binding (e.g. analyze flow through for, by example, the presence or absence of protein, if that molecular class is of interest), and third if it hinders subsequent processing steps (such as treatment with reduction and alkylation reagents followed by trypsin). Effective molecule coagulants must not hinder sample processing, must promote binding, and must not hinder subsequent processing done on- or in-matrix.

As referred to herein, an “extraction solvent” shall mean a solvent with the ability to dissolve or substantially dissolve, perhaps under conditions of agitation such as physical agitation or thermal agitation or sonic or ultrasonic agitation, one or more classes of desired analyte molecule. While in principle extraction solvents might have components such as urea or detergents, the presence of such non-volatile compounds interferes with downstream analysis. Examples of extraction solvents include hydrophobic organics chosen to dissolve hydrophobic components of a sample like lipids and hydrophobic proteins, which might then be made less hydrophobic by the addition of a more polar molecule coagulant, causing the hydrophobic components to bind to the matrix, volatile acids and bases such as hydrochloric acid or formic or acetic acid or other mostly volatile acids, or ammonium hydroxide or tetramethylammonium hydroxide, all of which can be neutralized, which are mass-spec compatible and which can be mixed with molecule coagulants to cause the aggregation of analytes on the matrix.

Extraction solvents and molecule coagulants should preferably be volatile mixtures, or mixtures which do not interfere with down-stream analysis, or alternatively mixtures from which interfering components can be easily and quickly removed to non-interfering levels. Extraction solvents and molecule coagulants must be so chosen they, once combined, yield conditions that promote analyte binding to the matrix. Extraction solvents and molecule coagulants can be mixtures and dissolve substances of interest, can be easily handled in or do not interfere with downstream analysis and processing, and must have conditions (of temperature, time, pH, concentration, etc. all of which might be different depending on the kind of matrix) that foster the binding or coagulation or capture of one or more class of molecule of interest to the matrix.

### Capture Matrix

Herein disclosed is a two-piece sample processing assembly with integrated matrix which enhances the speed and simplicity of sample processing that requires incubation steps, which formerly necessitated the repeated application and removal of plugs, causing delay, irreproducibility, inability to automate and sample loss. The assembly can be used in any case where some fraction of a sample must be passed through a matrix, and the material which is retained on or in or by the matrix will be further treated with a reagent that requires time to operate i.e. requires an incubation under some conditions of time, temperature, etc. The assembly is consequently useful in many analytical fields from analysis of environmental to clinical samples. While the exact protocols of use depend fully on the composition of the matrix and treatments received by the samples, disclosed herein are the steps to produce samples of metabolites, lipids, nucleic acids, glycans and proteins. In many embodiments, the assembly is to be fabricated by injection molding of plastics and is disposable to prevent sample crossover and contamination. The assembled system especially in the lower parked position is specifically contemplated to be exposed to conditions conducive to treatments afforded to the samples bound or retained on or in or by the matrix. Such treatments might include especially temperature and sonic energy, but other treatments are possible.

It is preferred that the matrix is a porous or fibrous material which is able to be penetrated by the medium comprising the large molecules. Such a porous or fibrous material may also be formed from a powder or pieces or beads. Furthermore, the matrix should be a suitable material to permit the large molecules to be reversibly captured by the matrix. The matrix, through its pores and rough surface, affords in ultrasonication nucleation promoting features which lower cavitation thresholds (ultra)sonication bubble nucleation, growth and collapse, and in so doing, promote the action of (ultra)sonication in an on and within the matrix. The methods herein, thus may speed sonic or ultrasonic processing steps.

The presence of such a matrix allows for aggregation of the large molecules to be moderated from the medium to which the coagulant has been added. If no such matrix were present, the large molecules would tend to aggregate together in an uncontrolled manner. This is undesirable as it makes further processing of the large molecules more difficult or impossible. For example, digestion of captured proteins with a protease is impeded without aggregates first being disrupted by a chaotropic agent such as concentrated urea, or a detergent, either and all of which can then interfere in downstream analysis. Similarly, a nuclease may be unable to access DNA which is aggregated together with proteins and other co-aggregated molecules, or a glycosidase unable to access glycans including those attached to proteins.

Essentially, capture of large molecules in the matrix also allows for their sequential elution, which is essential to the generation of multiple classes of analyte for multi-omics analysis. Furthermore, having the large molecules captured in the matrix allows for washing (rinsing) of the matrix and large molecules to be performed to remove any contaminants and/or separate different molecular classes whilst ensuring the captured molecules are not lost or diluted excessively, which would make further processing problematic.

There are many materials which are potentially suitable for use as a matrix in the present application, and therefore the choice of a specific set of materials is not limiting. Various exemplary suitable materials, and general properties of such materials, will be described below, but it will be apparent to the skilled person that other materials can be used, including small beads used in chromatography, or surfaces otherwise derivatized for sample processing such as a C18 surface (on beads or on a membrane) or a mixed bed containing, by example, reverse phase and ion exchange media comingled, or any other material which fulfils the below criteria, and which may have additional properties.

While many other matrices are possible, particularly preferred matrixes comprise depth filter materials.

The key consideration in the context of the present application is that the matrix (typically a depth filter) is able to bind and retain the (typically large(r)) molecules supplemented with a coagulation media and retain those molecules during subsequent washing and processing steps, maintain them in a form such that enzymes can be used to alter the physical state of the retained molecules, especially to reduce the size of larger molecules such as proteins, DNA and RNA, or glycans, or to free from captured molecules moieties of interest such as glycans or lipids or ubiquitination or other molecular feature which can be accessed with chemical and/or enzymatic treatments. The suitability of any putative matrix can be assessed by testing it in a protocol as described in the examples below. One of ordinary skill will be able to identify alternative suitable matrix materials.

By way of general guidance, the matrix typically:
is adapted to capture and retain fine and very fine particles, e.g. from several micrometers (e.g. 20 μm or less, 10 μm or less, 5 μm or less, or 2 μm or less) to sub-micrometer size range (e.g. down to 0.2 μm or even 0.1 μm in size);
is substantially inert with respect to the molecules of the sample;
is able to reversibly capture (i.e. retain) molecules such as proteins and DNA or RNA or lipids or glycans, from the sample when the sample is exposed to a coagulation medium;
allows for chemical and/or enzymatic processing of the captured molecules, for example a protease can be used to digest the proteins in situ, or a nuclease can be used to produce smaller sizes of DNA or RNA, or a glycosidase can release glycans from protein or does not bind to, and therefore retain, the surfactant to any significant extent.

The capture matrix, which can be a depth filter, but which simply must be porous, may in some embodiments be derivatized with enzymes for processing of the sample, for example with proteases or nucleases or lipases or glycosidases.

The matrix is held within the inner vial by a variety of techniques known to one skilled in the art including hermetically sealing or plastic welding or heat welding or ultrasonic welding or alternatively by the physical size of the matrix and friction as it is forced into the narrowing bottom of the inner vial or the use of adhesives or frits or support systems such as screens or plastic scaffolding, which could include support or retention rings or screens among other possibilities.

The matrix or matrices can be anything porous such as filtration material, chromatographic material, material with affinities, membranes, frits, SPE material, filters, depth filters, etc. In the case of lose chromatographic beads, frits can be afforded at the bottom and top, or only the bottom. Suitable materials for the matrix of the present application include porous matrices such as sintered materials or porous plastics or membranes of defined or approximately defined porosity. Exemplary materials include porous polyethylene (PE), polypropylene (PP), polytetrafluoroethylene (PTFE) and sintered polytetrafluorethylene. Suitable materials might also include porous materials made by sintering glass or other materials, various filters including paper or glass or depth filters, glass membrane filters, membranes with specific molecular weight cutoffs, or membranes with specific pore sizes such as 0.2 micron, 2 micron, 20 micron, among many others. In addition to membranes and sheets, matrices can include lose beads or powders, depending on the use case. If lose powder, the dimensions of the particles (particle diameters) may be of a size similar to liquid chromatography, or may be slightly larger or smaller to afford control over the force required to move solvent through said matrix material. Similarly, pore size of porous matrices including membranes can be modified to alter the rate of flow of solution through the matrix. The matrix may be hydrophilic or hydrophobic and may be chosen to be water or organic-solvent wettable.

One skilled in the art will recognize that a huge variety of surfaces or medias can be employed for the matrix or matrices including materials useful for SPE materials, reverse phase materials such as bonded phase silica and including by example C4, C8 or C18 packing materials, or chelating surfaces to capture materials like metals, or polymeric polymer particles which present a hydrophobic surfaces, or ion exchange resins such as SCX, SAX which present negatively or positively charged surfaces, or weak cation or ion exchange, or gel filtration material of particles with pores of a given size to facilitate retention of analytes of some given radius or molecular weight, or affinity based support, including surfaces such as IMAC for metal affinity chromatography, or other affinities such as and not limited to antibodies against antigens or haptens or PTMs of peptides such as phosphorylations of YST or ubiquitin or acetylations or methylations or lipidations or antibodies against particular motifs or titanium dioxide to capture phosphorylated residues or silicon carbide for nucleic acid (DNA and RNA) affinity or streptavidin for biotinylated moieties or fluorinated surfaces to capture halogenated compounds, or antibody based capture materials such as protein A or G, or chelators, or any similar matrix material used in chromatography such as high performance liquid chromatography. The matrix may be partly or fully comprised of a monolithic material with any of the above affinities, or other affinities.

The device may comprise a secondary matrix, likely a hydrophobic matrix disposed between the primary matrix and the outlet, i.e. downstream of the primary matrix. One skilled in the art will recognize that many other matrices are possible.

Suitably the secondary matrix extends across the entire lumen of the vessel such that anything flowing from the inlet to the outlet must pass through at least a portion of the secondary matrix.

The outlet may lead to a sump or reservoir adapted to collect various media, reagents, buffers and the like which pass through the matrix, and in particular different fractions of different molecules with different solubilities.

The eluted molecules or fragments can suitably pass to a secondary matrix. Suitably the secondary matrix might be a hydrophobic matrix, e.g. a stationary hydrophobic phase suitable for reverse phase chromatography (RPC). The most column RPC matrices are based upon silica substrates, for example, silica with alkyl chains bonded thereto, but any inert hydrophobic solid phase could, in theory, be used. A particularly preferred hydrophobic matrix comprises octadecyl carbon chain (C18)-bonded silica, C8-bonded silica, or a combination of the two, but other suitable matrices include cyano-bonded silica and phenyl-bonded silica. Alternative secondary matrices might ion exchange, or hydrophobic interaction chromatographies or alternatively affinity chromatography based either on larger molecule affinity reagents such as aptameres or antibodies or alternatively chemistries like IMAC or titanium dioxide for phosphorylation. Similarly RNA can be enriched with oligo-thymidine, or glycans with boron affinity chromatography or lectins. One skilled in the art will understand that could be coupled with this application in many different embodiments such as with loose beads held with a frit, or derivatized membranes such as Empore C18. The secondary matrix can have several roles, e.g.: it functions as a mechanical support for the primary matrix, it acts as a guard filter to capturing stray particles and shed fiber material from the primary matrix, and it assists in the final clean-up of the molecules and fragments of molecules which were captured and processed; and it can allow for chromatographic resolution of the molecules and fragments of molecules which were captured and processed.

In some preferred embodiments of the application which include a reverse phase secondary matrix, the application comprises the step of eluting the molecules and fragments of molecules which were captured and processed from a hydrophobic, secondary matrix using a series of eluents or gradient of eluent of increasing hydrophobicity. Thus the method can provide a degree of chromatographic separation of the molecules and fragments of molecules which were captured and processed based on their hydrophobicity. This allows the population of captured molecules or fragments thereof to be resolved on the basis of hydrophobicity which can aid in later analysis. For this purpose a secondary matrix comprising C8-bonded silica is very useful. A suitable series of eluents comprises, consecutively, 5% ACN in water, 10% ACN in water, 15% ACN in water and then 60% acetonitrile in 0.5% formic acid (FA); such a series allows for four fractions to be obtained from the captured molecules.

The device may be a modified pipette tip. Other types of vessels are contemplated, e.g. vessels adapted for automated and/or high throughput sample preparation and/or spin columns

Capture

Especially large molecule capture, after addition of coagulation medium, is achieved through a combination of two capture mechanisms. Any precipitated particles are physically trapped in the filter pores and other in-solution material is adsorbed on the filter via non-covalent interactions with the filter surface. One skilled in the art will recognize that there are many different solutions which can specifically cause the coagulation of specific classes or combinations of classes of kinds of biomolecules, such as lipids, glycans, proteins, peptides, nucleic acids. For example, the coagulation and capture of proteins is facilitated by the addition of an organic solvent such as methanol, other alcohols or many other organic solvents.

Alternatively, the capture of lipids is facilitated by the use of an aqueous solvent, and lipids and other small molecules can be separated in the flow through by the use of a biphasic organic solution such as mixtures of methanol, water and methyl-tert-butyl-ether (MTBE), solutions which also cause protein and DNA and RNA and glycans to precipitate and/or be bound within the trapping matrix.

In the case of a size-based retention, i.e. where particles are trapped in pores because of their size or size of aggregated particles or particulate, elution may be achieved after chemical and/or enzymatic treatment to reduce large molecules to smaller sizes. By non-limiting example, captured protein can be broken into protein fragments of smaller size (peptides) by proteases or chemical treatment or sheering by sonic energy. Similarly glycans can be liberated from captured proteins by treatment with glycosidases, or larger glycans can be processed to smaller pieces by glycosidases, lipids can be freed from trapped material including protein (for lipidated proteins) or larger lipids broken into smaller pieces, and nucleases or sonic sheering can produce shorter lengths of DNA and RNA, by non-limiting example for the generation of libraries. This method relies on the capture of one or more class of molecule while another or others is/are left soluble, and thus pass(es) through the pores for subsequent analysis.

The capacity (and hence volume) of the matrix should generally be sufficient to trap substantially all of the (large) molecules in the sample without becoming clogged regardless by which mechanism the (large) molecules are retained. However, it will be apparent that the required matrix capacity depends, inter alia, on the concentration of the molecules in the sample. Suitable matrix volumes can be determined by trial and error, and typically there will be no problem encountered if a higher volume of matrix is provided than is strictly required, other than it may require more reagents to wet, wash, and enzymatically or chemically process the sample and to elute the resultant processed molecules.

The coagulant causes some part or fraction of the biomolecules to adhere to or be captured or retained upon or within the matrix in a reversible manner. Typically, though not exclusively, this will include proteins, DNA, RNA and glycans. Most typically small molecules such as (and not limited to) metabolites will pass through. However by varying the extraction solvent(s) used, it is possible to capture and retain other classes of molecule such as (and not limited to) lipids. With enough time, it is possible that especially protein and DNA/RNA will precipitate and form a suspension of fine particles; this precipitation is not obligatory. What is obligatory is that the coagulant does not cause severe precipitation which renders the precipitant insensitive to enzymatic treatment (e.g. with digestion trypsin or LysC or PNGase F or nucleases), especially under aqueous conditions. It is noted that while a sample can be clarified by example by centrifugation after exposer to the extraction solvent, the entire sample can also be loaded including debris; this will then be subjected to whatever further extractions and/or chemical and/or enzymatic processing steps.

### Depth Filters

Depth filters are a type of filters that use a porous filtration medium to retain particles throughout the medium, rather than just on the surface of the medium (as is the case with membrane/surface filters). Depth filters are commonly used when the fluid to be filtered contains a high load of particles because, relative to other types of filters, they can retain a large mass of particles before becoming clogged (for more information on depth filters, and other filters, see Derek B Purchas and Ken Sutherland, Handbook of Filter Media (2nd Edition), Elsevier Advanced Technology (2002)).

Depth filters typically have a random network of pore channels that vary in size and geometry. They are manufactured from a variety of solid materials. Materials of construction include various forms of quartz, polymers, cellulose, and glass, either singly or in combination. The processes used to manufacture depth filters do not result in a regular arrangement of the solid matrix. Instead, there is a range of pore sizes within a given structure that includes pores significantly larger and significantly smaller than the nominal pore rating.

Depth filters are typically made out of one or more of the following materials:
Quartz;
Glass fiber;
Polymers;
Cellulose; and
Cellulose with other additions such as diatomaceous earth.

Preferred depth filters for use in the present application are formed from cellulose, filled cellulose, quartz, glass fiber or polymers. The filter material should typically be inert with respect to the molecules which are being processed and reagents used in the method, so that undesirable reactions are avoided.

Depth filters are not typically characterized by a defined pore size in the same way as membrane filters (surface filters), and the pore size is typically highly variable. Thus it is imprecise to define a specific pore size for a depth filter-based matrix. Depth filters are often referred to in terms of target particle size retention, e.g. 5 μm, 1 μm or the like. The format of depth filters is highly diverse from sheets to cartridges to pleated filters in a huge variety of physical formats.

Particularly preferred depth filters for the present application include quartz, borosilicate depth filters, cellulose and/or cellulose plus diatomaceous earth or minerals or carbon or other materials, many forms of which are available from many suppliers such as Ahlstrom, Eaton, EMD Millipore, ErtelAlsop, Filtrox, HOBRA-Školnik, Pall, Sartorius, Whatman, or alternatively of a proprietary composition and construction, so long as the material substantially corresponds to the properties of a depth filter.

Depth filters have a random network of pore channels that vary in size and geometry. They are manufactured from a variety of solid materials. Materials of construction include various forms of plastics, cellulose, and glass, either singly or in combination. The processes used to manufacture depth filters do not result in a regular arrangement of the solid matrix. Instead, there is a range of pore sizes within a given structure that includes pores significantly larger and significantly smaller than the pore rating.

The randomness of the structure does not allow the assignment of a definitive upper limit on the size of particles that may pass through the filter. A portion of the particles in the filtrate will exceed the pore rating. Depth filters also can entrap a large percentage of particles smaller than the pore rating. Because depth filters trap particles throughout the structure, they typically exhibit a high particle-handling capacity. This makes them particularly useful in applications where the solution being filtered has a high particle load. Depth filters are not considered sterilizing-grade.

Various grades of depth filters may have different pore sizes, i.e. Grade 4 (20-25 μm pores), Grade 598 (8-10 μm pores) and Grade 3 (6 μm pores) can be used and will achieved some degree of retention, but the finer or coarser filters may provide improved performance, depending on the properties of the molecules to be allowed to pass through and those desired to be retained on the filter. Thus the indication is that depth filters in the trapping range of from 15 μm down to 0.1 μm (or even smaller) are preferred, e.g. about 15 μm or finer, about 5 μm or finer, about 1 μm or finer, about 0.5 μm or finer being suitable.

Depth filters are typically used as pre-filters because they are an economical way to remove ≥98% of suspended solids and protect elements downstream from fouling or clogging. They owe their high capacity to the fact that contaminants are trapped and retained within the whole filter depth.

Conventional depth filters can be made out of the following materials:
Quartz
Glass Fibre
Polymers
Cellulose
Cellulose with fillers such as diatomaceous earth

Quartz. Filter media made of pure micro-quartz fibres. Such media can be produced with or without glass fibres and binder. Media without glass fibres and binder are particularly appropriate for emission control at high temperatures of 900-950° C. and wherever absolute purity of the filter medium is required. Excellent filtration properties, minimal metal contents, outstanding weight and dimension stability.

Glass Fibre. As implied by the name, glass fibre depth filters are made from glass fibres. In sheet form the fibres are initially held together only as a consequence of mechanical interaction. To improve the handling characteristics, the filter is sometimes treated with a polymeric binder, such as polyvinyl alcohol, which serves to hold the matrix together. Glass fibre filters are also prone to fibre shedding. If required, a membrane filter can be placed downstream to retain any fibres. Examples include GF/D (Whatman), a filter material which is utilised in the above-mentioned examples.

Polymers. Polymeric depth filters are manufactured from plastic fibres of various lengths, morphologies, and diameters. To improve the strength of these filters and reduce the level of fibre shedding, the filter can be calendared, the process of running the material between cylindrical rollers to apply pressure and/or heat. Most polymeric depth filters are inherently hydrophobic. For low pressure aqueous filtration, the filter may require a surface treatment to render it wettable. Polymeric depth filters are normally very strong and easy to handle.

Cellulose. As implied by the name, cellulosic depth filters are made from cellulose fibres. The fibres can be derived from a relatively crude source, such as wood pulp, or a highly purified source, such as cotton. The filters are manufactured by techniques very similar to paper manufacture and are very economical. Although they are generally very easy to handle when dry, they are mechanically very weak when wet. Cellulosic filters are prone to fibre shedding during fabrication into a device and when used in filtration. If required, a membrane filter can be placed downstream to retain any fibres. Cellulose fibres may also be a source of contaminants, however the ability of cellulose filters to be embedded with other materials such as diatomaceous earth presents unique opportunities. Various such forms, highly purified, may well be useful.

### Buffers

Conventional methods for precipitating in preparation for mass spectrometry are harsh and cause dramatic precipitation and aggregation which render them rather insensitive to enzymatic activity. By example with proteins, exemplary precipitants in prior art methods include trichloroacetic acid (TCA), typically a 100% w/v solution (500 g TCA into 350 ml dH2O). See, for example Curr Protoc Protein Sci. 2010 February; CHAPTER: Unit-16.12. Such precipitated proteins must be treated with strong chaotropic agents to render them susceptible to protease action. Exemplary chaotropic agents for such purposes include urea (e.g. at 8M concentration) and the like, or with detergents or the like.

The present application can involve the use of buffers and the like which could be considered to be mildly chaotropic. For example, a preferred buffer for the present application is based upon methanol and ammonium acetate. One specific embodiment is 50% methanol as a coagulant with 50% 30 mM ammonium acetate containing 3% nonionic detergent. Another specific and preferred embodiment is four volumes of methanol as a coagulant containing 30 mM ammonium acetate (made in anhydrous methanol from an aqueous 1 M ammonium acetate stock solution) added to sample extracted in 30 mM ammonium acetate with probe sonication. Another specific embodiment is 50% methanol with 30 mM ammonium acetate as a wash solution. These compositions have far less chaotropic effects on biomolecules, including those which are precipitated and aggregated, including (and not limited to) DNA and protein, quite unlike urea or guanidinium hydrochloride.

Suitably the coagulant comprises a mixture of aqueous and organic solvents, most typically in the range of two parts methanol to one part aqueous extraction solution to ten parts methanol to one part aqueous extraction solution. It is apparent to one skilled in the art that methanol is only a representative organic solvent, and that many others might be used to the same ends.

The aqueous extraction solution can be neutral, such as in the specific embodiment of 30 mM ammonium acetate, which is near pH 7, or basic, such as 1.8% ammonium hydroxide, or acidic, such as 1 M HCl or formic acid.

Aqueous extraction solvents around neutral are the preferred embodiment when proteins are to be captured in their native states, for example for later enzymatic processing. The extraction solution can contain detergents, and detergents are typically not ideal because they interfere with downstream analysis of the classes of molecule which did not bind to the capture matrix. The concentrations of buffer such as ammonium acetate in a neutral aqueous extraction can be varied from 1 mM to as high as multiple molar, depending on the kind and class of molecules desired. Similarly, the concentration of base can vary from less than 1% to the maximum of solubility, for example for ammonium hydroxide a maximum of 35.6% w/w; typically 1%-5% base is most suitable, though other embodiments are possible.

In basic extractions ammonium hydroxide is preferred due to it volatile nature. The concentration of acid in an aqueous acidic extraction solution falls between 10 mM and multiple molar, again optimized depending on the desired class of molecules. It should be noted that in preferred embodiments, volatile acids, bases and buffers are desired as they can be removed by speed-vacing. It should also be noted that capture is best around neutral pH, and also noted that while the extraction solution is typically aqueous, there is no reason it must be aqueous so long as it enables the capture and fraction mechanism(s) described below. It is apparent to one skilled in the art that there exist many buffers, acids and bases, and coagulants, and that the substances described in this paragraph serve only as illustrative examples and are not limiting.

Typically acidic or basic extractions are favored because at non-physiological pH values, enzymes that could degrade a sample such as and not limited to proteases, phosphatases, lipases, glycosidases, nucleases and other are inactive or poorly active.

To determine the needed concentration of coagulant, typically a solution of the sample extracted with extraction solvent is exposed to varying concentrations of coagulant, allowed to flow through the trapping matrix (typically a depth filter) and the flow through is first concentrated, then analyzed for the class of molecule which were intended to be captured. For example, in the embodiment where the flow through contains small molecules such as metabolites and protein and DNA and RNA and glycans are retained on the trap, one would analyse for proteins by example by SDS PAGE and for DNA by e.g. polyacrylamide gels, each kind of gel being visualized by their respective stains (e.g. colloidal Coomassie, lectins and ethidium bromide, among many other stains for both proteins, nucleic acids and glycans). If the desired class of protein has not been captured, a different coagulant or different concentration must be tried, until reversible capture of the molecular class is achieved. In one test, it was found for an aqueous solution containing antibodies that a six-to-one volume excess of methanol afforded good capture.

Other methods of coagulating molecules onto the matrix may also be suitable for the present application. For example, salts can be used to drive ‘salting out’ precipitation. In such embodiments, the downstream implications of such coagulation methods must be considered. For example, PEG can be used to drive things out of solution, however PEG would make downstream analysis near impossible.

The suitability of any coagulant for use in the present application can be tested using the methodology described below. In particular, any coagulant should be able to cause biomolecules or molecules which have been solubilized with an extraction solution, which if it was not near neutral, will be brought to around neutral before capture, to be captured on the trapping matrix, and the molecules so retained should be capable of being treated in the device and/or on the capture matrix with enzymes such as (and not limited to) a nuclease, protease (typically trypsin), glycosidase, among many other enzymes or alternatively various chemistries, without the need for solubilization with a strong agent such as a chaotropic like urea or a surfactant or detergent. As mentioned above, given too much time molecules can aggregate and precipitate which might potentially lead to enzymes such as protease no longer being effective. Accordingly, sensitivity to enzymatic and/or chemical treatments should be assessed immediately after capture of molecules on the trapping matrix, or, ideally, following capture of the molecules in the depth filter trapping matrix as described above. Time courses for the period of exposure of the sample to coagulant may also be performed. Furthermore, the coagulant should not prevent downstream analysis of extracted and potentially processed molecules using mass spectrometry.

The sample comprising a sample extraction solvent and coagulant is typically brought into contact with the trapping matrix, although the matrix can also deal with any precipitation or debris from the sample, and the vessel holding the trapping matrix may hold the coagulant and the extraction solvent may be directly added to the coagulant.

Where the extraction solvent/coagulant mixture is added to the matrix, the matrix may already be permeated with a fluid medium (phase), i.e. a solution and typically a fluid which matches the composition of the extraction solvent/coagulant mixture. Preferably the fluid medium which permeates the matrix is mildly chaotropic. For example it can comprise an aqueous solution of a short chain alcohol, e.g., methanol, ethanol or propanol, or other organic solvents. Most preferred is an aqueous methanolic solution, e.g. typically comprising 60% or higher.

An exemplary, and generally preferred, extraction solvent/coagulant mixture is sample extraction with one volume of 30 mM ammonium acetate mixed with four volumes of a coagulant in particular for this example methanol containing 30 mM ammonium acetate, whereby anhydrous methanol is supplemented to 30 mM ammonium acetate from an aqueous 1 M ammonium acetate stock solution.

The step of washing the trapping matrix with captured molecules is not obligatory for captured endogenous molecules however it is obligatory if proteins have been reduced and alkylated or otherwise chemically manipulated on the trapping matrix; this will typically take place after recovery of the smaller molecules such as lipids and metabolites. Washing also removes contaminants, and any suitable washing liquid which solubilizes the contaminants or reduction/alkylating reagents (or reagents of any other chemical treatment such as cleavage or deamidation or oxidation) which does not solubilize molecules of interest can be used. A suitable liquid is the various aqueous methanolic solutions containing ammonium acetate described above. However, other liquids would be suitable, and the suitability of any putative washing liquid could be readily tested. Typically mild chaotropes are useful for this purpose. They should ideally be mass spec compatible.

In some situations it may be desirable to remove the washing liquid, e.g. where presence of that liquid might have an adverse effect on the activity of subsequently administered processing enzymes such as proteases or nucleases or glycosidases, and to replace it with another buffer. This is easily accomplished with a first wash step using an aqueous methanolic solution to remove reduction and alkylation reagents (other organic solvent compositions could be used), and a second rinse to remove residual methanolic solution, e.g. using water or an aqueous ammonium bicarbonate solution. Aqueous buffers containing reagents such as ammonium bicarbonate or acetate, and many other known to a person skilled in the art, plus any necessary cofactors, can then be used for the purpose of downstream processing.

### Processing

In this application, the enzymes such as proteases or nucleases or glycosidases used to treat the captured molecules are administered after the small molecules have been separated and captured in the flow through of the solvent extraction solution combined with the coagulation solution. Digestion of the proteins with a protease is a conventional step in the preparation of proteins for analysis by mass spectrometry. Typical proteases include trypsin or LysC, but it can be any other suitable protease, e.g. chymotrypsin and many others. For example, 0.07 μg/μl of trypsin (03708985001, Roche or V5111, Promega) in 50 mM ammonium bicarbonate can be used in embodiments of the application. Glycans can be cut or processed or liberated by enzymatic means. N-linked glycans can be released with peptide-N-glucosidase F (PNGaseF). PNGaseF releases most glycans except those that contain 1-3 linked fucose to the reducing terminal GlcNAc. In that case, the enzyme peptide-N-glucosidase A (PNGaseA) is used. There are fewer enzymes comparable to PNGAseF for O-linked glycan release and subsequent analysis. Typically the release of O-linked glycans is achieved through chemical methods such as β-elimination. However, Genovis offers an o-protease for O-glycan-specific digestion of glycoproteins (OpeRATOR), an endoglycosidase (O-glycosidase) for O-glycans of core 1 and core 3 (OglyZOR) and an exoglycosidase which acts on sialic acids (SialEXO); all these enzymes can be used in embodiments of this application, most preferably applied to the trapping matrix.

The enzymes used to process captured molecules such as proteases or nucleases or glycosidases or lipases or other enzymes are typically added to the medium permeating the matrix. Multiple enzymes can be used either serially or in parallel. For example, large molecules can be separated and captured in the trapping matrix as described above with capture of the small molecules. Glycans can be freed or cut with PNGase F, which can be recovered with an aqueous wash as they are highly water-soluble. Proteins are left behind, which can then be reduced and alkylated in situ, followed by digestion with proteases as described above. In another example, in the case that the nucleic acids of samples are not of interest, nucleases and proteases can be added simultaneously, so long as the protease does not instantly digest the nuclease.

Suitably the method comprises the step of desalting the captured molecules and/or their fragments. Desalting can be achieved by rinsing the molecules with salt free buffer and/or water and/or water mixed with organic solvents such as methanol. Desalting can be either within the trapping matrix, in which case molecules are simply washed, or alternatively in some embodiments the application has other affinities such as C8 or C18 (see below).

### Elution

The molecules and their fragments can be eluted using any suitable agent. Water is useful for dissolving glycans, and can solubilize DNA and RNA. DNA and RNA can be solubilized in TE buffer (1 mM EDTA 10 mM tris pH 8.0). Basic solutions (e.g. ammonium bicarbonate), or acidic solutions (e.g. trifluoroaceric acid) or salt solutions (e.g. sodium chloride) and solutions of water supplemented with an organic such as 10% acetonitrile are suitable for eluting proteins/fragments from the matrix. Notably, independent of any other processing for other molecular classes, captured proteins can be eluted from the depth filter using high concentrations of formic acid (60% or 80% or more, keeping the solution cold to avoid formylation), or 8 M urea or 6 M GuHCl or base such as 1.8% ammonium hydroxide. It should be noted that sonication assists for any of these reagents, and that carbamylation by urea can be limited by using amine containing buffers.

The method may further comprise eluting the molecules and fragments of molecules which were captured and processed from the secondary matrix using a suitable elution solution, e.g. 70% acetonitrile, 0.5% formic acid in H₂O for embodiments which use reverse phase capture.

Preferably the application uses at least in part a coagulation medium substantially comprising methanol or another alcohol or organic solvent. This medium is useful not only for capture in the trapping matrix but also for washing. A particularly preferred medium is a buffer at an approximately neutral pH (e.g. from 6.5 to 7.5) comprising methanol or another alcohol (typically 60% or higher v/v methanol) and ammonium acetate or other buffer with a pKa around neutral at, e.g. specifically 80% methanol containing 30 mM ammonium acetate. This formula and composition may be reached only after combination of the extraction solvent with the coagulation medium. Other suitable media for the present application will be apparent to the skilled person.

The presented method is suitable for processing samples which comprise many conventional surfactants. SDS is commonly used as a surfactant for solubilizing and extracting membrane bound proteins from cells, but other surfactants are also used, including sodium cholate, sodium deoxycholate, n-dodecyl-beta-D-maltoside, Triton X-114, NP-40 (Thermo Scientific), and Brij 35 (Thermo Scientific). However, surfactants hamper down-stream analysis.

Where the device is a pipette tip or a spin column, it preferably comprises a layer of primary matrix and a layer of secondary matrix, the layers being arranged such that the primary matrix is upstream of the secondary matrix relative to the net direction of flow through the device. Typically the primary and secondary matrices are provided in the tapered portion of the device, with the secondary matrix being located nearer to the narrow tip end (nozzle), and the primary matrix being located nearer to the wide end.

The primary and/or secondary matrix may each comprise one or more flat layers (e.g. disks for a vessel which is circular in cross section) of the relevant material (e.g. depth filter or hydrophobic silica). Two or more layers of the relevant material can be stacked to provide the desired total depth, and hence volume and capacity, of matrix. Alternatively, a thicker and thus larger capacity material can be used.

The matrices can be retained in the device in any suitable manner, e.g. mechanically (e.g. by friction with the wall of the device, or using a clip, frame or other support means) or by an adhesive or the like (provided such an adhesive or the like is compatible with the method).

The device is suitably adapted to be mounted in a centrifuge to facilitate driving of the various media, reagents, buffers and the like through the matrix.

Alternatively the device is adapted to connect to one or more pumps to drive of the various media, reagents, buffers and the like through the matrix.

The device can suitably be a microfluidic device.

The device can be provided in association with a holder, e.g. a support which allows the device to be mounted in a centrifuge or other piece of laboratory equipment.

The present application provides a system comprising a device and associated sample handling apparatus.

In certain embodiments, the trap may be combined with a computer control system, or with microfluidics and/or other provisions described below which allow for automated sample processing. In an exemplary embodiment, the computer system includes a memory, a processor, and, optionally, a secondary storage device. In some embodiments, the computer system includes a plurality of processors and is configured as a plurality of, e.g., bladed servers, or other known server configurations. In particular embodiments, the computer system also includes an input device, a display device, and an output device. In some embodiments, the memory includes RAM or similar types of memory. In particular embodiments, the memory stores one or more applications for execution by the processor. In some embodiments, the secondary storage device includes a hard disk drive, floppy disk drive, CD-ROM or DVD drive, or other types of non-volatile data storage. In particular embodiments, the processor executes the application(s) that are stored in the memory or the secondary storage, or received from the internet or other network. In some embodiments, processing by the processor may be implemented in software, such as software modules, for execution by computers or other machines. These applications preferably include instructions executable to perform the functions and methods described above and illustrated in the Figures herein. The applications preferably provide GUIs through which users may view and interact with the application(s). In other embodiments, the system comprises remote access to control and/or view the system.

The system may be adapted to perform several steps of the method of the present application, e.g. at least the steps of molecule capture, transfer of molecules to the matrix, fractionation and washing as needed, subsequent treatment with enzymes and subsequent fractionation.

Furthermore the system may additionally be adapted to perform one or more of cell lysis, extraction of biomolecules and elution of biomolecule fragments from the matrix.

The present application provides a kit comprising a device and one or more containers comprising at least one of: a buffer medium for use in the device; reagents for cell lysis and solubilization of membrane bound proteins; enzymes including (by example) proteases, nucleases, gylcosidases, lipidases, et.; washing/rinsing agents as needed; and multiple elution reagents, which are chosen per biomolecular class property as described herein. Various suitable media, reagents and the like are discussed herein.

### Spin Column Assembly

There remains a need for a simple, efficient and reproducible sample preparation tool, compatible with small sample amounts, which produces from the same biological sample separate fractions of different classes of molecules from a sample, typically (but not necessarily) a biological sample such as a biopsy or blood sample or other piece of biology. The present application provides an elegant and simple-to-use two-part nesting system of an inner and outer vial to satisfy these experimental needs. The inner vial has a space to retain and support one or more matrices and other components well known to one familiar in the art such as frits and membranes. The inner and outer vials interface in two positions, the “lower” and “upper” parked positions. In the lower parked position, the outer column seals the inner vial, preventing flow out of the inner vial and allowing reactions to happen in whatever incubation conditions are required within and atop the matrix and within volume of the inner vial. The inner vial can then be raised to the upper parked position in which solution can flow from the interior of the inner vial through the matrix to the interior of the outer vial. The outer vial then becomes a receptacle for the flow though of whatever incubation step, and there are no issues with losses to plugs because the outer vial replaces plugs.

The two-piece system does not require any plugging to effect incubations or reactions, minimizing handling and maximizing sample processing speed as well as sample recovery. The system has upper and lower parked positions, effected by engaging or disengaging locking mechanisms between the inner and outer vials, which blocks flow out of the matrix or allows it. In a preferred embodiment, the locking mechanism is comprised of upside down U-shaped stops on the exterior of the inner vial and support pillars on the inside of the outer vial which can engage the middle of the U to support it in the upper parked position or be disengaged from the support pillars to allow the inner vial to seat into the very bottom of the outer vial. In the upper parked position, the contents of the inner vial and matrix can be transported to the outer vial through the porous matrix, for example by positive pressure or centrifugation, or by appropriate application of negative pressure. In the lower parked position, the inner vial is sealed by the outer vial, allowing for treatments that require incubation such as coagulation steps. The inner vial is tightly interfaced against and sealed to the outer vial, allowing the inner vial and its matrix and contents to receive heat, light, electromagnetic radiation like microwaves, sonic energy like ultrasonication, pressure or any other of a variety of treatments applied to the outside of the outer vial. Using such external treatments, especially sonication and heat and pressure, can dramatically reduce reaction times of chemical and enzymatic reactions, or the time it takes to solubilize materials.

This application conveniently provides a method of affording such treatments to samples by submersion into solutions (including and not limited to e.g. ultrasonication and incubation) while preventing contamination; devices with plugs cannot be relied upon to keep seals during such treatments. In the lower parked position, dead volume is minimized with a pin that fills most of the void space in the output beneath the matrix. This allows for minimal reaction volumes and maximal elution concentration of reactions such as and not limited to enzymatic reactions, on, in, within or atop the matrix, or elutions from chromatographic media like C18 or SCX among many others. Once the outer vial has received either flow though of the matrix or sample after subsequent processing steps, the outer vial can be closed and sealed with its integrated cap to become a storage container for the eluted or processed material; multiple outer vials may be used for multiple processing steps resulting in multiple fractions, and the outer vial obviates sample transfers and plugging of the matrix. Adsorptive losses, which become exasperated during frequent sample transfers, are thus minimized. The outer vial has a sloped lower surface facing the flat surface of a D-shaped pin to form a region first into which sample flows due to gravity and/or centrifugal force and second a region afforded enough space such that the sample can be removed or withdrawn or sampled by standard means such as pipette tips or aspiration needles, among many other techniques of sample transport and handling. The design of the inner and outer vials can remain the same yet be easily changed with many different matrices, allowing application of this system to many treatment workflows. Finally, the lure lock output of the inner vial is standard and allows easy attachment of the inner vial to many other consumables and devices, such as Sep-Pak C18 disposable SPE units, or vacuum manifolds, affording the system flexibility to be adapted to the largest number of workflows.

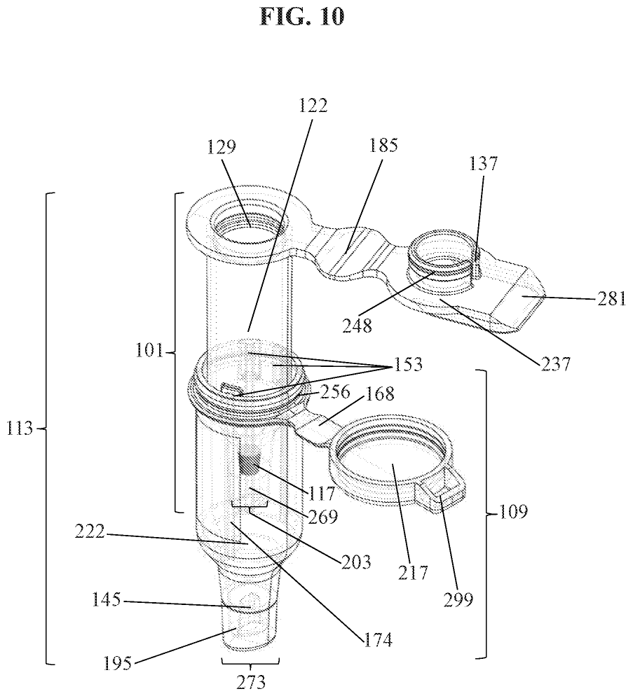

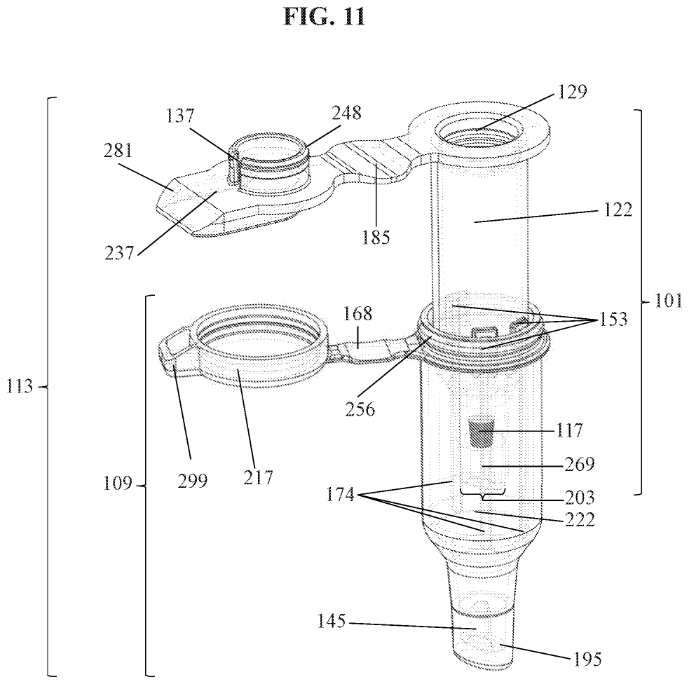

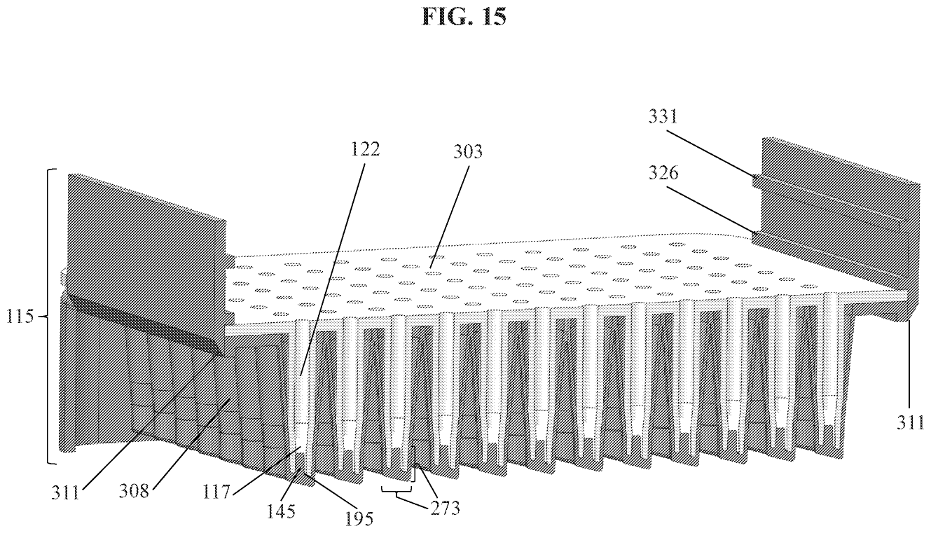

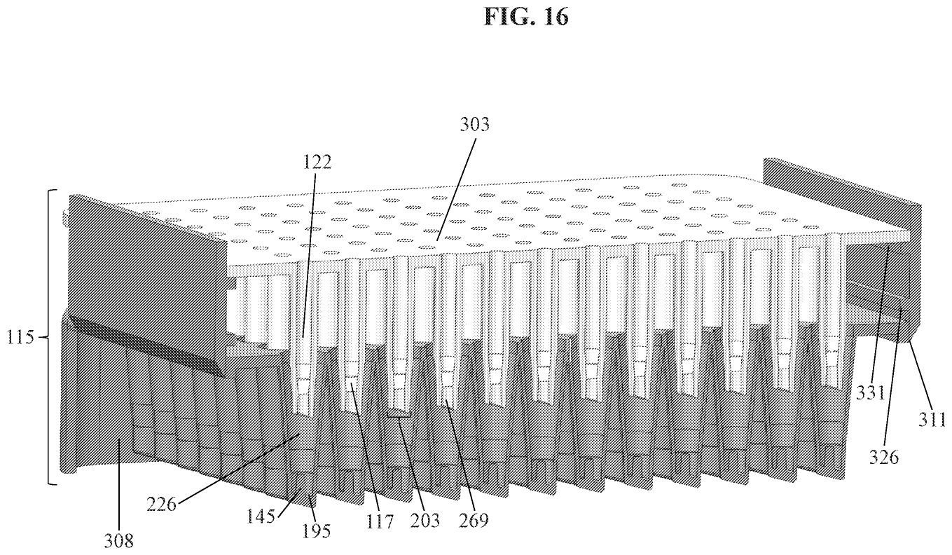

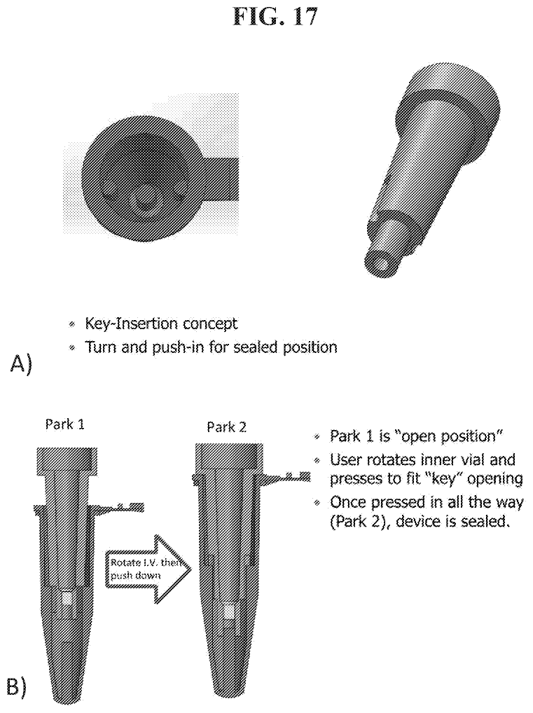

A representative embodiment of spin-column assembly 113 is detailed in FIGS. 10-14, and a representative embodiment in a 96-well plate format 115 in FIGS. 15 and 16. It will be apparent to one skilled in the art that these are merely representative embodiments, and that they are not limiting.

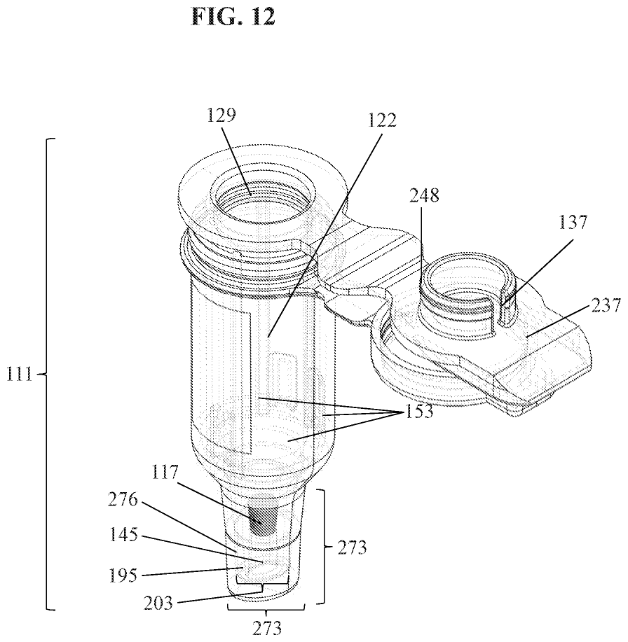

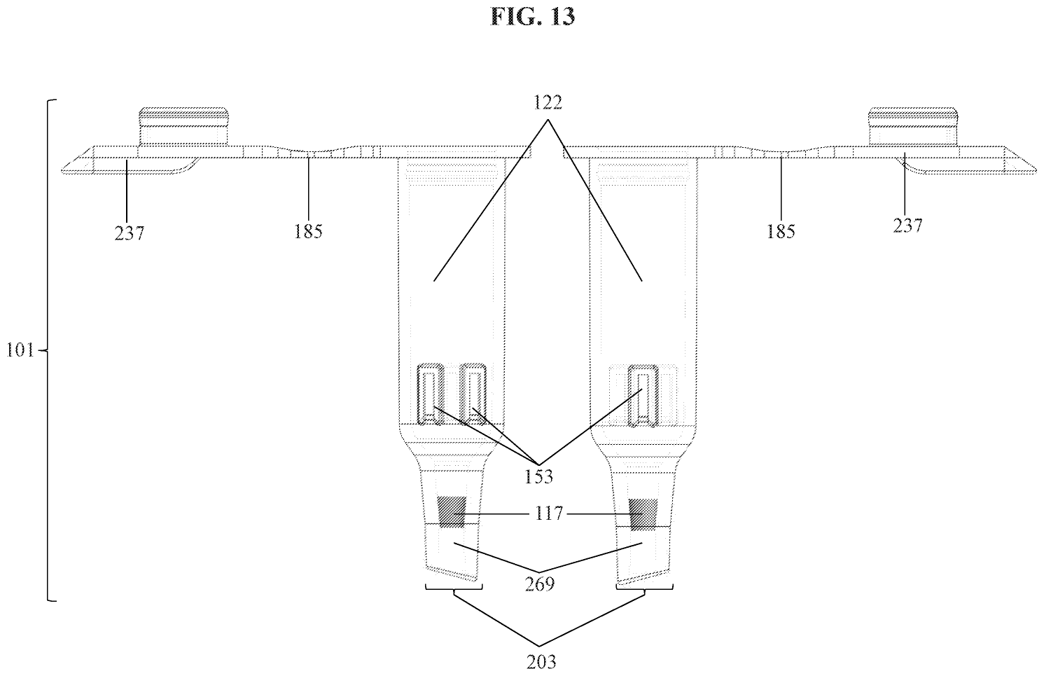

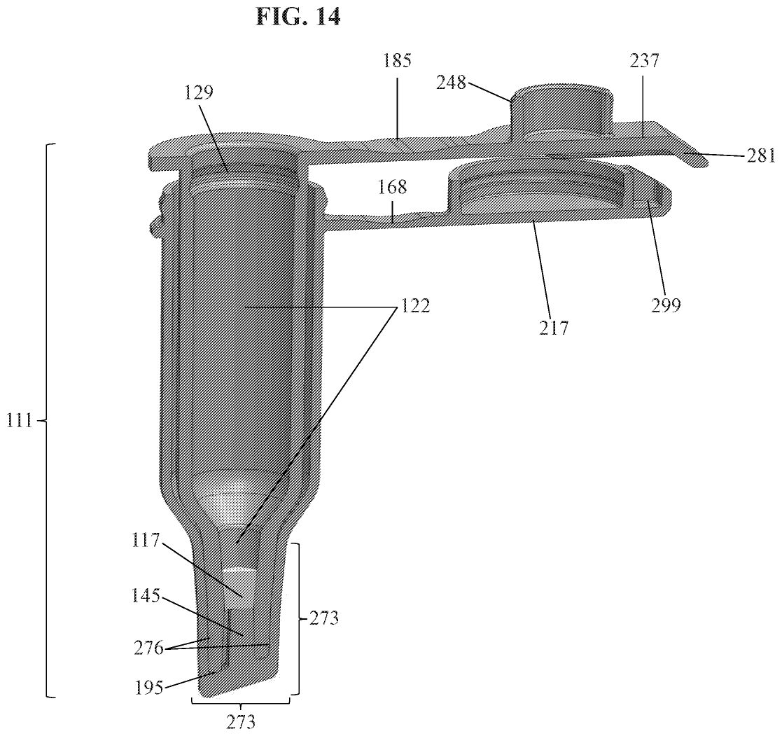

The inner vial 101 consists of an opening 129 into which samples of liquids and/or solids can be deposited, a space 122 to hold samples, a hinge 185 connected to the lid 237, said lid having a tab 281 to open and close it, as well as a ribbed sealing mechanism 248 to seal the inner vial during incubations, and said sealing mechanism is afforded a vent 127 which allows air pressure to equalize between the inside and outside of the inner vial. Sample holding space 122 is connected and exposed to a porous matrix 117 which sits at the bottom of the inner vial in a conical section, conical to afford better sealing during manufacturing and operation via centrifugation or positive or negative pressure, though conical simply a representative shape and is not limiting, and said matrix 117 opens on the bottom to the inner vial bottom opening 269 which in the specific embodiment as presented has the outer dimensions of a lure lock 203, but which can have other dimensions. The inner vial has, in the presented embodiment, three stops 153 in the shape of upside down U-s (see FIG. 13) which, if rotated to the correct angle offset between the caps of the inner and outer, can interface with supports on the interior of the outer vial 174 to support the inner vial 101 in an upper parked position, as is shown in FIGS. 10 and 11. In this upper parked position, the sample can pass from space 122 through matrix 117 through the bottom opening 269 of the inner vial and into the sample holding space of the outer vial 222. However if the inner vial is positioned such that the inner vial lid 237 and outer vial lids 217 are directly above each other as shown in FIGS. 12 and 14, the inner vial passes to the bottom of the outer vial where it is sealed by a tight interface 276 with the outer vial and D-pin 145 of the outer vial; this is the lower parked position (see FIGS. 12 and 14). In this way the combination of the inner and outer vials obviate the need for plugs in processing through a matrix, especially when incubations are required. The output channel 269 of the inner vial 101 is so fashioned to exactly fit the space at the bottom of the outer vial 109 and especially the slope of the outer vial which affords a sample collection space 195.

The outer vial 109 consists of a vial with an opening configured to receive the inner vial 101 in either an upper parked position (FIGS. 10 and 11) with support bars 174 engaged in the stops 153 of the inner vial, or alternatively in a lower parked position (FIGS. 12 and 14) in which the outer vial seals the inner vial through the tight interface 276 and D-pin 145. In the most preferred embodiment, D-pin 145 nearly touches the matrix 117 and thus occupies much or all of the dead space of inner vial output channel or opening 269. The outer vial has a lid 217 attached via a hinge 168, said lid having a tab 299 to open and close it as well as a rib sealing mechanism 256 that interfaces with the lid 217. When the lids of the inner vials are aligned, the support bars 174 do not engage the inner vial and the inner vial passes to the lower parked position shown in FIGS. 12 and 14. The tight interface 276 is intentionally tight to most efficiently communicate treatments such as and not limited to heat, light, ultrasonic energy or electromagnetic energy applied to the exterior of the outer vial at the bottom region of the assembly 273 to the interior of the inner vial including to the matrix 117 and any material bound on, in or on top of it, as well as any solution held within the inner vial sample holding space 122. The bottom of the outer vial is sloped to create a sample collection region 195 which is directly opposed to the flat side of the D-pin; the D-pin shape affords sufficient room for pipette tips of normal size to pass to the bottom of the sample collection region 195. The low nature of this sample collection region 195 allows solution held in the sample holding region 222 of the outer vial to flow down via gravity or centrifugation and be recovered by standard means such as pipetting nearly quantitatively. The D-pin 145 and form-fitted, tight interface 176 between the inner and outer vials removes the need for a plug in processing through a matrix.

Sample processing begins in the inner vial 101. Samples that do not require an initial incubation, or which have already been incubated with the necessary reagents in a separate vesicle, can be immediately applied to the inner vial's interior sample holding space of 112 through the upper opening 129 when the inner vial 101 and outer vial 109 are in the upper parked position held by use of the locking/stop/support mechanism afforded to the inner vial 153 and the outer vial 174 (see FIGS. 10 and 11). Samples may contain solids or coagulated or precipitated or flocculent materials, or beads or other insoluble components, all of which may or may not be loaded along with any liquid, as required by the experiment. In the case of no initial incubation, the inner and outer vial assembly 113 is then typically closed with the lid 237 which interfaces with the opening of the inner vial 129 with a rib sealing mechanism 248.

Alternatively and depending on the case, the inner vial might be placed in the lower parked position (FIGS. 12 and 14) and the interior space 122 can be preloaded with a reagent, such as a coagulation reagent or a precipitation or a solubilization reagent. Sample can then be directly introduced into the liquid reagent to be incubated with the needed conditions for the needed length of time in the inner vial.

During incubations, the inner vial 101 can be sealed for incubation with its lid 237 which bends at its hinge 185 which is manipulated to be open or closed by hand or automation with handling tab 281. Incubations that require heat cause the gas also contained in the interior space 122 to expand; thus the inner vial lid 237 is afforded a vent 137 to allow the internal pressure to equalize with the atmosphere external to the inner vial 101. This same vent 137 provides that a vacuum does not build up during passage of the sample from the inner space 122 of the inner vial to inner space of the outer vial 222; this step occurs when the two pieces are engaged in the upper parked position.

In the lower parked position (FIGS. 12 and 14), the bottom portion 273 of inner vial 101 and outer vial 109 nest extremely tightly because the inner dimensions of the outer vial is sized to exactly fit the outer dimensions of the inner at an interface 276. This tight interface facilitates flow from the exterior of the outer vial to the interior of the inner vial, its contents and matrix treatments such as heat or light or electromagnetic radiation or sonic energy like ultrasonication; such treatments are afforded to the inner vial 101 and its contents by treatment of the lower portion 273 of the engaged nested assembly 113 in the lower parked position, for example by placing at least portion 273 in an ultrasonication bath, or by placing it in an incubator, or by exposing it to light or microwaves, or other treatments. Exposure to such treatments can speed and facilitate chemical and enzymatic reactions, as well as solubilize or physically disrupt materials held within the assembly.

In the lower parked position, outer vial pin 145 mostly occupies the dead space interior of the output of the inner vial 203. This is important to minimize reaction or elution volumes, to maintain maximal concentration of analytes and to minimize waste of reagents that might be expensive, such as mass spec grade enzymes like proteases.

The tight fit seals the inner vial 101 against the outer vial 109 in region 273 when in the lower parked position seals the inner vial and prevents flow from its interior 122 or matrix 117, obviating need for a plug. The tightness of interface 276 is important as well because its volume is negligible, typically <10 μL and usually <2 μL, depending on the consistency of manufacturing, that any leak from the internal space 122 of the inner vial 101 is limited to that small space as the solution level in interface 276 equalizes with the solution level on the interior space of the inner column 122; leaks of this volume, should they occur, are negligible and acceptable. Indeed it is advantageous to fill any space remaining at interface 276 with solution via centrifugation to facilitate flow of external treatments like heat or ultrasonication from the exterior of the outer vial to the interior of the inner vial including its matrix and contents. One skilled in the art will recognize that this application can be scaled to much larger or much smaller than the presented examples, and that such examples as are presented here are not limiting, and that the exemplary dead volumes listed herein will change as a function of the scale at which the particular embodiment is made. As presented, the application is scaled to fit in a standard benchtop centrifuge. Specifically contemplated forms include standard sizes used in laboratory and analytical settings such as tubes from 0.2 mL to 2 mL and including 0.5 and 1.7 mL sizes, as well as conical tubes such as a 15 and 50 mL conical tube (Falcon tube).

Regardless if the sample did or did not require an initial incubation, after the incubation complete with whatever potential treatment such as time or heat or ultrasonication applied in the lower parked position as shown in FIGS. 12 and 14, the inner vial 101 can be returned to the upper parked position within the outer vial 109 as shown in FIGS. 10 and 11. The sample within the sample holding space 122 of the inner vial can then be passed through the matrix 117 by centrifugation, gravity flow, or positive or negative pressure. The application of positive pressure necessitates that the lid 237 remain open. A typical force at which the assembly might be centrifuged is 4,000 g; it can be higher or lower depending on the use case and the strength of matrix 117.

If the matrix is afforded an affinity or chromatography or filtration function, the first fraction will be a flow through fraction of the moieties which passed through matrix 117; this fraction will pass into the sample holding space of the outer vial 222. Washes, should they be necessary, can subsequently be performed by moving the inner vial 101 to fresh outer vials 109, which can capture the washes if desired. Alternatively washes can be directly into the flow though, as directed by the needs of the experiment.

Either with or without washes, material bound or retained in, on or by the matrix 117 is ready for further processing. The inner column 101 is lifted to disengage the locking/support mechanisms 153 and the inner vial, perhaps in a fresh outer vial, is placed in the lower parked position to seal the inner vial against the outer vial. Treatment reagents are then added to the interior of the inner vial via opening 129 into sample holding and processing space 122. Most typically, the assembled inner and outer vial will be subject to centrifugation to displace all air from the matrix 117 and fill any dead space with treatment reagents. Treatment reagents most commonly include: elution solutions, such as aqueous buffers to elute nucleic acids or hydrophobic solvents to dissolve lipids or other hydrophobic compounds, in both cases and others heat and or sonication may be applied to help dissolve and elute the fractions of interest; enzymes, such as proteases like trypsin, pepsin, chymotrypsin, Lys-C, Lys-N, Asp-N, Glu-C, Arg-C and Tryp-N, nucleases of which hundreds to thousands of enzymes exist, glycosidases like PNGase F, and other enzymes or proteins like HRP conjugated enzymes or antibodies or proteins; chemical treatments such as derivatizations with reactive chemistries like isothiocyanates like FITC or NHS esters or isobaric labels or cysteine labels, among many other reactions, or reductions and alkylations; or other treatments. These treatments are then afforded their requisite time, temperature, energy addition be it from heat or sonication etc. to complete the treatment. After the treatment is complete, the inner vial 101 is again moved to the upper parked position as show in FIGS. 10 and 11 and again the portion of the sample released from the matrix is propelled through the matrix 117 by pressure or centrifugation.

Such treatments can be sequential, each likely occurring in a fresh outer vial, and each releasing a new fraction of the sample retained or bound on, in or by the matrix. For example, in the case a coagulant such as an organic solvent is first added to the inner vial in the lower parked position, and then a sample, for example serum containing ammonium acetate, is added to the coagulant, and the sample is passed through a matrix 117 adapted to capture the biopolymers of the sample after the inner vial is raised to the upper parked position, the first resulting fraction will be of small molecules. If then the inner vial is then returned to the lower parked position in a new outer vial, and an aqueous solution is applied, especially with the aid of heat and/or sonication, nucleic acids can be dissolved and eluted once the inner vial is again in the upper parked position. Returning the inner vial to a new outer vial in the lower parked position, the retained and bound biopolymers can be treated with PNGse F to release glycans. The inner vial is again placed in the upper parked position and the glycans are eluted. Putting the inner vial in a new outer vial, the proteins can be exposed to reduction with, e.g., TCEP, and alkylation with, e.g., MMTS. After reduction and alkylation the proteins can be washed free of the reagents, likely into a waste tube, and as a final step a protease such as trypsin can be applied to process proteins bound or retained on or in or by the matrix to peptides. This reaction can be accelerated with heat and sonication applied to the lower region of the assembled inner and outer vials 273 afforded by the tight interface between the inner and outer vials 276.

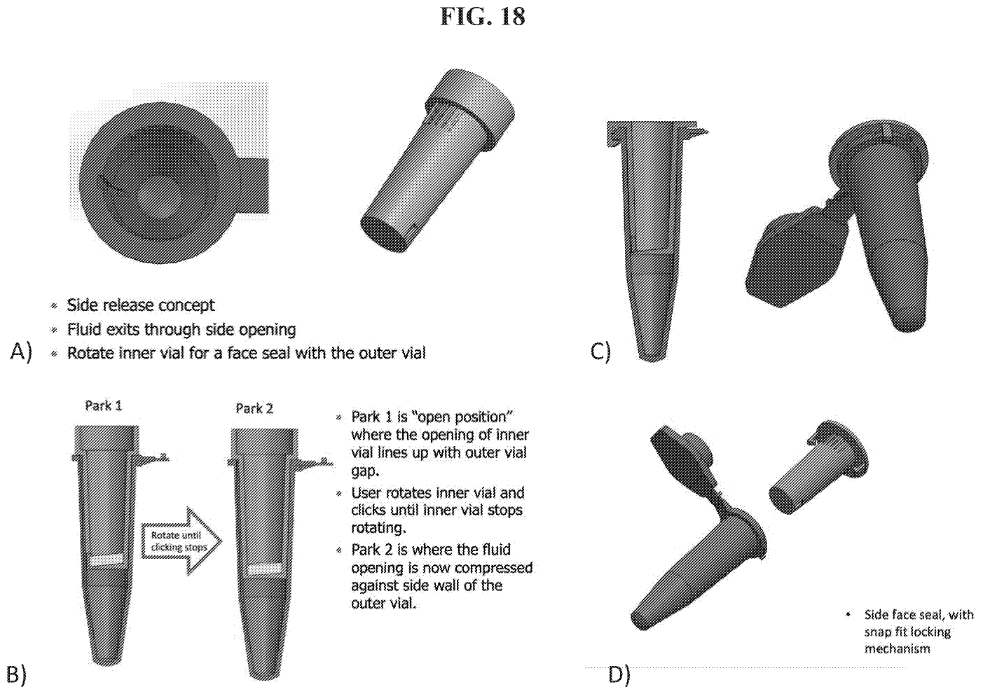

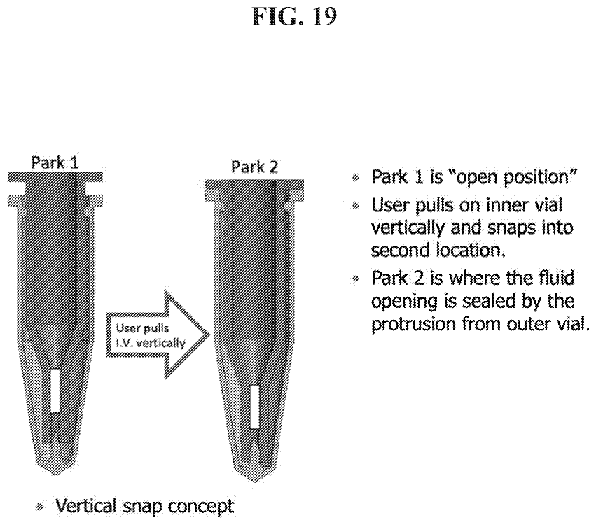

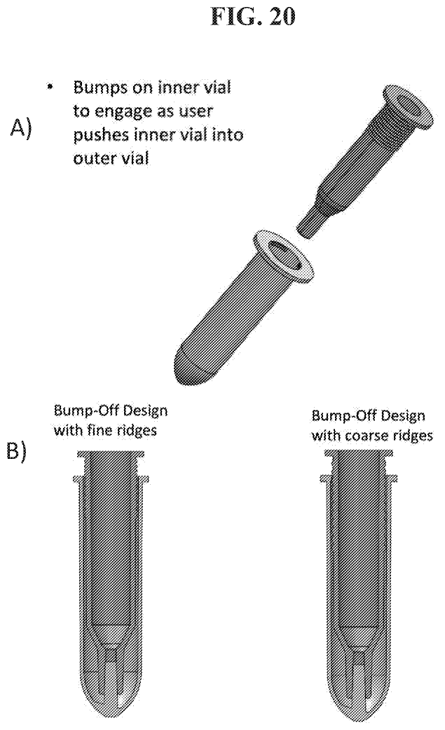

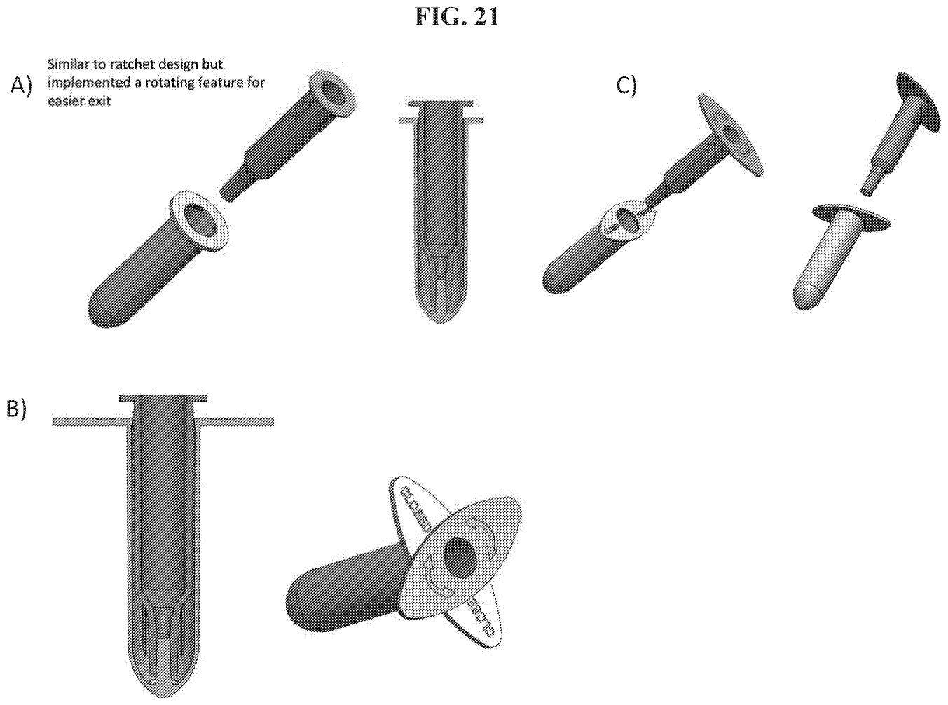

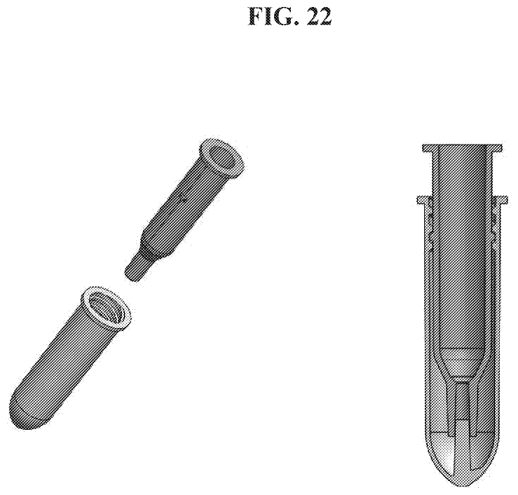

The embodiment shown in FIGS. 10-14 requires rotation to mesh the upside down U-shaped stops 153 with the corresponding support mechanism 174 of the outer vial. One skilled in the art will appreciate that many such locking mechanisms are possible including support posts which hold the inner vial or, when placed in recesses, allow the inner vial to seal against the outer vial (see FIG. 18), push-on bumps or snaps or ridges to support the inner vial at various vertical heights within the outer vial (FIGS. 21-22), which may have a break radially within the outer vial and on the outside of the outer vial to allow the bumps or snaps or ridges to be disengaged by rotation (FIG. 21) or threads (FIG. 22). Alternatively, embodiments exist in which a locking mechanism that allow or prohibit flow thorough the matrix via a side release design in which the outer vial either seals or does not seal against the inner vial depending on the position of rotation and in which a snap fit locking mechanism can afford sealing is contemplated (FIG. 19).

It is noted that the lure lock 203 allows the reversible attachment of cartridges such as SPE cartridges like C18 Sep-Paks directly to the inner vial. Such cartridges may have any of the affinities listed for the matrix 117, and make the assembly particularly flexible and able to use currently existent sample preparation and chromatography products.

The above described steps and method and assembly are easily parallelized by making arrays of individual columns, as is illustrated by the example 96-well plate embodiment of FIGS. 15 and 16. Such embodiments maintain exactly the same tight sealing and interfacing mechanism 276, D-pin 145, matrix 117, sample collection region 195, and sample holding spaces of the inner (122) and outer (222) vials. The difference lies in the mechanism used to support the upper and lower parked positions. In FIGS. 15 and 16, two supports 326 and 331 exist on side tabs supported by hinges 311 which allows the side tabs to be engaged or disengaged in the upper and lower parked positions by swinging them out. In FIG. 15, the lower parked position in which the inner plate 303 is sealed against the outer plate 308 is maintained by support tab 326 on both sides which holds the inner plate 303 down against the outer plate 308. In FIG. 16, support tab 331 on both sides holds the inner place 303 up such that contents of the inner plate in sample holding space 122 can flow though the matrices 117 through the bottom openings of the inner plate 269 into the sample holding space of the outer plate 226. There is no difference in use or treatment steps between individual spin columns and plates with the sole exception that plates or other arrays must be supported in slightly different fashions. One skilled in the art can contemplate many mechanisms to support the inner plate within the sample-receiving space 226 of the outer plate including, by example, clips or support rings or collars or tabs, which might be integrated into either the inner or outer plates, or both, or which might be a third piece, or pillars or supports which swing up or collapse to afford the upper and lower parked positions.

The present application is further illustrated by the following examples that should not be construed as limiting. The contents of all references, patents, and published patent applications cited throughout this application, as well as the Figures and Tables, are incorporated herein by reference.

### EXAMPLES

This work outlines and demonstrates the concept of the Simultaneous Trapping technology, SiTrap, for detergent-free proteomics and metabolomics sample preparation, which is extensible to many other classes of molecules such as DNA, RNA and glycans including glycans covalently attached to proteins. SiTrap methodology provides the opportunity for simple and robust multiomics profiling performed on the same sample which has significant impact for comparative biological inference in omics data, high-throughput omics analysis, and is of key importance when working with limited sample amounts in translational medical research.

### Methods

SiTrap Tips

SiTrap tips were constructed using either cellulose or quartz depth filter materials. 1.6-mm-diameter plugs were inserted into a pipette tip (D200, Gilson). SiTrap cellulose tips were used for cellular and tissue analyses. For the sample processing steps involving centrifugation (load, wash and elution), the tips were placed in 2.0 or 1.5-ml sample tubes with the aid of tube adapters.

### Sample Processing

Cell Pellets

MDA-MB-231 cell pellets (1,000,000 cells per pellet) were lysed by probe sonication on ice in 250 μl of lysis solutions (30 mM ammonium acetate, 1.8% ammonium hydroxide (prepared by dilution of the stock 28% ammonium hydroxide solution (Sigma)), 3% SDS in 30 mM ammonium acetate, 3% P407 in 30 mM ammonium acetate) for SiTrap, and in 3% SDS in 50 mM Tris-HCl, pH 7.6 for SDS based approaches. The extracts were clarified by centrifugation at 11,000 g for 2 min at 18° C. Protein concentration was measured by Pierce BCA Protein Assay Kit (Thermo). 30 μg of protein was processed in six replicates in each case. For ammonium acetate (AA) extraction SiTrap processing, four volumes of methanol containing 30 mM AA were added to the lysate whereby anhydrous methanol was supplemented to 30 mM AA from an aqueous 1 M ammonium acetate stock solution. For ammonium hydroxide (AH) extraction SiTrap, an equal volume of 1 M acetic acid was added to the lysate followed by the addition of two volumes of methanol. The samples were loaded into SiTrap cellulose tips. The tips were inserted into 2.0-ml sample tubes and were centrifuged at 2000 g to capture the proteins. Captured proteins were washed by adding 80 μl of 50% methanol in 30 mM AA to the tips followed by centrifugation at 2500 g for 30 sec. The tips were removed and placed into 1.5-ml sample tubes. The captured proteins were further denatured, reduced and alkylated in situ by adding 60 mM triethylammonium bicarbonate (TEAB), 10 mM tris(2-carboxyethyl)phosphine (TCEP), 25 mM chloroacetamide (CAA) solution to the tips followed by heating at 80° C. for 30 min (the reduction/alkylation solution should be prepared prior to the start of experiment and thoroughly vortexed right before use). After a wash with 80 μl of 20 mM TEAB at 2500 g for 30 sec, the tips were removed and placed into new 1.5-ml sample tubes. 20 μl of Sequencing Grade trypsin (Promega) in 100 mM ammonium bicarbonate at a concentration of 0.07 μg/μl was added to the tips. The trypsin solution was pushed down using a syringe with a customized tip adapter described previously till the solution meniscus was positioned ˜3 mm above the top of the cellulose plug. Tryptic digestion was done by incubation at 47° C. for 1 hour. Post-digest elution was performed consecutively with 70 μl 300 mM ammonium bicarbonate and 70 μl of 3% formic acid. The peptides were concentrated using C8 Stage tips for the downstream analysis by mass spectrometry. For SDS processing 30 μg of protein was processed with trypsin after SDS removal. The digestion, peptide elution and concentration were the same as for SiTrap.

One skilled in the art will recognize that a tip format is only one embodiment of many different physical forms such as plates or spin columns or cartridges in many different formats. Specifically, and not exclusively, the application might be embodied in a 96-well or 384-well plate or many other formats including cartridges and units integrated with chromatographic media or chromatographic separation systems, among many others, and that such an embodiment might also be coupled to sample collection and/or storage.

Renal Tissues

Frozen renal tissue from three matched clear cell renal carcinoma (G2 pT3a, G2 pT1b, G1 pT2)/adjacent normal sample pairs were obtained from The Leeds Multidisciplinary Research Tissue Bank. Approximately 1 cm² sections with a thickness of 10 μm were cut for each sample and placed into 1.5 ml sample tube. 80 μl of 1.8% ammonium hydroxide was added to the tube and the tissue was lysed by probe sonication. The tube was centrifuged at 11,000 g for 2 min at 18° C. to remove the debris. The supernatant was removed for further processing. The SiTrap load was normalized by protein concentration. 50 μg of protein was loaded into the SiTrap cellulose tips as described above for ammonium hydroxide lysates. The collected flow-through fraction, devoid of proteins, was dried down using a Speed-Vac for targeted metabolomics analysis. The captured protein fraction, in turn, was digested as described above, the resulting peptides were concentrated for proteomics analysis.

SiTrap Serum Processing Method

SiTrap quartz tips were constructed as described in this document. Serum from a healthy volunteer was obtained from The Leeds Multidisciplinary Research Tissue Bank. 0.5 μl of the serum was processed either directly by protein solubilization with 25 μl of 5% SDS in 50 mM Tris-HCl, pH 7.6 and tryptic digestion in OQ STrap tips (6 replicate samples in total), or by SiTrap, diluted with 30 μl of 20 mM TEAB buffer and processed by fractionation on SiTrap quartz tips resulting in two fractions, ‘captured’ and ‘flow-through’ (3 replicates each for each fraction, 6 samples in total). The diluted in TEAB serum was loaded into SiTrap quartz tip and gently pushed through with the aid of a syringe with a tip adapter, the ‘flow-through’ fraction was collected. The tip with the ‘captured’ fraction was inserted into 2.0-ml sample tube and washed consecutively with 100 μl and 40 μl of 20 mM TEAB using centrifugation at 2500×g. Reduction/alkylation and digestion of the trapped proteins were performed in the same way as described for cellular lysates in the Methods. The ‘flow-through’ fraction was diluted with six volumes of 30 mM ammonium acetate in methanol and consequently trapped and digested in another SiTrap tip in the same way as the ‘captured’ fraction. The resulting peptides were analyzed by LC-MS/MS using 100 min acquisition time as described in the Methods. The obtained data were processed as described below.

Proteomics

Peptides were separated online by reversed-phase capillary liquid chromatography using an EASY-nLC 1000 system (Proxeon) connected to a custom-made 30-cm capillary emitter column (inner diameter 75 μm, packed with 3 μm Reprosil-Pur 120 C18 media, Dr. Maisch). The chromatography system was hyphenated with a linear quadrupole ion trap-orbitrap (LTQ-Orbitrap) Velos mass spectrometer (Thermo). The total acquisition time was 100 min for cellular and 140 min for tissue analyses; the major part of the chromatographic gradient was 3%-22% acetonitrile in 0.1% formic acid. Survey MS scans (scan range of 305-1350 amu) were acquired in the orbitrap with the resolution set to 60,000. Up to 20 most intense ions per scan were fragmented and analyzed in the linear trap. Data were processed against a Uniprot human protein sequence database (October, 2018) with MaxQuant 1.5.2.8 software package (www.maxquant.org) (Cox, J., Mann, M., MaxQuant enables high peptide identification rates, individualized p.p.b.-range mass accuracies and proteome-wide protein quantification. Nature biotechnology 2008, 26, 1367-1372). Carbamidomethylation of cysteine was set as a fixed modification, with protein N-terminal acetylation and oxidation of methionine as variable modifications. Up to three missed cleavages and at least one unique peptide for valid protein identification were chosen. The maximum protein and peptide false discovery rates were set to 0.01. Analysis of Gene Ontology (GO) features was undertaken with Panther 14.0 (www.pantherdb.org) (Thomas, P. D., Campbell, M. J., Kejariwal, A., Mi, H., et al., PANTHER: a library of protein families and subfamilies indexed by function. Genome Res 2003, 13, 2129-2141.). Perseus software package 1.6.2.3 (https://maxquant.net/perseus/) (Tyanova, S., Temu, T., Sinitcyn, P., Carlson, A., et al., The Perseus computational platform for comprehensive analysis of (prote)omics data. Nat Methods 2016, 13, 731-740.) was used for volcano plot significance analysis—the mean LFQ intensities of proteins were log 2-transformed and their differences plotted against the corresponding p values from t-test, the significance cut-offs were set to 0.05 for FDR and 0.01 for S0. For data comparison only proteins identified with at least two peptides and one unique peptide were used.

Metabolomics

### Targeted Metabolomic LC-MS Analysis of Acylcarnitines, Free Fatty Acids and Bile Acids

A solution of 10 μM palmitoyl-L-carnitine-(N-methyl-d3) (Sigma), 10 μM palmitic acid-d31 (Sigma) and 10 μM deoxycholic acid-d6 (Sigma) in LC-MS grade methanol was prepared as internal standard spiking solution (ISSS). Samples were reconstituted in 100 μl LC-MS grade water and 100 μl ISSS, vortex mixed and sonicated for 30 min before being transferred to LC vials. Chromatography was performed using an ACQUITY UPLC system (Waters) equipped with a CORTECS T3 2.7 μm (2.1×30 mm) column, which was kept at 60° C. The ACQUITY UPLC system was coupled to a Xevo TQ-XS mass spectrometer (Waters Corporation). The binary solvent system used was solvent A comprising LC-MS grade water, 0.2 mM ammonium formate and 0.01% formic acid, and solvent B comprising analytical grade acetonitrile/isopropanol 1:1, 0.2 mM ammonium formate, and 0.01% formic acid. For all analyses a 10 μl injection was used and mobile phase was set at a flow rate of 1.3 ml/min. For acylcarnitine analysis, the column mobile phase was held at 2% solvent B for 0.1 min followed by an increase from 2% to 98% solvent B over 1.2 min. The mobile phase was then held at 98% solvent B for 0.9 min. The mobile phase was then returned to 2% solvent B held for 0.1 mins to re-equilibrate the column. For free fatty acid analysis, the column mobile phase was increased from 50% to 98% solvent B over 0.7 min. The mobile phase was then held at 98% solvent B for 0.5 min. The mobile phase was then returned to 50% solvent B held for 0.1 min to re-equilibrate the column. For bile acid analysis, the column mobile phase was held at 20% solvent B for 0.1 min followed by an increase from 20% to 55% solvent B over 0.7 min. The mobile phase was increased to 98% solvent B and held for 0.9 min. The mobile phase was then returned to 20% solvent B held for 0.1 mins to re-equilibrate the column. Analyses were performed using multiple reaction monitoring (MRM). Transitions and ionization conditions are given in tables 1, 2 and 3. For acylcarnitine analyses the Xevo TQ-XS was operated in positive electro-spray ionization (ESI) mode. For free fatty acid and bile acid analyses the Xevo TQ-XS was operated in negative ESI mode. A cone gas flow rate of 50 ml/hr and desolvation temperature of 650° C. was used.

Metabolomics Data Analysis

Data were processed and peak integration performed using the Waters Targetlynx application (Waters Corporation). Integrated acyl-carnitine, free fatty acid, and bile acid peak areas were normalized to the palmitoyl-L-carnitine-(N-methyl-d3), palmitic acid-d31 or deoxycholic acid-d6 internal standard respectively.

Multivariate data analysis was performed using Metaboanalyst version 4.0 (Chong, J., Soufan, O., Li, C., Caraus, I., et al., MetaboAnalyst 4.0: towards more transparent and integrative metabolomics analysis. Nucleic Acids Res 2018, 46, W486-W494.). Data sets were mean-centered and analyzed using principal components analysis (PCA) and partial least squares-discriminant analysis (PLS-DA). Metabolite changes responsible for clustering or regression trends within the pattern recognition models were identified by interrogating the corresponding loadings plot. Metabolites identified in the variable importance in projections/coefficients plots were deemed to have changed globally if they contributed to separation in the models with a confidence limit of 95%. These were verified using univariate volcano plots with a fold change cut off of 1.2 and P-value cut off of 0.05.

TABLE 1
Multiple Reaction Monitoring Parameters for acyl-carnitines
species. Acyl-carnitines are designated by acyl chain length in carbons
and degree of unsaturated double bonds. Internal standard (IS).

| Acyl- | Parent Ion | Fragment Ion | Cone Voltage | Collision |
|---|---|---|---|---|
| Carnitine | (m/z) | (m/z) | (v) | Energy (ev) |
| C18:2 | 424.3 | 85 | 50 | 28 |
| C18:1 | 426.4 | 85 | 50 | 28 |
| C18:0 | 428.4 | 85 | 50 | 28 |
| C16:1 | 398.3 | 85 | 50 | 26 |
| C16:0 | 400.3 | 85 | 50 | 26 |
| C14:2 | 368.3 | 85 | 46 | 26 |
| C14:1 | 370.3 | 85 | 46 | 26 |
| C14:0 | 372.3 | 85 | 46 | 26 |
| C12:1 | 343.3 | 85 | 46 | 24 |
| C12:0 | 344.3 | 85 | 46 | 24 |
| C10:1 | 314.2 | 85 | 42 | 24 |
| C10:0 | 316.2 | 85 | 42 | 24 |
| C8:1 | 286.2 | 85 | 42 | 22 |
| C8 | 288.2 | 85 | 42 | 22 |
| C6 | 260.2 | 85 | 54 | 20 |
| C5:1 | 244.2 | 85 | 38 | 22 |
| C5 | 246.1 | 85 | 38 | 22 |
| C4 | 232.1 | 85 | 34 | 20 |
| C3 | 218.1 | 85 | 32 | 18 |
| C2 | 204.1 | 85 | 32 | 18 |
| C16:0-d3 IS | 403.4 | 341.26 | 8 | 18 |

TABLE 2
Multiple Reaction Monitoring Parameters for free fatty acid species.
Free fatty acids are designated by acyl chain length in carbons and
degree of unsaturated double bonds. Internal standard (IS).

| Free Fatty | Parent Ion | Fragment Ion | Cone Voltage | Collision |
|---|---|---|---|---|
| Acid | (m/z) | (m/z) | (v) | Energy (ev) |
| C22:6 | 327.25 | 327.25 | 45 | 7 |
| C22:5 | 329.25 | 329.25 | 45 | 7 |
| C22:4 | 331.25 | 331.25 | 45 | 7 |
| C22:1 | 337.25 | 337.25 | 45 | 7 |
| C22:0 | 339.25 | 339.25 | 45 | 7 |
| C20:5 | 301.25 | 301.25 | 45 | 7 |
| C20:4 | 303.25 | 303.25 | 45 | 7 |
| C20:3 | 305.25 | 305.25 | 45 | 7 |
| C20:2 | 307.25 | 307.25 | 45 | 7 |
| C20:1 | 309.25 | 309.25 | 45 | 7 |
| C20:0 | 311.25 | 311.25 | 45 | 7 |
| C18:3 | 277.25 | 277.25 | 45 | 7 |
| C18:2 | 279.25 | 279.25 | 45 | 7 |
| C18:1 | 281.25 | 281.25 | 45 | 7 |
| C18:0 | 283.25 | 283.25 | 45 | 7 |
| C17:1 | 267.25 | 267.25 | 45 | 7 |
| C17:0 | 269.25 | 269.25 | 45 | 7 |
| C16:2 | 251.25 | 251.25 | 45 | 7 |
| C16:1 | 253.25 | 253.25 | 45 | 7 |
| C16:0 | 255.25 | 255.25 | 45 | 7 |
| C15:1 | 239.25 | 239.25 | 45 | 7 |
| C15:0 | 241.25 | 241.25 | 45 | 7 |
| C14:1 | 225.25 | 225.25 | 45 | 7 |
| C14:0 | 227.25 | 227.25 | 45 | 7 |
| C12:1 | 197.25 | 197.25 | 45 | 7 |
| C12:0 | 199.25 | 199.25 | 45 | 7 |
| C16:0-d31 IS | 286.62 | 286.62 | 45 | 7 |

TABLE 3
Multiple Reaction Monitoring Parameters for bile acid species.
Internal standard (IS).

| | Parent | | Cone | |
|---|---|---|---|---|
| | Ion | Fragment | Volt- | Collision |
| Bile Acid | (m/z) | Ion (m/z) | age (v) | Energy (ev) |
| Glycoursodeoxycholic acid | 448.25 | 74 | 60 | 35 |
| Tauroursodeoxycholic acid | 498.25 | 80 | 60 | 60 |
| Taurohyodeoxycholic acid | 498.25 | 80 | 60 | 60 |
| Taurocholic acid | 514.25 | 80 | 60 | 64 |
| Glycocholic acid | 464.25 | 74 | 60 | 34 |
| Taurochenodeoxycholic acid | 498.25 | 80 | 60 | 60 |
| Taruodeoxycholic acid | 498.25 | 80 | 60 | 60 |
| Ursodeoxycholic acid | 391.25 | 391.25 | 60 | 16 |
| Cholic acid | 407.25 | 343.25 | 60 | 34 |
| Glycochenodeoxycholic acid | 448.25 | 74 | 60 | 35 |
| Glycodeoxycholic acid | 448.25 | 74 | 60 | 35 |
| Taurolithocholic acid | 482.25 | 80 | 60 | 60 |
| Chenodeoxycholic acid | 391.25 | 391.25 | 60 | 16 |
| Glycolithocholic acid | 432.25 | 74 | 60 | 35 |
| Deoxycholic acid | 391.25 | 391.25 | 60 | 16 |
| Lithocholic acid | 375.2 | 373.25 | 60 | 32 |
| Deoxycholic acid-d6 IS | 397.23 | 331.32 | 80 | 36 |

A tip format SiTrap is made according to the disclosure of this application and a portion of sample is added according to the disclosure such that 50 μg of protein are captured in the trapping matrix in a total volume of ammonium acetate and methanol totaling 150 μL; there will be more than 50 μg of total captured molecules because DNA, RNA and glycans among other molecules will be trapped. The flow through is kept which contains small molecules and lipids, which will be taken to lipidomics and metabolomics analysis. Some lipids and small molecules may be retained. DNA and RNA is first eluted by the addition of 3× of 50 μL TE buffer commonly used in molecular biology; this fraction may be analyzed by transcriptomics, RNAseq and genomics techniques. The sample is next treated with 2 μg of PNGase F in 50 μL of a phosphate buffer for at least one hour and up to overnight at 37 C. The glycans are spun out and recovered for glycomics analysis. The proteins are reduced and alkylated as disclosed below. 2 μg of trypsin is added in 40 μL of 50 mM TEAB at pH 8.5 and the proteins are digested 1 hr at 47 C; other incubation times and temperatures can be added. The capture matrix may be sonicated or ultrasonicated to speed digestion. Resulting peptides are taken into proteomics analyses. Alternatively, proteins can be eluted for top-down proteomics by sonication in, by example 40 μL 60% formic acid, 8 M urea or 6 M GuHCl; these reagents work best with sonication.

To solve the need for multi-omics analysis, where detergent or chaotrope or other solubilization agents prevent downstream analysis of molecules not bound on the trapping matrix, the system, device, process and method herein were devised to match the protein processing power and simplicity of detergent based methods but with the use of a detergent-free composition for lysis which allows for post-capture in situ reduction/alkylation of the trapped proteins, providing a contaminant-free flow-through fraction for complementary ‘omics’ analysis. The process can be automated to make a sample processing machine.

### Example 1

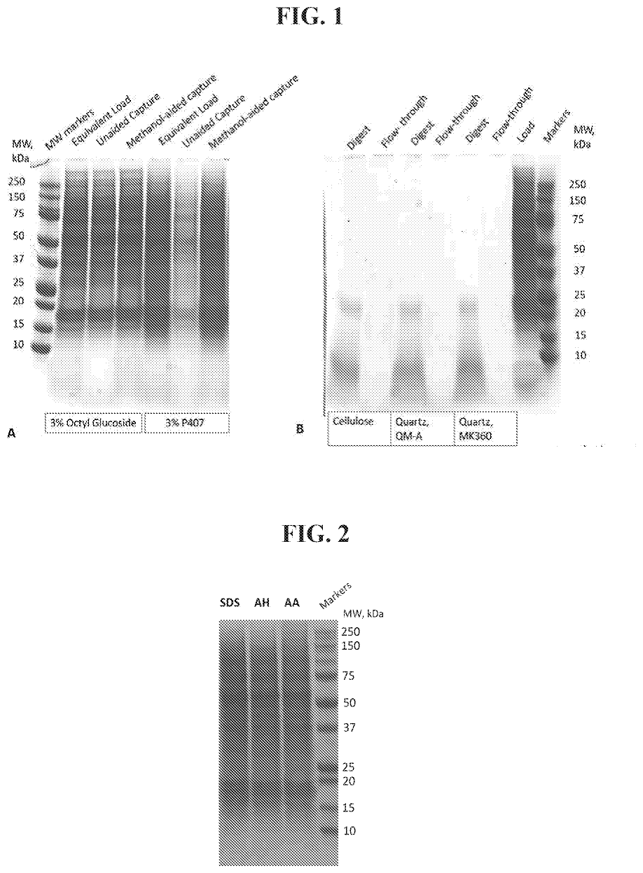

While working with cell lysates and non-ionic detergents such as octyl glucoside and Poloxamer 407, unexpectedly proteins in their native state can be captured by cellulose or quartz depth filters at near-neutral pH (FIG. 1) with or without detergents. This is surprising and represents a significant new advance which enables this method. The capture was robust. One skilled in the art will recognize that there are many other surfactants and detergents. Unexpectedly, further denaturation, reduction, alkylation and wash steps in situ was possible with subsequent digestion performed in the device and in the trapping matrix. One skilled in the art will recognize that there are many reduction and alkylation reagents can be used. This application provides the optimal composition and means of lysing cells and samples and biological without detergents, capturing extracted proteins and other molecule classes such as DNA and glycans in situ, while the metabolites and lipids and small molecules are separated and kept in the flow through, and further allowing the retained molecules to be processed by example by enzymatic digestion for example with a protease or nuclease or glycosidase. This application shows that sonication of a cell pellet either at near-neutral or basic pH efficiently releases proteins into solution with a similar extraction efficiency to SDS (FIG. 2); this application shows that proteins can be captured by either cellulose or quartz depth filter trap. One skilled in the art will recognize that, as described above, many other filter materials or porous materials could be employed, so long as the proteins are captured.

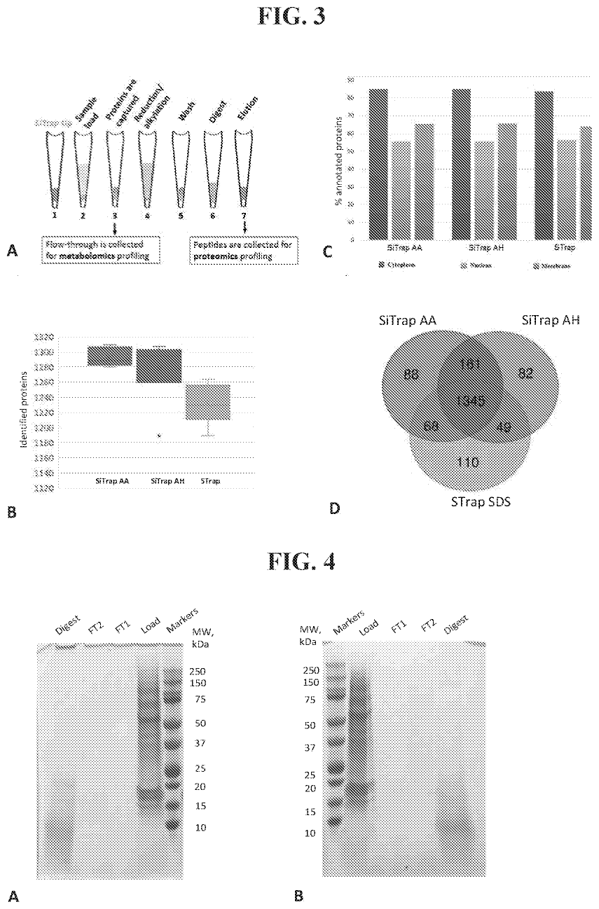

To outline SiTrap cellular processing, firstly a cell pellet is sonicated in excess of either 30 mM ammonium acetate (AA) or 1.8% ammonium hydroxide (AH) with subsequent centrifugation to remove debris. Using AH for lysis, and analyzing UV absorbance at 280 nm in a microvolume spectrophotometer, may provide a coarse direct estimation of protein concentration in cell lysates¹⁰. If AA extraction is used, four volumes of methanol containing 30 mM AA are added to the lysate. The sample is loaded into a SiTrap tip containing a depth filter compartment where proteins are instantly trapped. If AH extraction is used, then first an equal volume of 1M acetic acid is added to the lysate to bring the pH close to neutral, then two volumes of methanol are added before loading into the SiTrap tip. The resulting flow-through is collected for additional ‘omics’ processing. The captured proteins are denatured, reduced and alkylated in situ by heating at 80° C. in 60 mM triethylammonium bicarbonate (TEAB), 10 mM tris(2-carboxyethyl)phosphine (TCEP), 25 mM chloroacetamide (CAA) solution. After a wash, trypsin is added and the sample incubated at 47° C. for one hour to provide digestion of the proteins. The peptides are eluted and then concentrated using C8 or C18 Stage tips for analysis by mass spectrometry (MS) (FIG. 3A). It is noted that DNA is also co-captured, and that other enzymes can be used such as glycosidases to extend this application to other molecule classes.

To test the proteomics performance of the new SiTrap methodology, it was compared with SDS based sample preparation. MDA-MB-231 cells were extracted using either cell lysis and probe sonication on ice with AA or AH followed by SiTrap tryptic processing in cellulose SiTrap tips (FIG. 4) or cell lysis and probe sonication with SDS followed by digestion. 30 μg of protein was processed in six replicates in each case. Tryptic digestion was performed at 47° C. for one hour both for the samples. The test identified 1293 (±12 SD) and using SDS, 1278 (±44 SD) proteins on average with at least two peptides using AA or AH SiTrap lysis, respectively. This was comparable with the 1230 (±27 SD) average number of proteins identified for SDS lysis (FIG. 3B). The protein distributions in the main GO cellular component categories were very similar in all cases (FIG. 3C) and the majority of proteins were identified by all three approaches indicating an absence of bias (FIG. 3D).

### Example 2

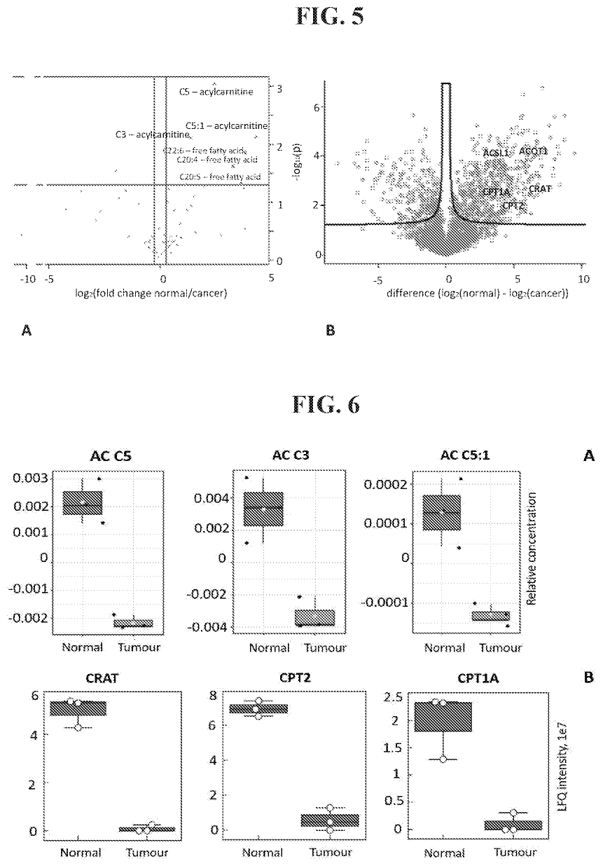

The ability of the SiTrap method and device to provide a simultaneous multiomics analysis platform was probed using a comparative proof-of-principle proteomics/metabolomics profiling study of clear cell renal carcinoma and corresponding adjacent noncancerous tissue sections. One skilled in the art will realize that this is simply an exemplary example, and is not limiting. The tissue sections (three normal/tumor pairs) were lysed by sonication with AH, the lysates were loaded into the SiTrap cellulose tips, the flow-through fractions were collected for targeted metabolomics profiling whereas the captured proteins were digested for proteomics analysis. Proteomics analysis resulted in a proteome dataset of 2655 proteins. The targeted metabolomics screen included 62 species across three metabolite classes—26 free fatty acids, 20 acyl carnitines, and 16 bile acids. Of these 59 metabolites were observed and quantified—25 free fatty acids, 19 acylcarnitines, and 15 bile acids. The metabolomics analysis indicated a decrease both in short-chain acylcarnitines (C5, C5:1 and C3) and in polyunsaturated free fatty acids (C20:5, C20:4, C22:6) in the tumor samples (FIG. 5A, FIG. 6A). Carnitine O-acetyltransferase (CRAT), Carnitine O-palmitoyltransferase 2 (CPT2) and Carnitine O-palmitoyltransferase 1 (CPT1A), the enzymes with crucial roles in acylcarnitine metabolism, were identified, quantified and found to be significantly decreased in the tumor samples, in concordance with the metabolomics results (FIG. 5B, FIG. 6B). A significant decrease in the tumor samples of other enzymes relevant to the polyunsaturated fatty acid metabolism was detected, in concordance with the metabolomics results: Acyl-CoA Thioesterase 1 (ACOT1) which releases C20:4, C20:5 and C22:6 from their CoA equivalents, and long chain Fatty acid-CoA ligase (ACSL1) which activates long-chain fatty acids to form acyl-CoAs (FIG. 5B).

### Example 3

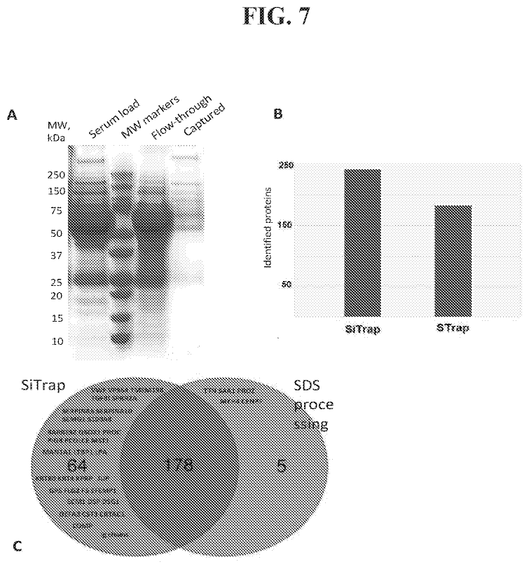

While working with serum samples it was observed that at basic pH, e.g. diluted in 20 mM TEAB, serum albumin is not trapped by a depth filter. However, many other serum proteins are captured (FIG. 7). This simple serum fractionation results in two fractions—the captured fraction, devoid of albumin, which can be directly processed in-tip by SiTrap. The alternative flow-through ‘albumin’ fraction can then be diluted with six volumes of 30 mM ammonium acetate in methanol and consequently captured and digested in another SiTrap unit. To test this approach 0.5 μl of human serum from a healthy volunteer was either digested directly by STrap technology (6 replicate samples in total) or diluted with 20 mM TEAB buffer and processed by fractionation using SiTrap quartz tips. SiTrap processing produced two fractions, captured and flow-through (3 replicates each for each fraction, 6 samples in total). The MS results from tryptic digests of the 6 samples in each approach were merged. The SiTrap fractionation lead to ˜30% increase in protein identifications compared with the direct approach (FIG. 7B, C). This example demonstrates fractionating serum into two or more fractions.

### Example 4

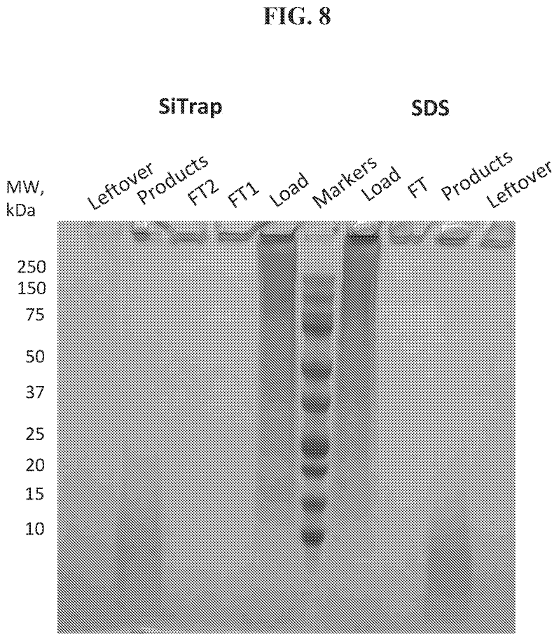

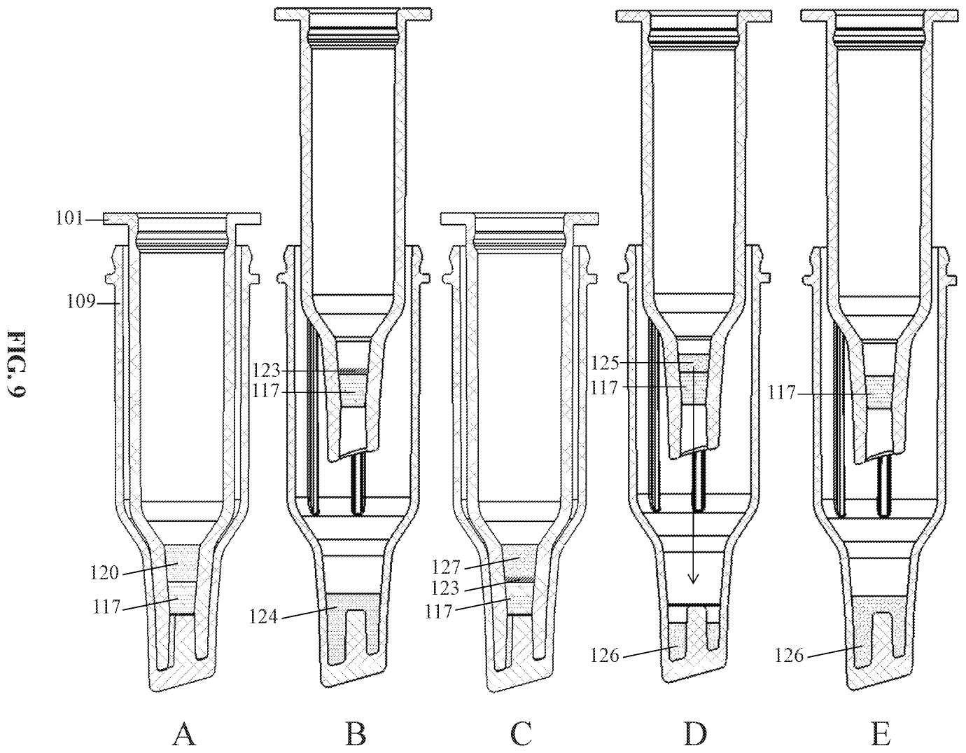

SiTrap sample processing also works on FFPE samples, due to their ubiquitousness in pathology, stability at room temperature and the sheer number of FFPE samples. Such samples, while representing a rich resource, are however very difficult due to their formalin-crosslinked nature and being embedded in wax. Surprisingly, SiTrap functioned well. Human renal FFPE tissue was deparaffinized by standard xylene/ethanol treatment and then lysed in 30 mM ammonium acetate by probe sonication. ˜50 μg of the resultant protein lysate was processed either by SiTrap or SDS methods. For SiTrap—4 volumes of methanol in 30 mM ammonium acetate was added to the lysate followed by protein capture in SiTrap cellulose tip, the tip was further washed with 60% methanol in 30 mM ammonium acetate, the flow-through was collected (FT1). Then 10 mM TCEP/30 mM chloroacetamide/60 mM TEAB solution was added and the tip was heated at 95 C for 1 hour. The tip was then washed with 20 mM TEAB, the flow-through was collected (FT2). The trapped proteins were digested at 48 C by two consecutive 1-hour digestions with 1.25 μg of trypsin (Promega) in 100 mM ammonium bicarbonate (trypsin concentration 0.07 μg/μl). Digest products were eluted consecutively by 500 mM ammonium bicarbonate and 50% acetonitrile in 0.2% formic acid. The leftover material was eluted by 2× Laemmli buffer. For SDS processing, the lysate was mixed with equal volume of 5% SDS in Tris-HCl pH 7.6, DTT was added to the final concentration of 20 mM, the sample was heated at 95 C for 1 hour. Chloroacetamide was added to the final concentration of 120 mM with consequent incubation for 30 min. The sample was cleared of SDS by the standard protocol and the flow-through was collected (FT). Similarly to SiTrap, the proteins were digested at 48 C by two consecutive 1-hour digestions with 1.25 μg of trypsin (Promega) in 100 mM ammonium bicarbonate (trypsin concentration 0.07 μg/μl). Digest products were eluted consecutively by 500 mM ammonium bicarbonate and 50% acetonitrile in 0.2% formic acid. The leftover material was eluted by 2× Laemmli buffer. This example demonstrates use of SiTrap technology for FFPE tissue (FIG. 8).

### Example 5

One exemplary embodiment of this application comprises capture of proteins and small molecules as described herein from one volume of a sample, wherein the sample was sonicated in the 30 mM ammonium acetate extraction solvent to physically disrupt the sample, mixed with four volumes of methanol containing 30 mM ammonium acetate, whereby anhydrous methanol was supplemented to 30 mM ammonium acetate from an aqueous 1 M ammonium acetate stock solution. The mixture was then applied to a cellulose depth filter employed as a trapping matrix, and the flow through, which contains small molecules of the cell in particular and not limited to metabolites and lipids, was kept for metabolomics and lipidomics analysis. The proteins were then reduced and alkylated in situ by heating at 80° C. in 60 mM triethylammonium bicarbonate (TEAB), 10 mM tris(2-carboxyethyl)phosphine (TCEP), 25 mM chloroacetamide (CAA) and the depth filter material was washed either with 50% methanol in 30 mM ammonium acetate or 20 mM TEAB and centrifuged at 2500 g for 30 sec. 1.4 ug of trypsin (Promega) was added in 20 uL of 100 mM ammonium bicarbonate and the trapped proteins were digested into peptides by incubation at 47 C for 1 hr. Post-digest elution was performed consecutively with 70 μl 300 mM ammonium bicarbonate and 70 μl of 3% formic acid. The peptides were concentrated using C8 Stage tips for the downstream analysis by mass spectrometry; such C8 processing might be integrated underneath the trapping matrix. This example demonstrates the multiomic nature of SiTrap.

### Example 6

Some experiments were analyzed on an Agilent 6546 QTOF using the following settings for peptide analysis, unless otherwise stated: 300-1700 m/z acquired in AutoMS2 positive mode with the Dual AJS ESI source with 325 C gas temp at 13 L/min and 275 C sheath gas temp. MSMSes were acquired a medium isolation width using 5000 MS absolute precursor threshold and 0.01% relative threshold with a target of 50,000 counts per spectrum and active exclusion enabled; VCap was set to 3500 and fragmentor to 175 V. An Agilent 1290 Infinity LC system was used running at 0.3 mL/min on a 2.1 mm×150 mm C18 column with a gradient between buffer A, water with 0.1% formic, and buffer B, 100% LCMS grade acetonitrile, holding at 5% B for 2 minutes then ramping to 40% B over 50 minutes holding at a 90% B was for 5 min and ramping back down to 5% B. The column, an 2.1×150 mm Agilent AdvanceBio Peptide Mapping 2.7 um column (cat #653750-902), was kept at 60 C.

Metabolite analysis on an Agilent 6546 QTOF used the following settings for peptide analysis, unless otherwise stated: data was acquired over 300-1700 m/z in AutoMS2 positive mode with the Dual AJS ESI source with 350 C gas temp at 5 L/min and 350 C sheath gas temp at 10 L/min. MSMSes were acquired a medium isolation width using 5000 MS absolute precursor threshold and 0.01% relative threshold with a target of 50,000 counts per spectrum and active exclusion disabled and isotope model set to common organic molecules; VCap was set to 3500 and fragmentor to 175 V. An Agilent 1290 Infinity LC system was used at 0.8 mL/min on a 2.1 mm×50 mm Agilent EclipsePlus C18 column (RRHD 1.8 um) with a gradient between buffer A, water with 0.1% formic, and buffer B, 100% LCMS grade acetonitrile (see table below for gradient). The column was kept at 40 C. The gradient was as follows:

| Event | Time (min) | A (%) | B (%) | Flow (mL/min) | Pressure (bar) |
|---|---|---|---|---|---|
| 1 | 2 | 95 | 5 | 0.8 | 600 |
| 2 | 4 | 60 | 40 | 0.8 | 600 |
| 3 | 5 | 50 | 50 | 0.8 | 600 |
| 4 | 10 | 50 | 50 | 0.8 | 600 |
| 5 | 15 | 30 | 70 | 0.8 | 600 |
| 6 | 19 | 20 | 80 | 0.8 | 600 |
| 7 | 20 | 20 | 80 | 0.8 | 600 |
| 8 | 21 | 95 | 5 | 0.8 | 600 |

SiTrap columns of FIGS. 10-14 were made using plastic injection molding formed from TPX plastic. The inner column was loaded with a porous matrix fashioned of quartz, glass fiber, polymers, cellulose or cellulose with fillers such as diatomaceous earth, using a pneumatic punching and pressing system. In some experiments, the matrix was afforded functional groups by derivatizations. In other experiments, the matrix was layered atop a chromatographic media like C18 or SCX. In other experiments, the inner vial received a bottom and top frit holding chromatographic media.

### Example 7

### Detection of SARS-CoV-2 Using Disclosed Method and Disclosed Physical Embodiment

The following example illustrates the use of the system to detect SARS-CoV-2 nucleocapsid protein, one of the more abundant proteins in the SARS-CoV-2 virus. Due to the BSL level of the laboratory in which the experimentation was performed, infectious virus was not directly analyzed. Rather, the nucelocapsid protein was made recombinantly and spiked into sputum. One skilled in the art will recognize that this example is not limiting, is applicable to live and infectious virus, within the limits of sensitivity of detection, and serves to illustrate the method's applicability to diagnosis. One skilled in the art will also recognize that this example can be extended to other viruses and pathogens, which have different genetic sequences and thus different protein sequences, by changing only the parameters of detection. The steps of this example are duplicated in other examples.

Human embryonic kidney cells HEK293 (approximately 1.5E6 cells/well, 6 well plate) were transfected with plasmid pCI-SARS-CoV-2-nucleoprotein (2 ug plasmid per well) using Lipofectamine 2000. The ORF of SARS-CoV-2 nucleoprotein was PCR amplified from a synthetic DNA clone. The nucleoprotein ORF sequence contained in the pCI-SARS-CoV-2-nucleoprotein plasmid is as follows:

ATGTCTGATAATGGACCCCAAAATCAGCGAAATGC
ACCCCGCATTACGTTTGGTGGACCCTCAGATTCAA
CTGGCAGTAACCAGAATGGAGAACGCAGTGGGGCG
CGATCAAAACAACGTCGGCCCCAAGGTTTACCCAA
TAATACTGCGTCTTGGTTCACCGCTCTCACTCAAC
ATGGCAAGGAAGACCTTAAATTCCCTCGAGGACAA
GGCGTTCCAATTAACACCAATAGCAGTCCAGATGA
CCAAATTGGCTACTACCGAAGAGCTACCAGACGAA
TTCGTGGTGGTGACGGTAAAATGAAAGATCTCAGT
CCAAGATGGTATTTCTACTACCTAGGAACTGGGCC
AGAAGCTGGACTTCCCTATGGTGCTAACAAAGACG
GCATCATATGGGTTGCAACTGAGGGAGCCTTGAAT
ACACCAAAAGATCACATTGGCACCCGCAATCCTGC
TAACAATGCTGCAATCGTGCTACAACTTCCTCAAG
GAACAACATTGCCAAAAGGCTTCTACGCAGAAGGG
AGCAGAGGCGGCAGTCAAGCCTCTTCTCGTTCCTC
ATCACGTAGTCGCAACAGTTCAAGAAATTCAACTC
CAGGCAGCAGTAGGGGAACTTCTCCTGCTAGAATG
GCTGGCAATGGCGGTGATGCTGCTCTTGCTTTGCT
GCTGCTTGACAGATTGAACCAGCTTGAGAGCAAAA
TGTCTGGTAAAGGCCAACAACAACAAGGCCAAACT
GTCACTAAGAAATCTGCTGCTGAGGCTTCTAAGAA
GCCTCGGCAAAAACGTACTGCCACTAAAGCATACA
ATGTAACACAAGCTTTCGGCAGACGTGGTCCAGAA
CAAACCCAAGGAAATTTTGGGGACCAGGAACTAAT
CAGACAAGGAACTGATTACAAACATTGGCCGCAAA
TTGCACAATTTGCCCCCAGCGCTTCAGCGTTCTTC
GGAATGTCGCGCATTGGCATGGAAGTCACACCTTC
GGGAACGTGGTTGACCTACACAGGTGCCATCAAAT
TGGATGACAAAGATCCAAATTTCAAAGATCAAGTC
ATTTTGCTGAATAAGCATATTGACGCATACAAAAC
ATTCCCACCAACAGAGCCTAAAAAGGACAAAAAGA
AGAAGGCTGATGAAACTCAAGCCTTACCGCAGAGA
CAGAAGAAACAGCAAACTGTGACTCTTCTTCCTGC
TGCAGATTTGGATGATTTCTCCAAACAATTGCAAC
AATCCATGAGCAGTGCTGACTCAACTCAGGCCTAA

The expressed nucleoprotein amino acid sequence is as follows:

MSDNGPQNQRNAPRITFGGPSDSTGSNQNGERSGA
RSKQRRPQGLPNNTASWFTALTQHGKEDLKFPRGQ
GVPINTNSSPDDQIGYYRRATRRIRGGDGKMKDLS
PRWYFYYLGTGPEAGLPYGANKDGIIWVATEGALN
TPKDHIGTRNPANNAAIVLQLPQGTTLPKGFYAEG
SRGGSQASSRSSSRSRNSSRNSTPGSSRGTSPARM
AGNGGDAALALLLLDRLNQLESKMSGKGQQQQGQT
VTKKSAAEASKKPRQKRTATKAYNVTQAFGRRGPE
QTQGNFGDQELIRQGTDYKHWPQIAQFAPSASAFF
GMSRIGMEVTPSGTWLTYTGAIKLDDKDPNFKDQV
ILLNKHIDAYKTFPPTEPKKDKKKKADETQALPQR
QKKQQTVTLLPAADLDDFSKQLQQSMSSADSTQA

One well was transfected with 1 ug pCI-SARS-CoV-2-nucleocapsid protein+1 ug plasmid pTM2-GFP. One well was transfected with 2 ug plasmid pTM2-GFP. After 40 hours of transfection, cells were washed with PBS, scarped into PBS, collected by centrifugation at 300×g for 2 minutes and stored at −80 C. After 40 hours of transfection, cells were washed with PBS, scraped into PBS and collected by centrifugation at 300×g for 2 minutes. Cotransfection with GFP and nucleocapsid protein did not show any difference to GFP alone, indicating that expression of the nucleocapsid protein does not affect the growth of HEK293 cells.

Cell pellets were processed as follows: to the cells was added either 1.8% ammonium hydroxide at approximately a 1:20 v/v ratio. Samples were sonicated either on a sonication water bath or a Covaris ultrasonicator. Samples were treated as a suspension and were sonicated and vortexed prior to any removal of sample. Protein concentration was assayed by BCA and set to ˜2 mg/mL by dilution with 1.8% ammonium hydroxide. Sputum was obtained ammonium hydroxide added to a final concentration of 1.8% from a 32% stock solution; sputum concentration was roughly 3 mg/mL. The sputum sample was similarly (ultra)sonicated and 1 uL of nucleocapsid protein solution was added to 99 uL sputum solution for a total protein load of roughly 300 ug in 100 uL; multiple replicate mixtures were prepared. To the samples was added 100 uL of 1 M acetic acid and 2 or 4 volumes of methanol was added in different SiTrap tubes loaded with cellulosic matrix in their lower parked position.

The SiTrap assemblies were raised to their upper parked positions and the sample was propelled through the matrix by centrifugation at 4,000 g for 5 min and the flow thorough, containing metabolites and small molecules, kept in the outer vial. The SiTrap inner vials were placed in fresh outer vial tubes in the lower parked position. At this point, five replicates were left at room temperature for 4 days and five other replicates were kept at −80 C. At the end of 4 days all samples were brought to room temperature. Proteins were reduced and alkylated for 10 min at 80 C with 10 mM TCEP and 25 mM chloroacetamide in a 50 mM tris buffer at pH 8 in the lower parked position. The reduction and alkylation reagents were removed by centrifugation in the upper solution, the proteins were washed with 75% MeOH and the washes and flow through discarded. The inner vial was placed in the lower parked position of the outer vial. Four samples, two stored at room temperature and two at −80 C, were subjected to accelerated digestion by exposure to ultrasonication. Because the ultrasonciation treatment was serial, to each of the four samples was first added 30 ug of trypsin added and the samples were immediately placed in a Covaris M220 and suspended via an improvised wire rack fashioned from straightened paperclip wire and held in place with lab tape. Each sample received ultrasonication treatment for 20 minutes with settings of 50 peak power, 20 duty factor and 300 burst/cycle. Samples were placed on ice to limit trypsin's activity. Two other samples received 30 ug of trypsin and four samples 30 ug of trypsin followed by a 1 hr 47 C incubation. Two samples were incubated overnight at 37 C with 15 ug of trypsin. Digestions were in 50 mM TEAB using Worthington trypsin.

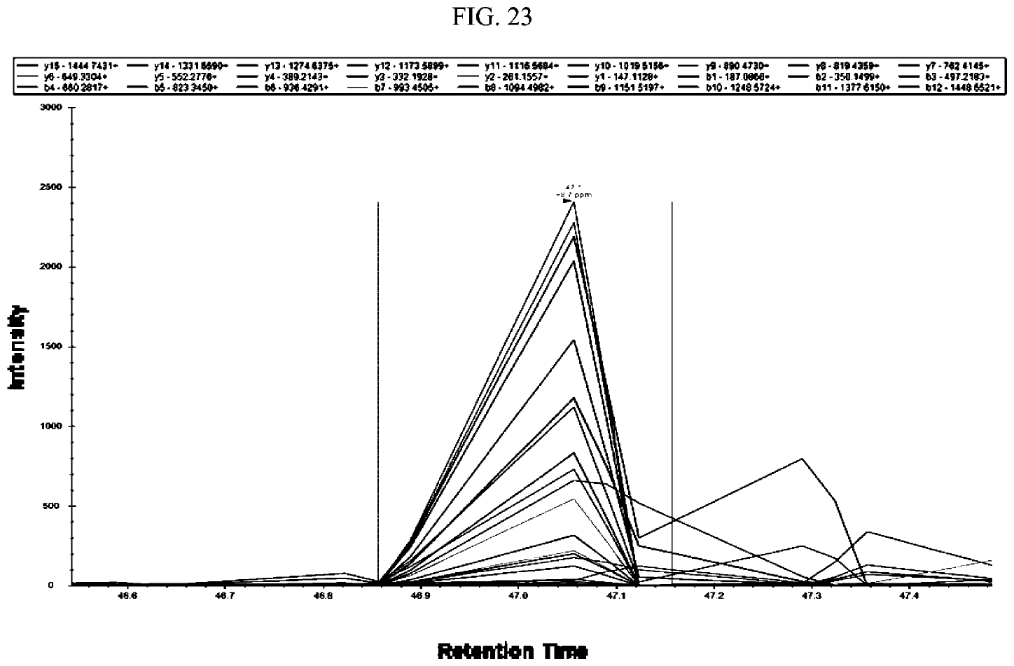

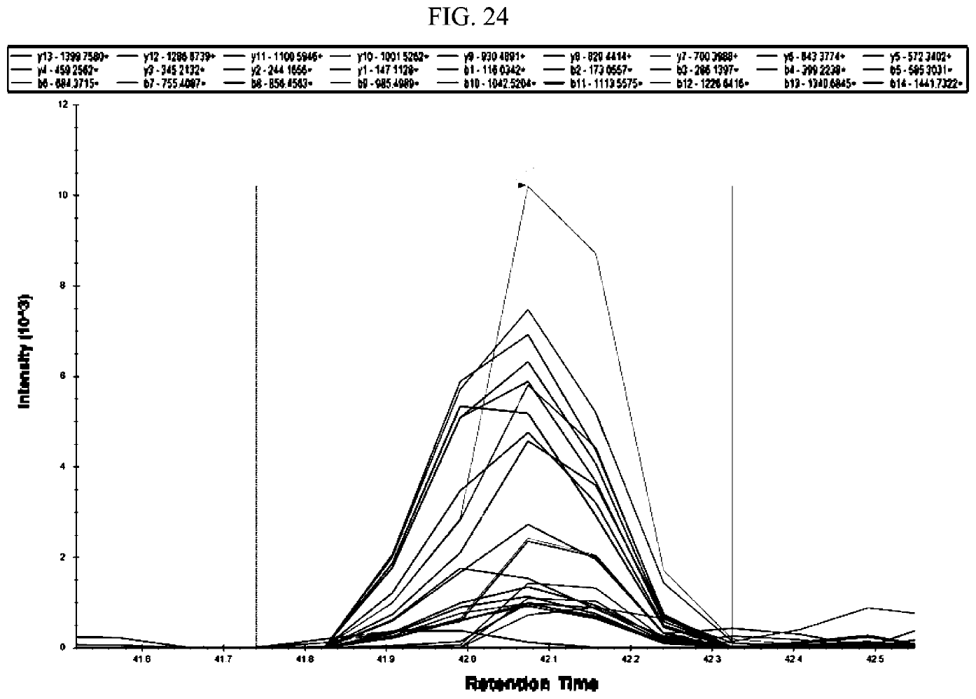

All samples were analyzed in targeted MS mode on the Agilent 6546 set to perform targeted MSMS on the following m/z for +2 charges for expected tryptic peptides of the SARS-CoV-2 protein: 375.180466, 403.193573, 443.706317, 458.742368, 471.784567, 563.78563, 564.785827, 573.751461, 601.809833, 741.330469, 835.948346, 842.948869, 894.929196, 912.411368, 931.48073, 1013.021708, 1030.578571, 1091.013989, 1118.541465, 1134.044029, 1162.598357, 573.751461, 912.411368, 1162.598357, 1091.013989, 1134.044029, 842.948869, 1030.578571, 443.706317, 375.180466, 403.193573, 835.948346, 601.809833, 563.78563, 894.929196, 1118.541465, 1013.021708, 471.784567, 458.742368, 564.785827, 931.48073, 741.330469. Data files were subsequently exported and loaded into Scaffold using its internal deconvolution and data search algorithms. Of the include list, the following peptides were detected: ITFGGPSDSTGSNQNGER at 912.411368, WYFYYLGTGPEAGLPYGANK at 1134.044029, DGIIWVATEGALNTPK at 842.948869, NPANNAAIVLQLPQGTTLPK at 1030.578571, MAGNGGDAALALLLLDR at 835.948346, AYNVTQAFGR at 563.78563, GPEQTQGNFGDQELIR at 894.929196, IGMEVTPSGTWLTYTGAIK at 1013.021708, ADETQALPQR at 564.785827, QQTVTLLPAADLDDFSK at 931.48073 and QLQQSMSSADSTQA at 741.330469; fragment ions observed are listed in the below table and representative traces are shown in FIGS. 23-24.

| Peptide sequence | Fragment ions observed |
|---|---|
| ITFGGPSDSTGSNQNGER | y12, y8, y7, y6, y5, y3, |
| | b1, b2, b6, b7, b8, b9, b12 |
| WYFYYLGTGPEAGLPYGANK | y15, y14, y13, y12, y11, |
| | y6, y4, y2, b2, b3, b4, b5, |
| | b6, b8, b9, b12 |
| DGIIWVATEGALNTPK | y11, y10, y8, y1, |
| | b6, b9, b10 |
| NPANNAAIVLQLPQGTTLPK | y10, y8, y2, y1, b2, b3 |
| MAGNGGDAALALLLLDR | y13, y12, y11, y9, y8, |
| | y7, y6, y3, b2, b3 |
| AYNVTQAFGR | y8, y7, y6, y5, y3, |
| | b2, b3, b4 |
| GPEQTQGNFGDQELIR | y5, y4, y3, y1, b6, b4 |
| IGMEVTPSGTWLTYTGAIK | y14, y13, y8, y7, y6, |
| | y4, b6 |
| ADETQALPQR | y2, y1, b3, b7 |
| QQTVTLLPAADLDDFSK | y12, y6, b1, b7, b9, b14 |
| QLQQSMSSADSTQA | y4, b1, b2, b8 |

There were no significant differences in the ability to detect the SARS-CoV-2 protein between 2 and 4× methanol additions, between storage at room temperature for four days and storage at room temperature, or between overnight 37 C, 1 hr 47 C or 20 min RT ultrasonication accelerated digestion. These results indicate that the SiTrap method is applicable to detect viruses and pathogens; that the inner and outer vial assembly is compatible with treatments of ultrasonication, and that ultrasonication speeds enzymatic processing, and importantly that sample, once bound, is stable at room temperature without desiccation and in the presence of oxygen for at least four days.

### Example 8

### Accelerated Serum Processing

100 ug of serum in 50 uL was denatured and dissolved in 1.8% ammonium hydroxide, mixed with 50 uL of 1 M acetic acid and provided with 2 volumes of methanol. This solution was applied to the inner and outer vial assembly in the upper parked position and the flow through recovered after centrifugation for 5 min at 4,000 g. The flow through fraction was taken for analysis via MSMS in the metabolite analysis mode. Serum was reduced, alkylated and digested as described for nucleocapsid protein by sonication in a Covaris M220. The small molecule fraction was analyzed by Agilent's MassHunter Qualitative Analysis version 10.0 searching against all METLIN and metabolite databases. 231 compounds were detected in metabolite mode. Peptides from the digestion were analyzed and searched using SpectrumMill against the human UniProt database. 344 protein groups including 1207 total proteins were detected. In some experimental iterations, the flow through fraction was dried and exposed to a 4:2:1 mixture v/v/v of 2-propanol/methanol/chloroform containing 7.5 mm ammonium acetate to generate a lipid fraction. 95% water with 0.1% formic plus 5% acetonitrile was then added to the outer vial and sonicated. In other experimental iterations, to the neutralized sample, 100 uL of chloroform followed by 300 uL of water and 400 uL of methanol was added and mixed. The inner vial was placed in a new vial and the solution centrifuged through. The mixture phase separated, with the upper layer containing more hydrophilic moieties and the lower more hydrophobic moieties like lipids. These approaches generated separate lipidomics and metabolomics fractions for higher ID rates. This sample illustrates that the SiTrap method and assembly can rapidly produce samples for metabolomics, lipidomics and proteomics analysis. The many metabolites are hydrophilic, and the use of additional chromatography such as HILIC will afford more identifications, and that the solvents described here are not limiting, but can be chosen to match the solubility properties of the analytes or classes of analytes of interest. It is specifically noted that combinations of solvents which phase partition are of special use, because their relative hydrophobicity can be altered, allowing tuning to the specific needs of analysis or treatment or processing.

### Example 9

### In-Trap Cell and Tissue Processing

˜10 uL of red blood cells (RBCs) or ˜10 mg of mouse liver were added to 50 uL of 1.8% ammonium hydroxide directly in the assembly in the lower parked position. The assembly was exposed to 5-10 min of ultrasonication on the M220 to lyse the cells or tissue. RBCs appeared to be fully dissolved and the liver appeared to be either fully disaggregated. 50 uL of 1 M acetic acid was then added, followed by 250 uL of HPLC grade methanol. The inner vial was moved to the upper parked position and the small molecule fraction recovered via centrifugation. In other experimental variations the processed RBCs or mouse liver was provided with chloroform as well to yield phase separated fractions for lipidomics (bottom layer) and metabolomics (top layer). The liver sample inner vial was placed in a clean new outer vial and 50 uL of TE was added and incubated for 30 min. This fraction, containing surviving RNA as well as DNA sheered by the ultrasonication, was eluted in the upper parked position, the matrix washed with 100 uL of TE and the sample was placed in a new outer vial. SDS-PAGE analysis showed very little protein. The inner vial was placed in a new outer vial and 10 uL of PNGAse F at 500 units/mL was added in 50 mM sodium phosphate at pH 8.6 to a total volume of 50 uL. The sample was processed at 37 C for 5 hrs and this fraction, containing glycans, was eluted by movement of the inner vial to the upper parked position and centrifugation. SDS-PAGE analysis showed no protein in this fraction and it was glycan positive by periodic acid and alcian blue tests. Finally, in a new outer vial, the sample was reduced, digested and alkylated as described above but with an overnight 37 C incubation. After further elution of peptides with 50 mM TEAB and 50% ACN, no material was observed on the column, indicating that the procedure was sufficient to fully process the tissue. In the event that had the tissue been contaminated with blood, an appropriately designed assembly with pore sizes great enough to allow passage of RBCs presents a mechanism for a manual or automated cleaning system.

### Example 10

### FFPE

1 mm cores of formalin fixed paraffin embedded mouse livers stored at room temperature were punched and homogenized in trap hydroxide as with in-trap cell and tissue processing for 10 min on the M220 following an overnight incubation in 1.8% ammonium to rehydrate the sample. The methanol and chloroform extraction protocol used on serum was applied, affording an upper layer free of paraffin which was taken for further metabolomics analysis. Protein processing with trypsin was performed as with serum to yield MSMS ready peptides.

### Example 11

### RNA Capture Visualization

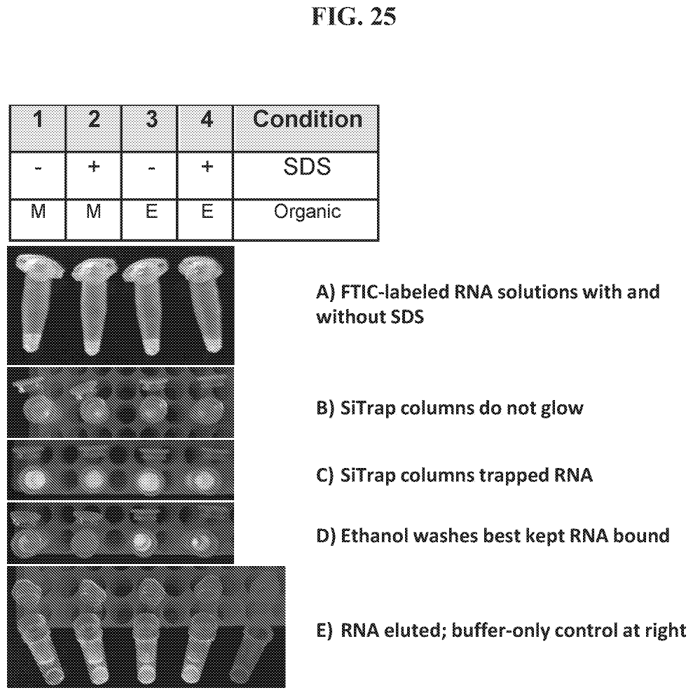

The ability of the SiTrap system to capture and release RNA was visualized with RNA. Yeast tRNA (Roche 10109495001) was labeled every tenth amine with fluorescein isothiocyanate (FITC, Sigma cat. no. 46951); the resulting labeled RNA was precipitated with ethanol and samples were washed until the supernatant was free of color, indicating removal of non-covalently-bound FITC. Labeled RNA was resuspended with or without the presence of 5% SDS in a final volume of 50 uL (see table in FIG. 25). As expected, the FITC-labeled tRNA glowed under UV light (FIG. 25A), allowing immediate visualization. Importantly, the SiTrap spin columns, here within a different vesicle to the assembly herein presented, but identical in its binding matrix, do not glow (FIG. 25B). To each sample was added 5 uL of 10 M ammonium acetate and 350 uL of either 90% methanol (“M” in FIG. 25) with 100 mM TEAB or straight ethanol (“E” in FIG. 25). Samples were mixed and immediately passed through SiTrap columns. All conditions trapped RNA (FIG. 25C). Columns were washed with 350 uL of the specified organic. Straight ethanol was more effective at retaining RNA on the column (FIG. 25D). RNA was eluted with 50 mM TEAB and ethanol-bound RNA was quantitatively released (FIG. 25E, conditions 3 and 4; note the lack of glow in the SiTrap binding matrix). This experiment demonstrates the reversible capture and release RNA for downstream processing.

### Example 12

Multifraction Analyses with Combined Matrices

The assembly was afforded the same binding matrix and beneath it a layer of either SCX or C18 flexible capture media (Affinisep). Samples were processed as described for serum. For SCX SiTraps, the sample was diluted 10× with 2:1 MeOH/water to effect better binding and the initial flow through kept. The SCX matrix was then eluted with 250 mM ammonium acetate in a new outer vial. Subsequently the proteins were digested as with serum using 1 hr 47 C digestions in new outer vials. The flow through from the 50 mM was removed 250 mM ammonium acetate provided to the inner vial in the parked position. After brief sonication, the inner vial was placed in the upper parked position to retrieve the bound peptides. SCX fractions so generated were highly complementary with relatively few IDs shared between the flow through and eluted fractions for either metabolites or peptides. For C18, the same procotol was repeated with the following changes: no dilution of the sample was initially performed and elutions were with 75% ACN rather than ammonium acetate. Peptide fraction C18 flow through had very little sample, as did metabolite flow through. These results are anticipated however because C18 chromatography was used subsequent to SiTrap processing. Thus, the C18 served as a cleanup step. Alternatively, elution “cuts” of 20% ACN were applied. These had noticeable amounts of peptides and metabolites and lipids.

While various embodiments have been described above, it should be understood that such disclosures have been presented by way of example only and are not limiting. Thus, the breadth and scope of the subject compositions and methods should not be limited by any of the above-described exemplary embodiments, but should be defined only in accordance with the following claims and their equivalents.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

What is claimed is:

1. A two-piece system for processing a sample comprising one or more fractions of a biological target of interest, the system comprising:
an outer vial, wherein the outer vial is configured to receive an inner vial within the outer vial, wherein the outer vial optionally comprises a pin;
an inner vial, wherein the inner vial comprises an inner chamber and a matrix, and wherein the inner vial is configured to be positioned within the outer vial in a first state and a second state, wherein the first state is a lower parked position within the outer vial, and the second state is an upper parked position within the outer vial; and wherein in
when the system is in the lower parked position of the inner vial, the outer vial seals the inner vial, wherein the pin of the outer vial is configured to seal the inner vial and remove the dead space of an output of the inner vial up to the bottom of the matrix; and wherein in
when the system is in the upper parked position of the inner vial, the outer vial does not seal the inner vial.

2. The system of claim 1, wherein the inner vial further comprises a cap and the outer vial comprises a cap.

3. The system of claim 1, wherein the inner vial comprises a vent.

4. The system of claim 1, wherein the inner vial comprises an opening on an end of the inner vial beneath the matrix when the inner vial has been received within the outer vial.

5. A method of preparing a sample comprising one or more fractions of a biological target of interest using a two-piece system, the method comprising:
exposing the sample to an extraction solvent, wherein the extraction solvent is neutral or neutralized and detergent-free and chaotrope-free;
optionally, physically disrupting said sample combined with said extraction solvent;
combining said sample and said extraction solvent with a molecule coagulant, wherein the molecule coagulant facilitates binding of molecules upon a matrix and wherein the molecule coagulant is a mildly chaotropic coagulant;
contacting said sample combined with said molecule coagulant with a capture matrix adapted to capture molecules in the presence of said molecule coagulant, wherein the capture matrix is contained within an inner vial of the system of claim 1;
positioning the inner vial within the outer vial of the system of claim 8 in the upper parked position of claim 1, wherein non-coagulated and unbound molecules flow from the inner vial into the outer vial;
collecting non-coagulated and unbound molecules into the outer vial, where the classes of non-coagulated molecules are dependent on the choice of molecule coagulant;
shifting the inner vial to the lower parked position of claim 1, wherein the outer vial seals the inner vial;
processing coagulated captured molecules bound to the matrix in the inner vial, wherein the processing of said coagulated captured molecules alters the physical state of the molecules and wherein said processing occurs without any prior exposure of the sample to strong chaotropic agents;
shifting the inner vial to the upper parked position of claim 1 in an outer vial, after processing of the coagulated captured molecules bound to the matrix; and
eluting a class or category of coagulated captured molecules from the matrix into an outer vial with extraction solvents chosen to match the solubilities of the coagulated captured molecules.

6. The method of claim 5, wherein the inner vial further comprises a cap and the outer vial comprises a cap.

7. The method of claim 5, wherein the inner vial comprises a vent.

8. The method of claim 5, wherein the inner vial comprises an opening on an end of the inner vial beneath the matrix when the inner vial has been received within the outer vial.

9. The method of claim 5, wherein the matrix is a depth filter.

10. The method of claim 5, wherein the biological target of interest is one or more selected from the group comprising proteins, DNA, RNA, lipids and glycans

11. The method of claim 5, wherein the processing is performed by one or more selected from the group consisting of a protease, a nuclease, and a glycosidase.

12. The method of claim 5, wherein the molecule coagulant is one or more selected from the group comprising organic solvents, aqueous solvents, and biphasic organic solutions.

13. The method of claim 5, wherein the extraction solvent is detergent-free 1.8% ammonium hydroxide.

14. A method of preparing a sample comprising one or more fractions of a biological target of interest, the method comprising:
exposing the sample to an extraction solvent, wherein the extraction solvent is neutral or neutralized and detergent-free and chaotrope-free;
optionally, physically disrupting said sample combined with said extraction solvent;
combining said sample and said extraction solvent with a molecule coagulant, wherein the molecule coagulant facilitates binding of molecules upon a matrix and wherein the molecule coagulant is a mildly chaotropic coagulant;
contacting said sample combined with said molecule coagulant with a capture matrix adapted to capture molecules in the presence of said molecule coagulant;
collecting non-coagulated and unbound molecules into a first removable vesicle, where the classes of non-coagulated molecules are dependent on the choice of molecule coagulant;
processing coagulated captured molecules bound to the matrix, wherein the processing of said coagulated captured molecules alters the physical state of the molecules and wherein said processing occurs without any prior exposure of the sample to strong chaotropic agents; and
eluting a class or category of coagulated captured molecules from the matrix into a second removable vesicle with extraction solvents chosen to match the solubilities of the coagulated captured molecules.

15. The method of claim 14, wherein the matrix is a depth filter.

16. The method of claim 14, wherein the biological target of interest is one or more selected from the group comprising proteins, DNA, RNA, lipids and glycans

17. The method of claim 14, wherein the processing is performed by one or more selected from the group consisting of a protease, a nuclease, and a glycosidase.

18. The method of claim 14, wherein the molecule coagulant is one or more selected from the group comprising organic solvents, aqueous solvents, and biphasic organic solutions.

19. The method of claim 14, wherein the extraction solvent is detergent-free 1.8% ammonium hydroxide.

20. The method of claim 14, further comprising the steps of:
adding two volumes of methanol to sample first extracted with 1.8% ammonium hydroxide sonication;
neutralizing by addition of an equal volume of 1 M acetic acid; and
adding two volumes of methanol as molecule coagulant.
